(19) United States
(12) Patent Application Publication
(10) Pub. No.: US 2022/0186037 A1
(43) Pub. Date: Jun. 16, 2022

(54) COATED PARTICLES FOR TURF INFILL

(71) Applicant: PREFERRED TECHNOLOGY, LLC, Wayne, PA (US)

(72) Inventors: Spyridon MONASTIRIOTIS, Spring, TX (US); Anthony Paul Haddock, Houston, TX (US); Mohamed Tarek Mahmoud ABDELWAHAB, Cairo (EG)

(21) Appl. No.: 17/548,136

(22) Filed: Dec. 10, 2021

Related U.S. Application Data
(60) Provisional application No. 63/195,740, filed on Jun. 2, 2021.
(60) Provisional application No. 63/124,649, filed on Dec. 11, 2020.

(51) Int. Cl. C09C 1/30; C09C 3/10; E01C 13/08

(52) U.S. Cl. CPC C09C 1/3081; E01C 13/08; C09C 1/3072; C09C 3/10

(57) ABSTRACT

The present embodiments are directed, in part, to coated particulates, methods of preparing thereof, and methods of using the same, for example, as turf infill.

### CROSS REFERENCE TO RELATED APPLICATIONS

This application claims priority to U.S. Provisional Application No. 63/124,649, filed Dec. 11, 2020 and U.S. Provisional Application No. 63/195,740, filed Jun. 2, 2021, each of which is hereby incorporated by reference in its entirety.

### BACKGROUND

Artificial surfaces have been commonly used in athletic fields for sports, landscaped public and private areas for various reasons including aesthetic appearance, low maintenance, evenness and uniform appearance of surfaces, etc.

Currently available systems of artificial turfs and turf infills have drawbacks. Infiltration and permeability have a significant impact on drainage of a high-performance artificial turf system. Insufficient drainage may provide a favorite environment for microbial growth. Thus, there is a need for new turf infill that will make artificial turf water drainage more efficient, which will lead to less or no water accumulation. Efficient water drainage addresses ponding and water accumulation while minimizing particle agglomeration due to icing under low temperatures and therefore provides anti-frosting and anti-icing properties. In addition, efficient water drainage provides an improved microbial growth resistance.

The torque required to move/rotate a set of athletic shoe cleats through an artificial turf system, known as rotational resistance, is an important property for performance and safety. Rotational resistance of a turf infill that is not properly tuned may result to a hazardous field for athletes.

The artificial turf's ability to absorb an amount of force on the surface is significant on reducing impact forces. A hard overall artificial turf and infill system will result in low energy dissipation between the athlete and the surface, which may be hazardous. Similarly, the vertical deformation, which is how much the overall artificial turf and infill system gives underfoot may have a significant effect on energy dissipation when running. A soft surface will require greater efforts that may result in muscle injuries and fatigue.

### SUMMARY

The present disclosure provides coated particulates for a turf infill comprising a core, wherein the core is substantially covered with one or more layers of polymeric coatings, wherein the polymeric coating is selected from a polyurethane coating, an epoxy coating, a phenolic coating, a polyurethane-phenol coating, and any combination thereof.

In some embodiments, the present disclosure provides coatings for the coated particulates as described herein comprising one or more additives selected from a UV stabilizer, an antimicrobial agent, a surfactant, a pigment or dye, an IR reflective colorant, an impact modifier, an omniphobic low surface energy agent, a wetting agent, an antifoaming agent, a catalyst, and any combination thereof.

In some embodiments, the present disclosure provides coatings for the coated particulates as described herein further comprising surface chemistry compounds that provide anti-fouling and biomass repellent properties and reduce organic biofilms buildup onto the turf infill particles outer surface. In some embodiments, an omniphobic surface, a very low surface energy coating which exhibits both oleophobic (oil repellent) and hydrophobic behavior (water repellent), provides anti-fouling properties and an improved microbial growth resistance.

In some embodiments, the present disclosure provides the coated particulates as described herein further comprising a surface additive on the outer surface of the polymeric coating, which can reduce the friction between the coated particles and/or tailor the rotational resistance of a turf infill comprising the coated particulates. In some embodiments, the surface additive is a silicone-containing surface additive for solvent-free, solvent-borne and aqueous coating systems, printing inks and/or adhesive systems as well as ambient-curing plastic systems. In some embodiments, the surface additive is BYK® 333.

In some embodiments, the present disclosure provides the coated particulates as described herein further comprising an impact modifier filler, which can reduce impact forces of a turf infill comprising the coated particulates and/or tailor the vertical deformation of the turf infill.

In some embodiments, the present disclosure provides methods of producing the coated particulates as provided and described herein.

In some embodiments, the present disclosure provides artificial turfs comprising the coated particulates as provided and described herein.

### BRIEF DESCRIPTION OF THE DRAWINGS

FIG. 1 illustrates UV stabilizers and pigments or dyes that are incorporated in the same coating of the coated particulate for a turf infill.

FIG. 2 illustrates pigments or dyes that are incorporated only in the inner coating of the coated particulate for a turf infill.

FIG. 3 illustrates UV stabilizers and pigments or dyes that are incorporated in the different coatings of the coated particulate for a turf infill, for example, pigments or dyes are incorporated inner layer while UV stabilizers are incorporated in the outer layer of the coatings.

FIG. 4 illustrates that antimicrobial agents are incorporated into the outer layer of the coatings of the coated particulate for a turf infill along with UV stabilizers while pigments or dyes are incorporated in the inner layer.

FIG. 5 illustrates two continuous mixers in series and their dosing ports used for charging chemicals while mixing.

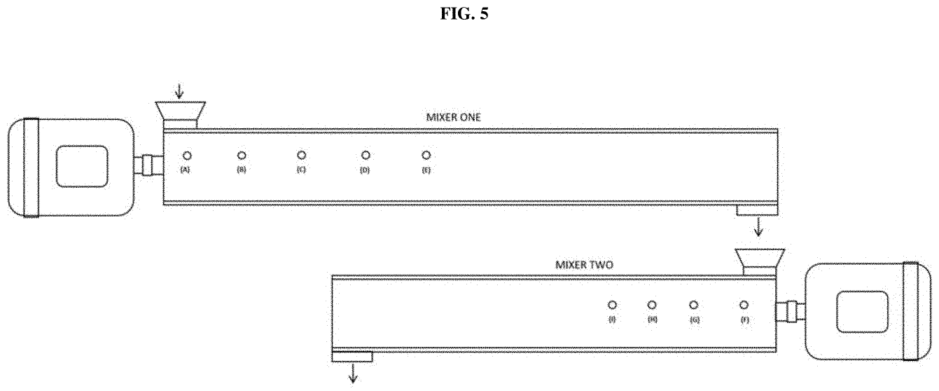

### DETAILED DESCRIPTION

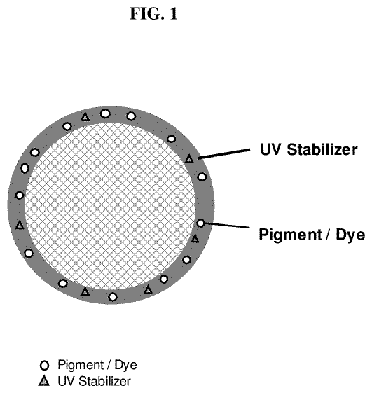

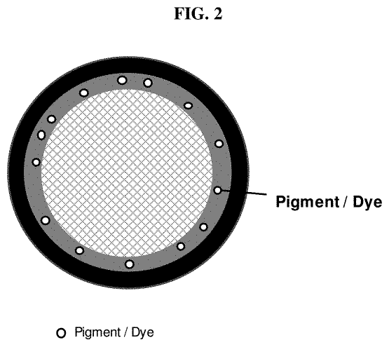

In some embodiments, coated particulates for a turf infill are provided. The core may be sand, quartz sand, ceramic, rubber, elastomeric particle, a polymeric particle, or a combination thereof. In some embodiments, the core is sand, quartz sand, ceramic, rubber, elastomeric particle, or a polymeric particle or a combination thereof. In some embodiments, the core is sand. In some embodiments, the core is quartz sand. In some embodiments, the core is ceramic. In some embodiments, the core is rubber. In some embodiments, the core is elastomeric particle. In some embodiments, the core is a polymeric particle. In some embodiments, the core is a combination of two or more selected from sand, quartz sand, ceramic, rubber, elastomeric particle, and a polymeric particle. In some embodiments, the core is substantially covered with one or more layers of polymeric coatings. In some embodiments, the core is substantially covered with a single layer of polymeric coating as illustrated in FIG. 1. In some embodiments, the core is substantially covered with multiple layers of polymeric coatings as illustrated in FIG. 2 to FIG. 4. In some embodiments, the polymeric coating is selected from a polyurethane coating, an epoxy coating, a phenolic coating, a polyurethane-phenol coating, and any combination thereof. In some embodiments, the polymeric coating is a polyurethane coating. In some embodiments, the polymeric coating is an epoxy coating. In some embodiments, the polymeric coating is a phenolic coating. In some embodiments, the polymeric coating is a polyurethane-phenol coating. In some embodiments, the polymeric coating is any combination of a polyurethane coating, an epoxy coating, and a phenolic coating. In some embodiments, the polymeric coating of the coated particulates as provided herein is coupled to the core through a coupling agent. In some embodiments, the coupling agent is a silane coupling agent. In some embodiments, the particulate is sand or other materials as described herein.

In some embodiments, the particulate, such as sand, is coated with a silane as a coupling agent. The silane coated particle, can then be coated with an isocyanate and polyol, which can be a blend of the two or added separately to form a polyurethane coated particle. In some embodiments, the particle is then contacted with an isocyanate, which can be the same or different as the first isocyanate, and a surfactant to finish coating the sand. Additionally, in some embodiments, when the isocyanate and the polyol is added to the silane coated particle a colorant is also used. The formation of the polyurethane coating can also be catalyzed with a catalyst, such as a dibutyltin dilaurate catalyst. Accordingly, in some embodiments, a coated particulate (e.g. sand) is provided that comprises a polyurethane coating coupled to the sand through a silane (e.g. aminopropyltriethoxysilane). The coating can also comprise a colorant or other additives.

In some embodiments, the polymeric coating of the coated particulates as provided and described herein resists degradation under the combination of heat, UV-light, and water. Coating stability tests under temperature and presence of water can be performed using an autoclave. The autoclave test can be used to determine the percent weight loss of a coated particulate after it is submerged in DI (deionized) water at 250° F. and 15 psi for three days. For example, 20 g of coated particulates can be placed in a vial, filled to the top with DI water and sealed tight. The concentration of the coated particulates in water can be about 2-5 lbs of coated particulates per gallon of water. After the three-day testing is complete, for example, the sample can be rinsed with DI water and dried in an oven at, for example, 125° F. for 24 hours. A loss on ignition (LOI) test can be performed pre-autoclave and post-autoclave to determine the overall wt. % loss. In some embodiments, the polymeric coating exhibits sufficient resistance to a 3-day autoclave test so that the coating resists loss by dissolution in hot water of less than about 25 wt. % of the overall coating, less than 15 wt. %, or a loss of less than 5 wt. %. In some embodiments, the polymeric coating of the coated particulate as provided and described herein does not support microbial growth. In some embodiments, the polymeric coating is hydrophilic. In some embodiments, the hydrophilic polymeric coating is the outer layer coating of the coated particulates as provided and described herein. In some embodiments, the hydrophilic polymeric coating is a polyurethane coating. In some embodiments, the coated particulates with the hydrophilic polymeric coating as provided and described herein drain water effectively. In some embodiments, the coated particulates with the hydrophilic polymeric coating as provided and described herein drain water effectively. In some embodiments, the water is surface water. In some embodiments, the surface water is from rain, hail, snow, or irrigation. In some embodiments, the surface water is from rain. In some embodiments, the surface water is from snow. In some embodiments, the surface water is from irrigation. In some embodiments, the polymeric coating of the coated particulates as provided and described herein is resistant to microbial growth. In some embodiments, the polymeric coating comprises an antimicrobial agent. In some embodiments, the antimicrobial agent is a boron-containing compound. In some embodiments, the boron-containing compound is borax pentahydrate, borax decahydrate, boric acid, polyborate, tetraboric acid, sodium metaborate, anhydrous, or boron components of polymers, or a combination thereof. In some embodiments, the antimicrobial agent is a silver based material, cupper based material such as cuprous oxide, or zinc based material such as zinc oxide copper, or a combination thereof such as a copper-silver-zinc alloy, copper-silver alloys, or silver-zinc alloy. Other antimicrobial agents such as salts of organic cations such as quaternary ammonium, quaternary phosphonium, N-alkylpyridinium, N-alkylimidazolium, guanidinium and organosulphonium are commonly used as biocidal functionalities to be attached to polymers. In some embodiments, the infill coating comprises an omniphobic surface chemistry modifier. An omniphobic coating is a low surface energy coating that exhibits both oleophobic (oil repellent) and hydrophobic (water repellent) behavior. The oleophobic behavior provides antifouling and biomass repellent properties to the coating, reducing organic biofilms buildup on the coated particulates.

In some embodiments, the polyurethane coatings of the coated particulates as provided and described herein are formed from a reaction of an isocyanate component and an isocyanate reactive blend. As used herein, the term “isocyanate index” refers to the ratio of the total number of isocyanate functionalities (—NCO) over the total number of isocyanate reactive blend functionalities (e.g., —OH). In some embodiments, the polyurethane coating has an isocyanate index from about 0.25 to about 8. In some embodiments, the polyurethane coating has an isocyanate index from about 0.25 to about 8.0, from about 0.25 to about 7.5, from about 0.25 to about 7.0, from about 0.25 to about 6.5, from about 0.25 to about 6.0, from about 0.25 to about 5.5, from about 0.25 to about 5.0, from about 0.25 to about 4.5, from about 0.25 to about 4.0, from about 0.25 to about 3.5, from about 0.25 to about 3.0, from about 0.25 to about 2.5, from about 0.25 to about 2.0, from about 0.25 to about 1.5, from about 0.25 to about 1.0, or from about 0.25 to about 0.5. In some embodiments, the polyurethane coating has an isocyanate index from about 0.5 to about 8.0, 0.5 to about 7.5, from about 0.5 to about 7.0, from about 0.5 to about 6.5, from about 0.5 to about 6.0, from about 0.5 to about 5.5, from about 0.5 to about 5.0, from about 0.5 to about 4.5, from about 0.5 to about 4.0, from about 0.5 to about 3.5, from about 0.5 to about 3.0, from about 0.5 to about 2.5, from about 0.5 to about 2.0, from about 0.5 to about 1.5, or from about 0.5 to about 1.0. In some embodiments, the polyurethane coating has an isocyanate index from about 1.0 to about 8.0, from about 1.0 to about 7.5, from about 1.0 to about 7.0, from about 1.0 to about 6.5, from about 1.0 to about 6.0, from about 1.0 to about 5.5, from about 1.0 to about 5.0, from about 1.0 to about 4.5, from about 1.0 to about 4.0, from about 1.0 to about 3.5, from about 1.0 to about 3.0, from about 1.0 to about 2.5, from about 1.0 to about 2.0, or from about 1.0 to about 1.5. In some embodiments, the polyurethane coating has an isocyanate index from about 1.5 to about 8.0, from about 1.5 to about 7.5, from about 1.5 to about 7.0, from about 1.5 to about 6.5, from about 1.5 to about 6.0, from about 1.5 to about 5.5, from about 1.5 to about 5.0, from about 1.5 to about 4.5, from about 1.5 to about 4.0, from about 1.5 to about 3.5, from about 1.5 to about 3.0, from about 1.5 to about 2.5, or from about 1.5 to about 2.0. In some embodiments, the polyurethane coating has an isocyanate index from about 2.0 to about 8.0, from about 2.0 to about 7.5, from about 2.0 to about 7.0, from about 2.0 to about 6.5, from about 2.0 to about 6.0, from about 2.0 to about 5.5, from about 2.0 to about 5.0, from about 2.0 to about 4.5, from about 2.0 to about 4.0, from about 2.0 to about 3.5, from about 2.0 to about 3.0, or from about 2.0 to about 2.5. In some embodiments, the polyurethane coating has an isocyanate index from about 2.5 to about 8.0, from about 2.5 to about 7.5, from about 2.5 to about 7.0, from about 2.5 to about 6.5, from about 2.5 to about 6.0, from about 2.5 to about 5.5, from about 2.5 to about 5.0, from about 2.5 to about 4.5, from about 2.5 to about 4.0, from about 2.5 to about 3.5, or from about 2.5 to about 3. In some embodiments, the polyurethane coating has an isocyanate index from about 3.0 to about 8.0, 3.0 to about 7.5, from about 3.0 to about 7.0, from about 3.0 to about 6.5, from about 3.0 to about 6.0, from about 3.0 to about 5.5, from about 3.0 to about 5.0, from about 3.0 to about 4.5, from about 3.0 to about 4.0, or from about 3.0 to about 3.5. In some embodiments, the polyurethane coating has an isocyanate index from about 3.5 to about 8.0, from about 3.5 to about 7.5, from about 3.5 to about 7.0, from about 3.5 to about 6.5, from about 3.5 to about 6.0, from about 3.5 to about 5.5, from about 3.5 to about 5.0, from about 3.5 to about 4.5, or from about 3.5 to about 4.0. In some embodiments, the polyurethane coating has an isocyanate index from about 4.0 to about 8.0, from about 4.0 to about 7.5, from about 4.0 to about 7.0, from about 4.0 to about 6.5, from about 4.0 to about 6.0, from about 4.0 to about 5.5, from about 4.0 to about 5.0, or from about 4.0 to about 4.5. In some embodiments, the polyurethane coating has an isocyanate index from about 4.5 to about 7.5, from about 4.5 to about 7.0, from about 4.5 to about 6.5, from about 4.5 to about 6.0, from about 4.5 to about 5.5, or from about 4.5 to about 5.0. In some embodiments, the polyurethane coating has an isocyanate index from about 5.5 to about 8.0, 5.5 to about 7.5, from about 5.5 to about 7.0, from about 5.5 to about 6.5, or from about 5.5 to about 6.0 In some embodiments, the polyurethane coating has an isocyanate index from about 6.0 to about 8.0, from about 6.0 to about 7.5, from about 6.0 to about 7.0, or from about 6.0 to about 6.5. In some embodiments, the polyurethane coating has an isocyanate index from about 6.5 to about 8.0, from about 6.5 to about 7.5, or from about 6.5 to about 7.0. In some embodiments, the polyurethane coating has an isocyanate index from about 7.0 to about 8.0, or from about 7.0 to about 7.5. In some embodiments, the polyurethane coating has an isocyanate index from about 7.5 to about 8.0. In some embodiments, the polyurethane coating has an isocyanate index of about 8.0, about 7.5, about 7, about 6.5, about 6.0, about 5.5, about 5.0, about 4.5, about 4.0, about 3.5, about 3.0, about 2.5, about 2.0, about 1.5, about 1.0, about 0.75, about 0.5, or about 0.25.

### Coupling Agent

In some embodiments, provided are coated particulates for a turf infill, wherein the polymeric coating is coupled to the core (e.g., particle, such as a sand particle) through a silane coupling agent. In some embodiments, the core is a ceramic particle. Silanes can be used as a first inner layer, and can for example, function as an adhesion agent or a coupling agent that couples the inorganic core (e.g., sand particle or ceramic particle) with the organic coating and improve coating wetting during the coating process and prevent future coating delamination. In some embodiments, the silane coupling agent is an organofunctional silane coupling agent. In some embodiments, the organofunctional silane coupling agent is selected from the group of 3-glycidyloxypropyltrimethoxysilane, 3-glycidyloxypropyltriethoxysilane, 2-(3,4-epoxycyclohexy)ethyltrimethoxysilane, and 2-(3,4-epoxycyclohexyl)ethyltriethoxysilane, 3-[2-(2-aminoethylamino)ethylamino]propyl-trimethoxysilane (CAS No. 35141-30-1), 3-mercaptopropyl-trimethoxysilane (CAS No. 4420-74-0), n-propyltrimethoxysilane (CAS No. 1067-25-0), [3-(2-aminoethyl)aminopropyl]trimethoxysilane (CAS No. 1760-24-3), silane n-dodecyltrimethoxysilane (CAS No. 3069-21-4), bis(trimethoxysilylpropyl) amine (CAS No. 82985-35-1), 1,2-bis(trimethoxysilyl)ethane (CAS No. 18406-41-2), vinyltri(2-methoxyethoxy) silane (CAS No. 1067-53-4), n-octyltriethoxysilane (CAS No. 2943-75-1), bis[3-(triethoxysilyl) propyl]tetrasulfide (CAS No. 40372-72-3), vinyltriethoxysilane (CAS No. 78-08-0): 3-glycidoxypropyl-trimethoxysilane (CAS No. 2530-83-8), 3-(Triethoxysilyl)propyl isocyanate, 3-mercaptopropyl-triethoxysilane (CAS No. 14814-09-6), 3-glycidoxypropyl-triethoxysilane (CAS No. 2602-34-8), 2-(3,4-epoxycyclohexyl)ethyl]trimethoxysilane (CAS No. 3388-04-3), 3-aminopropyltrimethoxysilane (CAS No. 13822-56-5), 2-(3,4-epoxycyclohexyl)ethyl]triethoxysilane (CAS No. 10217-34-2), 3-aminopropyltriethoxysilane (CAS No. 919-30-2), 3-glycidoxypropyl-methyldimethoxysilane (CAS No. 65799-47-5), bis(triethoxysilylpropyl)amine (CAS No. 13497-18-2), 3-(2-aminoethylamino)propyldimethoxymethylsilane (CAS No. 3069-29-2), N-(n-Butyl)-3-aminopropyltri-methoxysilane (CAS NO. 31024-56-3), n-propyltriethoxysilane (CAS No. 2550-02-9), vinyltrimethoxysilane (CAS No. 2768-02-7), 3-ureidopropyltriethoxy-silane (CAS No. 23779-32-0), 3-methacryloxypropyl-trimethoxysilane (CAS No. 2530-85-0), aqueous 3-aminopropylsilane hydrolysate, and a combination thereof. In some embodiments, the silane coupling agent is aminopropyltriethoxysilane silane. In some embodiments, the aminopropyltriethoxysilane silane is GENIOSIL® GF 93. In some embodiments, the silane coupling agent is 3-aminopropylsilane hydrolysate silane. In some embodiments, 3-aminopropylsilane hydrolysate silane is Dynasylan® HYDROSIL.

In some embodiments, the silane coupling agent is utilized at a low concentration. In some embodiments, the silane coupling agent is about 0.005% to about 4.0% of the particulate by weight. In some embodiments, the silane coupling agent is about 0.02% to about 4% of the particulate by weight. In some embodiments, the silane coupling agent is about 0.04% to about 4% of the particulate by weight. In some embodiments, the silane coupling agent is about 0.06% to about 4% of the particulate by weight. In some embodiments, the silane coupling agent is about 0.06% to about 3% of the particulate by weight. In some embodiments, the silane coupling agent is about 0.06% to about 2% of the particulate by weight. In some embodiments, the silane coupling agent is about 0.06% to about 1% of the particulate by weight. In some embodiments, the silane coupling agent is about 0.06% to about 0.5% of the particulate by weight. In some embodiments, the silane coupling agent is about 0.06% to about 0.4% of the particulate by weight. In some embodiments, the silane coupling agent is about 0.06% to about 0.3% of the particulate by weight. In some embodiments, the silane coupling agent is about 0.06% to about 0.2% of the particulate by weight. In some embodiments, the silane coupling agent is about 0.06% to about 0.15% of the particulate by weight. In some embodiments, the silane coupling agent is about 0.06% to about 0.1% of the particulate by weight. In some embodiments, the silane coupling agent is about 0.06% to about 0.09% of the particulate by weight. In some embodiments, the silane coupling agent is about 0.06% to about 0.08% of the particulate by weight. In some embodiments, the silane coupling agent is about 0.06% to about 0.07% of the particulate by weight.

### The Isocyanate Component

In some embodiments, the isocyanate component comprises a cycloaliphatic isocyanate, an aliphatic isocyanate, or an aromatic isocyanate, or a combination thereof. In some embodiments, the isocyanate component comprises toluol-2,4-diisocyanate; toluol-2,6-diisocyanate (TDI); 1,5 naphthalindiisocyanate; cumol-2,4-diisocyanate; 4-methoxy-1,3-phenyldiisocyanate; 4-chloro-1,3-phenyldiisocyanate; diphenylmethane-4,4-diisocyanate; diphenylmethane-2,4-diisocyanate; diphenylmethane-2,2-diisocyanate; 4-bromo-1,3-phenyldiisocyanate; 4-ethoxy-1,3-phenyl-diisocyanate; 2,4′-diisocyanate diphenylether; 5,6-dimethyl-1,3-phenyl-diisocyanate; methylenediphenyl diisocyanate (including 2,2′-MDI, 2,4′-MDI and 4,4″-MDI); 4,4 diisocyanato-diphenylether; 4,6-dimethyl-1,3-phenyldiisocyanate; 9,10-anthracene-diisocyanate; 2,4,6-toluol triisocyanate; 2,4,4′-triisocyanatodiphenylether; 1,4-tetramethylene diisocyanate; 1,6-hexamethylene diisocyanate (HDI); 1,10-decamethylene-diisocyanate; 1,3-cyclohexylene diisocyanate; 4,4′ methylene-bis-(cyclohexylisocyanate); xylol diisocyanate; 1-isocyanato-3-methyl-isocyanate-3,5,5-trimethylcyclohexane (isophorone diisocyanate); 1-3-bis(isocyanato-1-methylethyl) benzol (m-TMXDI); or 1,4 bis(isocyanato-1-methylethyl) benzol (p-TMXDI), isocyanurate-modified hexamethylene diisocyanate, 1,3,5-tris(6-isocyanatohexyl)biuret (hexamethylene diisocyanate biuret), hexamethylene diisocyanate trimer, or an oligomer or polymer thereof, or a combination thereof. In some embodiments, the aliphatic isocyanate is an isocyanate terminated polypropylene glycol prepolymer based on hydrogenated 4,4′ methylenebis diisocyanate (HMDI). In some embodiments, the aliphatic isocyanate is Lupranate® 5570. In some embodiments, the aliphatic isocyanate is Lupranate® 5570. In some embodiments, the aliphatic isocyanate is Lupranate® M20. In some embodiments, the aliphatic isocyanate is BASF Lupranate 5570. In some embodiments, the isocyanate component comprises a polymeric MDI isocyanate. In some embodiments, the polymeric MDI isocyanate is Dow HF-459. In some embodiments, the polymeric MDI isocyanate is Dow PAPI™ 27. In some embodiments, the polymeric MDI isocyanate is a low viscosity polymeric MDI isocyanate. In some embodiments, the low viscosity polymeric MDI isocyanate is BASF Lupranate M20. In some embodiments, isocyanates are available from the Dow Chemical Company under the tradenames TERAFORCE™, ISONATE™, VORASTAR™, HYPOL™, and PAPI™. In some embodiments, the isocyanates are available from BASF under the tradenames LUPRANATE® and BASONAT®. In some embodiments, the aliphatic isocyanate is, the aliphatic isocyanate is BASF Basonat® HI 2000 NG, Tolonate™ HDT-LV, or Tolonate™ HDB-LV. In some embodiments, the aliphatic isocyanate is BASF Basonat® HI 2000 NG. In some embodiments, Basonat® HI 2000 NG is a solvent free, low viscosity aliphatic polyisocyanate used for weather resistant 2K polyurethane coatings. In some embodiments, the aliphatic isocyanate is Tolonate™ HDT-LV. In some embodiments, the polyisocyanate is based on isocyanurate-modified hexamethylene diisocyanate (HDI). In some embodiments, Tolonate™ HDT-LV is a solvent free, low viscosity aliphatic polyisocyanate used for weather resistant 2K polyurethane coatings. In some embodiments, the polyisocyanate is based on Hexamethylene Diisocyanate trimer. In some embodiments, the aliphatic isocyanate is Tolonate™ HDB-LV. In some embodiments, Tolonate™ HDB-LV is a solvent free, low viscosity aliphatic polyisocyanate used for 2K polyurethane coatings. In some embodiments, the polyisocyanate is based on Hexamethylene Diisocyanate biuret.

In some embodiments, the isocyanate component comprises an isocyanate with at least 1, 2, 3, or 4 reactive isocyanate groups. Other isocyanate-containing compounds may be also used. The suitable isocyanate with at least 2 isocyanate groups such as an aliphatic or an aromatic isocyanate with at least 2 isocyanate groups (e.g. a diisocyanate, triisocyanate or tetraisocyanate), or an oligomer or a polymer thereof can also be used. The isocyanates with at least 2 isocyanate groups can also be, for example, carbocyclic or heterocyclic and/or contain one or more heterocyclic groups. In some embodiments, the isocyanate is a mixture or blend of a diisocyanate or a triisocyanate. In some embodiments, the isocyanate component is a mixture or blend of one or more polyisocyanates, one or more isocyanate terminated prepolymer and/or mixtures of prepolymers with unreacted polyisocyanate compounds. Isocyanate terminated prepolymers can also be formed by reacting a stoichiometric excess of a polyisocyanate with one or more polyols.

In some embodiments, the isocyanate comprises 4,4′-methylenediphenyl diisocyanate. In some embodiments, the isocyanate comprises 4,4′-methylenediphenyl diisocyanate present in a concentration of about 18 to about 25 wt. %. Isocyanate terminated prepolymers may also be used and, for example, have a concentration of free isocyanate moiety (NCO) of 8 wt. % to 37 wt. %. In some embodiments, the mixtures of polyisocyanates have an average isocyanate equivalent weight from about 65 to about 195. In some embodiments, the isocyanate comprises a diphenylmethane diisocyanate and/or as described herein.

In some embodiments, the isocyanate with at least 2 isocyanate groups is a compound of the formula (III) or a compound of the formula (IV):

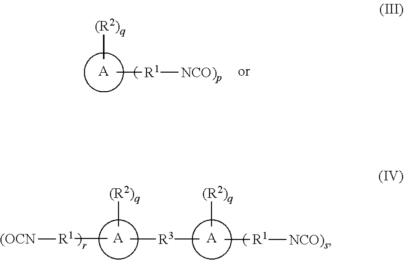

wherein the variables are as provided and defined herein.

In some embodiments, in the formulas (III) and (IV), A is each, independently, an aryl, heteroaryl, cycloalkyl or heterocycloalkyl.

In some embodiments, A is each, independently, an aryl or cycloalkyl. In some embodiments, A is each, independently, an aryl which can be, for example, phenyl, naphthyl or anthracenyl. In some embodiments, A is a phenyl.

In some embodiments, the heteroaryl is a heteroaryl with 5 or 6 ring atoms, of which 1, 2 or 3 ring atoms are each, independently, an oxygen, sulfur or nitrogen atom and the other ring atoms are carbon atoms. In some embodiments, the heteroaryl is a pyridinyl, thienyl, furyl, pyrrolyl, imidazolyl, pyrazolyl, pyrazinyl, pyrimidinyl, pyridazinyl, oxazolyl, isoxazolyl or furazanyl.

In some embodiments, the cycloalkyl is a C₃₋₁₀-cycloalkyl or a C₅₋₇-cycloalkyl.

In some embodiments, the heterocycloalkyl is a heterocycloalkyl with 3 to 10 ring atoms, such as 5 to 7 ring atoms, of which one or more (e.g., 1, 2 or 3) ring atoms are each, independently, an oxygen, sulfur or nitrogen atom and the other ring atoms are carbon atoms. In some embodiments, the heterocycloalkyl is tetrahydrofuranyl, piperidinyl, piperazinyl, aziridinyl, acetidinyl, pyrrolidinyl, imidazolidinyl, morpholinyl, pyrazolidinyl, tetrahydrothienyl, octahydroquinolinyl, octahydroisoquinolinyl, oxazolidinyl or isoxazolidinyl. In some embodiments, the heterocycloalkyl is tetrahydrofuranyl, piperidinyl, piperazinyl, pyrrolidinyl, imidazolidinyl, morpholinyl, pyrazolidinyl, tetrahydrothienyl, oxazolidinyl or isoxazolidinyl.

In some embodiments, in the formulas (III) and (IV), each R¹ is, independently, a covalent bond or C₁₋₄-alkylene (e.g., methylene, ethylene, propylene, or butylene). In some embodiments, each R¹ is a covalent bond.

In some embodiments, in the formulas (III) and (IV), each R² is each, independently, a halogen (e.g., F, Cl, Br or I), a C₁₋₄-alkyl (e.g., methyl, ethyl, propyl or butyl), or C₁₋₄-alkyloxy (e.g., methoxy, ethoxy, propoxy or butoxy). In some embodiments, each R² is, independently, a C₁₋₄-alkyl. In some embodiments, each R² is methyl.

In some embodiments, in the formula (IV), R³ is a covalent bond, a C₁₋₄-alkylene (e.g., methylene, ethylene, propylene or butylene) or a group —(CH₂)_{R31}—O—(CH₂)_{R32}—, wherein R31 and R32 are each, independently, 0, 1, 2 or 3. In some embodiments, R³ is a —CH₂— group or an —O— group.

In some embodiments, in the formula (III), p is equal to 2, 3, or 4. In some embodiments, p is 2 or 3. In some embodiments, p is 2.

In some embodiments, in the formulas (III) and (IV), each q is, independently, an integer from 0 to 3, such as 0, 1, or 2. When q is equal to 0, the corresponding group A has no substituent R², but has hydrogen atoms instead of R².

In some embodiments, in the formula (IV), each r and s are, independently, 0, 1, 2, 3 or 4, wherein the sum of r and s is equal to 2, 3, or 4. In some embodiments, each r and s are, independently, 0, 1, or 2, wherein the sum of r and s is equal to 2. In some embodiments, r is equal to 1 and s is equal to 1.

Non-limiting examples of the isocyanate with at least 2 isocyanate groups are: toluol-2,4-diisocyanate; toluol-2,6-diisocyanate; 1,5-naphthalindiisocyanate; cumol-2,4-diisocyanate; 4-methoxy-1,3-phenyldiisocyanate; 4-chloro-1,3-phenyldiisocyanate; diphenylmethane-4,4-diisocyanate; diphenylmethane-2,4-diisocyanate; diphenylmethane-2,2-diisocyanate; 4-bromo-1,3-phenyldiisocyanate; 4-ethoxy-1,3-phenyl-diisocyanate; 2,4′-diisocyanate diphenylether; 5,6-dimethyl-1,3-phenyl-diisocyanate; 2,4-dimethyl-1,3-phenyldiisocyanate; 4,4-diisocyanato-diphenylether; 4,6-dimethyl-1,3-phenyldiisocyanate; 9,10-anthracene-diisocyanate; 2,4,6-toluol triisocyanate; 2,4,4′-triisocyanatodiphenylether; 1,4-tetramethylene diisocyanate; 1,6-hexamethylene diisocyanate (HDI); 1,10-decamethylene-diisocyanate; 1,3-cyclohexylene diisocyanate; 4,4′-methylene-bis-(cyclohexylisocyanate); xylol diisocyanate; 1-isocyanato-3-methyl-isocyanate-3,5,5-trimethylcyclohexane (isophorone diisocyanate); 1-3-bis(isocyanato-1-methylethyl) benzol (m-TMXDI); 1,4-bis(isocyanato-1-methylethyl) benzol (p-TMXDI); isocyanurate-modified hexamethylene diisocyanate, 1,3,5-tris(6-isocyanatohexyl)biuret (hexamethylene diisocyanate biuret), hexamethylene diisocyanate trimer, or oligomers or polymers of the above mentioned isocyanate compounds; or mixtures of two or more of the above mentioned isocyanate compounds or oligomers or polymers thereof.

In some embodiments, the isocyanates with at least 2 isocyanate groups are toluol diisocyanate, diphenylmethane diisocyanate, an oligomer based on toluol diisocyanate, or an oligomer based on diphenylmethane diisocyanate.

### The Isocyanate Reactive Blend

In some embodiments, the polyurethane is formed by reacting the isocyanate component with an isocyanate reactive blend. Other non-limiting exemplary conditions and ratios are described in Example 1 for producing the polyurethane, including the use of catalysts. The isocyanate reactive blend may or may not have reactive amine functionality.

In some embodiments, the isocyanate reactive blend consists of one or more hydroxy functional compounds, one or more catalysts, pigments, dyes, antimicrobial agents, surfactants, silicone, functionalized and non-functionalized fumed silica, fumed alumina, block copolymers, amphiphilic diblock polymers, amphiphilic triblock polymers, dispersed polymer particles in polyols, DI water and/or UV stabilizers. The isocyanate reactive blend can, for example, have an average of at least 1 hydroxyl group per molecule. Hydroxy functional compounds include polyether polyols, polyester polyols, polyether-polyester polyols, branched polyether-polyester polyols, polycaprolactone polyols, cardanol, cardol, castor oil, monols, and mixtures thereof. Exemplary hydroxy functional compounds include 1,2-propanediol, 1,4-butanediol, 1,6-hexanediol, glycerin, ethylene glycol, diethylene glycol, triethylene glycol, 1,2-propylene glycol, 1,3-propylene glycol, dipropylene glycol, tripropylene glycol, trimethylolpropane, trimethylolethane, triethanolamine, polyether polyols available from Dow under the tradename VORANOL™ polyether polyols, blend of a polyether polyol and a polyol available from Dow as TERAFORCE™ 62575 (XUS 62575); polymer polyol containing dispersed polymer particles available from Dow as DNC 701.01, polymer polyol containing dispersed polymer particles with a solids content of approximately 40 wt. % available from Dow as VORALUX™ HL 431, polyether polyols available from BASF under the tradename PLURACOL® polyether polyols such as PLURACOL 1016; PLURACOL 410R; PLURACOL 858; PLURACOL 1158; PLURACOL PEP 450; PLURACOL PEP 550, polyester polyols available from BASF under the tradename LUPRAPHEN® polyester polyols, aliphatic polyols available from Alberdingk Boley under the tradename ALBODUR® polyols and polyether-polyester polyols from Cardolite under the tradename Cardolite® polyol such as Cardolite® NX-9014. In some embodiments, Cardolite® NX-9014 is a solvent free, low viscosity, branched polyether-polyester polyol used for weather resistant 2K polyurethane coatings and adhesives. In some embodiments, Cardolite® NX-9014 is based on Cashew Nutshell Liquid (CNSL), a natural, non-food chain, and annually renewable biomaterial. Exemplary catalysts include dibutyltin dilaurate available from Evonik as Dabco® T-12 and tertiary amine catalyst available from Evonik as Dabco® ™ R. Exemplary pigments include thermoset colorants available from Chromaflo under the tradename PLAS™ DL thermoset colorants, IR reflective colorants available from Chromaflo under the tradename CHROMA-CHEM® 50-990. Exemplary UV stabilizers include BASF Tinuvin® 5050; BASF Tinuvin® 292; BASF Tinuvin® 384-2; and BASF Tinuvin® 5333-DW (N).

In some embodiments, the IR reflective colorant reduces the heating effect in sunlight by reflecting the near infrared (NIR) portion of the spectrum resulting cooling effect. In some embodiments, the IR reflective colorant is Chromaflo's Plasticolors® DL50056. In some embodiments, the IR reflective colorant is Plasticolors® DL80943. In some embodiments, the IR reflective colorant CHROMA-CHEM® 50-990.

In some embodiments, the isocyanate reactive blend comprises an additive as described herein. In some embodiments, the additive is a UV stabilizer, a surfactant, an antimicrobial agent, an anti-block pigment, a tint, a dye, a wetting agent, an antifoaming agent, a plasticizer, or a blowing agent, a silicone fluid, silicone glycols, polydimethylsiloxane fluids, silicone resins, antifoam agents, DI water, or a combination thereof. In some embodiments, the additives are, but are not limited to, impact strength enhancers, reinforcing agents, reaction rate enhancers or catalysts, crosslinking agents, optical brighteners, propylene carbonates, coloring agents, fluorescent agents, whitening agents, hindered amine light stabilizers, processing aids, mica, talc, nano-fillers, silane coupling agents, anti-slip agents, water affinity or repulsion components, water-activated agents, viscosifiers, flow-aids, anticaking agents, wetting agents, and/or toughening agents such as one or more block copolymers.

In some embodiments, the polyol is a mixture or blend of a polyol and a polyether polyol. In some embodiments, the polyol is a mixture or blend of about 20 to about 30% polyol by weight and the polyether polyol is about 70 to about 80% by weight, wherein the total of the polyol and the polyether polyol is 100%. The polyether polyol can be a mixture or blend of 2 or more polyether polyols with different molecular weights. A low molecular weight polyether polyol could have an average molecular weight from 30 g/mol to 900 g/mol. A high molecular weight could have an average molecular weight from 900 g/mol to 3500 g/mol. The polyether polyols could have an average hydroxyl functionality higher than 2. Polyether polyols could be derived from ethylene oxide, propylene oxide, and/or butylene oxide. In some embodiments, the polyether polyol is an aliphatic polyol. In some embodiments, the aliphatic polyol is plant-based. In some embodiments, the plant-based aliphatic polyol is green. In some embodiments, the green plant-based aliphatic polyol is Albodur 1055. In some embodiments, the polyether polyol is Dow TERAFORCE™ 62575. In some embodiments, the isocyanate reactive blend comprises a molecular weight polyol. In some embodiments, the low molecular weight polyol is 1,4-butanediol. In some embodiments, the polyol is glycerin. In some embodiments, polyurethane dispersions include solvent-free, colloidal, anionic, low viscosity, aliphatic dispersions available from Alberdingk Boley under the trade name Alberdingk® U.

In some embodiments, the polyol is a mixture or blend of a polyol and a polyether-polyester polyol. In some embodiments, the polyether-polyester polyol is a branched polyether-polyester polyol. In some embodiments, the polyether-polyester polyol is a mixture of one or more polyether-polyester polyols and one or more branched polyether-polyester polyol. In some embodiments, the polyol is a mixture or blend of about 20 to about 30% polyol by weight and the polyether-polyester polyol is about 70 to about 80% by weight, wherein the total of the polyol and the polyether-polyester polyol is 100%. The polyether-polyester polyol can be a mixture or blend of 2 or more polyether-polyester polyols with different molecular weights. A low molecular weight polyether-polyester polyol could have an average molecular weight from 30 g/mol to 900 g/mol. A high molecular weight could have an average molecular weight from 900 g/mol to 3500 g/mol. The polyether-polyester polyols can, for example, have an average hydroxyl functionality higher than 2. Polyether-polyester polyols could be derived from cashew nutshell liquid. In some embodiments, the polyether-polyester polyols a Cardolite® NX-9014.

In some embodiments, the polyol is a mixture or blend selected from any combinations of one or more polyol, one or more polyether polyol, one or more polyether-polyester polyol, and one or more branched polyether-polyester polyol as described or provided herein. In some embodiments, the polyol is a mixture or blend selected from any combinations of one or more polyether polyol, one or more polyether-polyester polyol and one or more branched polyether-polyester polyol as described or provided herein. In some embodiments, the polyol is a mixture or blend selected from any combinations of one or more polyether polyol and one or more polyether-polyester polyol as described or provided herein. In some embodiments, the polyol is a mixture or blend selected from any combinations of one or more polyether polyol and one or more branched polyether-polyester polyol as described or provided herein. In some embodiments, the polyol is a mixture or blend selected from any combinations of one or more polyether-polyester polyol and one or more branched polyether-polyester polyol as described or provided herein.

### Epoxy Coatings

In some embodiments, the epoxy emulsion layer comprises an epoxy resin and an epoxy hardener or curing agent. Examples of epoxy hardeners and curing agents include, but are not limited to, aliphatic amines (e.g., Diethylene-triamine (DETA), triethylenetetraamine (TETA), tetraethylenepentamine (TEPA), aminoethylpiperazine (N-AEP), m-xylenediamine (MXDA), 2-methylpentanediamine (MPMD)); cycloaliphatic amines (e.g. Isophoronediamine (IPDA), methylene-di(cyclohexylamine) (PACM), diaminocyclohexane); aromatic amines (e.g. 4,4′-Diaminodiphenyl methane (DDM), 4,4′-Diaminodiphenyl sulfone (DDS), methylene-bis(diisopropylaniline) (MPDA), methylene-bis(dimethylaniline), diethyl toluene diamine (DETDA); and anhydrides (e.g., hexahydrophthalic acid anhydride, dicyclopentadiene dianhydride, mellitic anhydride, methyl tetrahydrophthalic anhydride, and nadic methyl anhydride). In some embodiments, the hardener or curing agent is triethylenetetraamine. In some embodiments, the hardener or curing agent is diethylenetriamine. In some embodiments, prior to coating the particle with the epoxy emulsion layer, the epoxy emulsion is mixed with a curing agent or hardener. Examples of epoxy hardeners and curing agents include, but are not limited to, aliphatic amines (e.g., Diethylene triamine (DETA), triethylenetetraamine (TETA), tetraethylenepentamine (TEPA), aminoethylpiperazine (N-AEP), m-xylenediamine (MXDA), 2-methylpentanediamine (MPMD)); cycloaliphatic amines (e.g., Isophoronediamine (IPDA), methylene-di(cyclohexylamine) (PACM), diaminocyclohexane); aromatic amines (e.g., 4,4′-Diaminodiphenyl methane (DDM), 4,4′-Diaminodiphenyl sulfone (DDS), methylene-bis(diisopropylaniline) (MPDA), methylene-bis(dimethylaniline), diethyl toluene diamine (DETDA); and anhydrides (e.g., hexahydrophthalic acid anhydride, dicyclopentadiene dianhydride, mellitic anhydride, methyl tetrahydrophthalic anhydride, and nadic methyl anhydride). In some embodiments, the hardener or curing agent is triethylenetetraamine. In some embodiments, a ratio of epoxy reactive sites to amine reactive sites is about of 0.8-1.2 (epoxy equivalent weight to amine equivalent weight). In some embodiments, the epoxy emulsion is contacted with the particle in the amount of about 0.1 to about 10.00 wt %.

### Phenolic Coatings

In some embodiments, the methods comprise curing the at least one phenol-aldehyde resin layer with a curative agent, wherein the curative agent is applied in an amount of about 5 to about 15 wt. % of the phenol-aldehyde resin. The curing agent can be added prior to the phenol-aldehyde resin being coated onto the particle or simultaneously with the phenol-aldehyde resin being coated onto the particle. In some embodiments, the curative agent is added in an amount of about 9% to about 14%, about 10% to about 13%, about 10% to about 12%, about 10% to about 11%, about 9%, about 10%, about 11%, about 12%, or about 13% of the curative agent, which can also be referred to as a cross-linking agent. In some embodiments, the curative agent is hexamethylenetetramine, paraformaldehyde, melamine resin, triphenylphosphine, oxazolidines, or any combination thereof. In some embodiments, the phenol-aldehyde resin on the coated particulate as described and provided herein is in the amount of about 0.1 to about 10.0 wt % of the coated particulates.

In some embodiments, the isocyanate reactive blend further comprises a colorant. In some embodiments, the colorant is to achieve a desired aesthetic effect. In some embodiments, the colorant to achieve a desired aesthetic effect is a colorant.

In some embodiments, the colorant achieves a green color. In some embodiments, the colorant is an organic polyol based colorant. In some embodiments, the organic polyol based colorant comprises phthalocyanine green G. In some embodiments, the polyol-based colorant comprises Chromaflo's Plasticolors® DL50056. In some embodiments, Plasticolors® DL-50056 is an organic colorant using Phthalocyanine green (PG7) dispersed in a polyether polyol for use in polyurethane systems. In some embodiments, the colorant comprises chrome (III) oxide (Cr₂O₃).

In some embodiments, the colorant achieves a white color. In some embodiments, the colorant comprises Plasticolors® DL 10106

In some embodiments, the colorant achieves a black color. In some embodiments, the colorant comprises iron oxide (FeO₂). In some embodiments, the colorant comprises Plasticolors® DL 02551, Plasticolors® DL 02553, Plasticolors® DL 30164, or any combination thereof. In some embodiments, the colorant comprises Plasticolors® DL 02551. In some embodiments, the colorant comprises Plasticolors® DL 02553. In some embodiments, the colorant comprises Plasticolors® DL 30164.

In some embodiments, the colorant achieves a blue color. In some embodiments, the colorant comprises Plasticolors® DL 30669.

In some embodiments, the colorant achieves a magenta color. In some embodiments, the colorant comprises Plasticolors® DL 070072.

In some embodiments, the colorant achieves a red color. In some embodiments, the colorant comprises Plasticolors® DL 70239, Plasticolors® DL 70840, or a combination thereof. In some embodiments, the colorant comprises Plasticolors® DL 70239. In some embodiments, the colorant comprises Plasticolors® DL 70840.

In some embodiments, the colorant achieves a yellow color. In some embodiments, the colorant is an organic polyol based colorant. In some embodiments, the colorant comprises Plasticolors® DL 80943, Plasticolors® DL 80166, Plasticolors® DL 80167, Plasticolors® DL 80815, or any combination thereof. In some embodiments, the colorant comprises Plasticolors® DL 80943. In some embodiments, Plasticolors® DL-80943 is an inorganic colorant using Bismuth Vanadate dispersed in a polyether polyol for use in polyurethane systems. In some embodiments, the colorant comprises Plasticolors® DL 80166. In some embodiments, the colorant comprises Plasticolors® DL 80167. In some embodiments, the colorant comprises Plasticolors® DL 80815.

In some embodiments, the colorant to achieve a desired aesthetic effect comprises a mixture or a blend of one or more colorants. In some embodiments, the colorant comprises a green colorant, a yellow colorant, a back colorant, a red colorant, a blue colorant, magenta colorant, a white colorant or any combination thereof. In some embodiments, the colorant comprises Plasticolors® DL-50056, Plasticolors® DL-80943, Plasticolors® DL-20711, or a combination thereof.

In some embodiments, the colorant comprises a mixture of a green colorant and a yellow colorant. In some embodiment, the weight ratio of the green colorant to the yellow colorant is from about 1:10 to about 10:1, from about 1:9 to about 9:1, from about 1:8 to about 8:1, from about 1:7 to about 7:1, from about 1:6 to about 6:1, from about 1:5 to about 5:1, from about 1:4 to about 4:1 from about 1:3 to about 3:1, or from about 1:2 to about 1:1. In some embodiment, the weight ratio of the green colorant to the yellow colorant is from about 1:9 to about 10:1. In some embodiment, the weight ratio of the green colorant to the yellow colorant is from about 1:8 to about 10:1. In some embodiment, the weight ratio of the green colorant to the yellow colorant is from about 1:7 to about 6:1. In some embodiment, the weight ratio of the green colorant to the yellow colorant is from about 1:5 to about 10:1. In some embodiment, the weight ratio of the green colorant to the yellow colorant is from about 1:4 to about 10:1. In some embodiment, the weight ratio of the green colorant to the yellow colorant is from about 1:3 to about 10:1. In some embodiment, the weight ratio of the green colorant to the yellow colorant is from about 1:2 to about 10:1. In some embodiment, the weight ratio of the green colorant to the yellow colorant is from about 1:1 to about 10:1. In some embodiment, the weight ratio of the green colorant to the yellow colorant is from about 2:1 to about 10:1. In some embodiment, the weight ratio of the green colorant to the yellow colorant is from about 3:1 to about 10:1. In some embodiment, the weight ratio of the green colorant to the yellow colorant is from about 4:1 to about 10:1. In some embodiment, the weight ratio of the green colorant to the yellow colorant is from about 5:1 to about 10:1. In some embodiment, the weight ratio of the green colorant to the yellow colorant is from about 6:1 to about 10:1. In some embodiment, the weight ratio of the green colorant to the yellow colorant is from about 7:1 to about 10:1. In some embodiment, the weight ratio of the green colorant to the yellow colorant is from about 8:1 to about 10:1. In some embodiment, the weight ratio of the green colorant to the yellow colorant is from about 9:1 to about 10:1.

In some embodiment, the weight ratio of the yellow colorant to the green colorant is from about 1:10 to about 10:1. In some embodiment, the weight ratio of the yellow colorant to the green colorant is from about 1:9 to about 10:1. In some embodiment, the weight ratio of the yellow colorant to the green colorant is from about 1:8 to about 10:1. In some embodiment, the weight ratio of the yellow colorant to the green colorant is from about 1:7 to about 6:1. In some embodiment, the weight ratio of the yellow colorant to the green colorant is from about 1:5 to about 10:1. In some embodiment, the weight ratio of the yellow colorant to the green colorant is from about 1:4 to about 10:1. In some embodiment, the weight ratio of the yellow colorant to the green colorant is from about 1:3 to about 10:1. In some embodiment, the weight ratio of the yellow colorant to the green colorant is from about 1:2 to about 10:1. In some embodiment, the weight ratio of the yellow colorant to the green colorant is from about 1:1 to about 10:1. In some embodiment, the weight ratio of the yellow colorant to the green colorant is from about 2:1 to about 10:1. In some embodiment, the weight ratio of the yellow colorant to the green colorant is from about 3:1 to about 10:1. In some embodiment, the weight ratio of the yellow colorant to the green colorant is from about 4:1 to about 10:1. In some embodiment, the weight ratio of the yellow colorant to the green colorant is from about 5:1 to about 10:1. In some embodiment, the weight ratio of the yellow colorant to the green colorant is from about 6:1 to about 10:1. In some embodiment, the weight ratio of the yellow colorant to the green colorant is from about 7:1 to about 10:1. In some embodiment, the weight ratio of the yellow colorant to the green colorant is from about 8:1 to about 10:1. In some embodiment, the weight ratio of the yellow colorant to the green colorant is from about 9:1 to about 10:1.

In some embodiment, the weight ratio of the yellow colorant to the green colorant is about 1:10. In some embodiment, the weight ratio of the yellow colorant to the green colorant is about 1:9. In some embodiment, the weight ratio of the yellow colorant to the green colorant is about 1:8. In some embodiment, the weight ratio of the yellow colorant to the green colorant is about 1:7 to about 6:1. In some embodiment, the weight ratio of the yellow colorant to the green colorant is about 1:5. In some embodiment, the weight ratio of the yellow colorant to the green colorant is about 1:4. In some embodiment, the weight ratio of the yellow colorant to the green colorant is about 1:3. In some embodiment, the weight ratio of the yellow colorant to the green colorant is about 1:2. In some embodiment, the weight ratio of the yellow colorant to the green colorant is about 1:1. In some embodiment, the weight ratio of the yellow colorant to the green colorant is about 2:1. In some embodiment, the weight ratio of the yellow colorant to the green colorant is about 3:1. In some embodiment, the weight ratio of the yellow colorant to the green colorant is about 4:1. In some embodiment, the weight ratio of the yellow colorant to the green colorant is about 5:1. In some embodiment, the weight ratio of the yellow colorant to the green colorant is about 6:1. In some embodiment, the weight ratio of the yellow colorant to the green colorant is about 7:1. In some embodiment, the weight ratio of the yellow colorant to the green colorant is about 8:1. In some embodiment, the weight ratio of the yellow colorant to the green colorant is about 9:1. In some embodiment, the weight ratio of the yellow colorant to the green colorant is about 10:1.

In some embodiments, the isocyanate reactive blend further comprises a polyurethane catalyst. In some embodiments, the polyurethane catalyst include tin containing catalysts such as dibutyltin diacetate, dibutyltin dialaurate, dibutyltin oxide, dibutyltin dimalkylmercapto acids, and dibutyltin dimercaptide and trimerization catalysts that form polyisocyanate trimers include alkali metal phenolates, alkali metal alkoxides, alkali metal carboxylates, quaternary ammonium carboxylate salts and various amines. In some embodiments, the polyurethane catalyst is dibutyltin dilaurate (Dabco T-12). In some embodiments, the polyurethane catalyst is a dimethyltin carboxylate (TIB Kat®300).

In some embodiments, the isocyanate reactive blend further comprises a UV stabilizer. In some embodiments, the UV stabilizer is a hindered amine light stabilizer, benzophenone, benzotriazoie, hydroxyphenyl triazine, 2-(2′-hydroxyphenyl)benzotriazoles, Uvinol 3000, Tinuvin® P, Irganox 1098, Uvinol 3008, Lavinix, BHT, Tinuvin® 320, Irganox 1010, rganox 1076, or Irgafos 168, or a combination thereof. In some embodiments, the UV stabilizer is a solvent-free, liquid blend of a 2-(2-hydroxyphenyl)-benzotriazole UV absorber (UVA) and a basic hindered amine light stabilizer (HALS). In some embodiments, the UV stabilizer is BASF Tinuvin® 5050. The coated particulate of claim 40, wherein the UV stabilizer is BASF Tinuvin® 5050. In some embodiments, the UV stabilizer is BASF is Tinuvin® 384-2. In some embodiments, the UV stabilizer is BASF Tinuvin® 123, Tinuvin® 152, or a combination thereof. In some embodiments, the isocyanate reactive blend further comprises antioxidants. In some embodiments, the antioxidant is a liquid phenol benzenepropanoic acid such as 3,5-bis (1,1-dimethyl-ethyl)-4-hydroxy-C7-C9 branched alkyl esters. In some embodiments the antioxidants are BASF Irganox® 1135, and Addivant™ ANOX® 1315.

In some embodiments, the polymeric coating comprises one or more impact modifiers. Impact modifiers have an effect on elastic properties and toughness of coatings. Elastomeric polymers derived from monomers such as ethylene, propylene, 1-butene and 4-methyl-1-pentene, styrene, butadiene, isoprene, vinyl acetate, acrylic acid, acrylonitrile, methyl methacrylate ethyl acrylate, and polymers comprising random, block, radial block, graft and core-shell copolymers and mixtures thereof. Commercial suitable copolymers are acrylonitrile/butadiene/styrene (ABS), polystyrene/polybutadiene/polystyrene (SBS), styrene/isoprene/styrene (SIS), nitrile rubber, styrene-acrylonitrile, and ethylene-vinyl acetate available from KRATON™. In some embodiments, the impact modifiers may be grafted polyols containing copolymerized styrene and acrylonitrile, available from Dow as DNC 701.01, and VORALUX™ HL 431.

In some embodiments, the isocyanate reactive blend comprises a phenol resin that comprises a condensation product of a phenol and an aldehyde, such as formaldehyde. In some embodiments, the phenol resin can be, for example, a resole or novolak phenol resin and/or a benzyl ether resin.

The resole-type phenol resin can be obtained, for example, by condensation of phenol or of one or more compounds of the following formula (I), with aldehydes, such as, but not limited to, formaldehyde, under basic conditions.

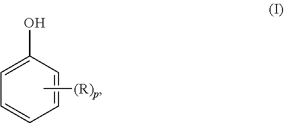

wherein R and p are provided and defined herein.

In some embodiments, R in the formula (I) is in each case, independently, a hydrogen atom, a halogen atom, C₁₋₁₆-alkyl or —OH (hydroxyl). In some embodiments, R is C₁₋₁₂-alkyl, C₁₋₆-alkyl, methyl, ethyl, propyl or butyl.

In some embodiments, p in the formula (I) is an integer from 0 to 4, such as 0, 1, 2 or 3. In some embodiments, p is 1 or 2. Those in the art will understand that when p is 0, the compound of formula (I) is phenol.

Novolak-type phenol resin comprises the condensation product of phenol or of one or more compounds of the formula (I) defined above, with aldehydes, such as formaldehyde, under acidic conditions.

In some embodiments, the polyol also comprises a polyether polyol. In some embodiments, the polyol comprises a benzyl ether resin of the general formula (II):

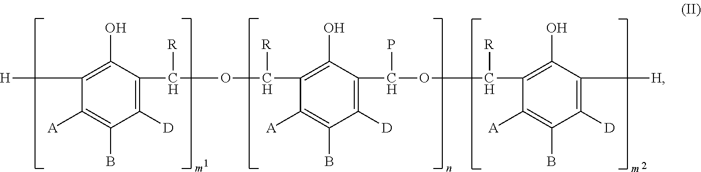

wherein A, B, D, and R are as provided and defined herein.

In some embodiments, A, B, and D each are, independently, a hydrogen atom, a halogen atom, a C₁₋₁₆-hydrocarbon residue, —(C₁₋₁₆-alkylene)-OH, —OH, an —O—(C₁₋₁₆-hydrocarbon residue), phenyl, —(C₁₋₆-alkylene)-phenyl, or —(C₁₋₆-alkylene)-phenylene-OH. In some embodiments, the halogen atom is F, Cl, Br or I. In some embodiments, the C₁₋₁₆-hydrocarbon-residue is C₁₋₁₆-alkyl, C₂₋₁₆-alkenyl or C₂₋₁₆-alkinyl, or C₁₋₁₂-alkyl, C₂₋₁₂-alkenyl or C₂₋₁₂-alkinyl, or C₁₋₆-alkyl, C₂₋₆-alkenyl or C₂₋₆-alkinyl, or C₁₋₄-alkyl, C₂₋₄-alkenyl or C₂₋₄-alkinyl, or C₁₋₁₂-alkyl, C₁₋₆-alkyl, or methyl, ethyl, propyl or butyl, or methyl;

In some embodiments, the residue —(C₁₋₁₆-alkylene)-OH is —(C₁₋₁₂-alkylene)-OH, —(C₁₋₆-alkylene)-OH, —(C₁₋₄-alkylene)-OH, or a methylol group (—CH₂—OH);

In some embodiments, the —O—(C₁₋₁₆-hydrocarbon)-residue is C₁₋₁₆-alkoxy, C₁₋₁₂-alkoxy, C₁₋₆-alkoxy, C₁₋₄-alkoxy, —O—CH₃, —O—CH₂CH₃, —O—(CH₂)₂CH₃ or —O—(CH₂)₃CH₃. In some embodiments, the residue —(C₁₋₆-alkylene)-phenyl can be —(C₁₋₄-alkylene)-phenyl, or —CH₂-phenyl.

In some embodiments, the residue —(C₁₋₆-alkylene)-phenylene-OH can be —(C₁₋₄-alkylene)-phenylene-OH, or —CH₂-phenylene-OH.

In some embodiments, R is a hydrogen atom of a C₁₋₆-hydrocarbon residue (e.g. linear or branched C₁₋₆-alkyl). In some embodiments, R is a hydrogen atom. This is the case, for example, when formaldehyde is used as aldehyde component in a condensation reaction with phenols in order to produce the benzyl ether resin of the formula (II).

In some embodiments, m¹ and m² are each, independently, 0 or 1.

In some embodiments, n is an integer from 0 to 100, such as from 1 to 50, from 2 to 10, or from 2 to 5.

In some embodiments, the sum of n, m¹ and m² is at least 2.

In some embodiments, the isocyanate reactive blend is a phenol resin with monomer units based on cardol and/or cardanol. Cardol and cardanol are produced from cashew nut oil, which is obtained from the seeds of the cashew nut tree. Cashew nut oil consists of about 90% anacardic acid to about 10% cardol. By heat treatment in an acid environment, a mixture or blend of cardol and cardanol is obtained by decarboxylation of the anacardic acid. Cardol and cardanol have the structures shown below:

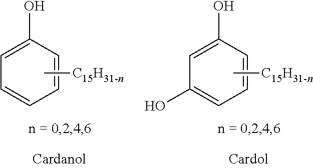

As shown in the illustration above, the hydrocarbon residue (—C₁₅H₃₁₋ₙ) in cardol and/or in cardanol can have one (n=2), two (n=4) or three (n=6) double bonds. Cardol specifically refers to compound CAS-No. 57486-25-6 and cardanol specifically to compound CAS-No. 37330-39-5.

Cardol and cardanol can each be used alone or at any particular mixing ratio in the phenol resin. Decarboxylated cashew nut oil can also be used.

Cardol and/or cardanol can be condensed into the above described phenol resins, for example, into the resole- or novolak-type phenol resins. For this purpose, cardol and/or cardanol can be condensed e.g. with phenol or with one or more of the above-defined compounds of the formula (I), and also with aldehydes, such as formaldehyde.

The amount of cardol and/or cardanol which is condensed in the phenol resin is not particularly restricted and can be, for example, from about 1 wt. % to about 99 wt. %, about 5 wt. % to about 60 wt. %, or about 10 wt. % to about 30 wt. %, relative to 100 wt. % of the amount of phenolic starting products used in the phenol resin.

In some embodiments, the isocyanate reactive blend is a phenol resin obtained by condensation of cardol and/or cardanol with aldehydes, such as formaldehyde.

A phenol resin that contains monomer units based on cardol and/or cardanol as described above, or which can be obtained by condensation of cardol and/or cardanol with aldehydes, has a particularly low viscosity and can thus be used with a low addition or without addition of reactive thinners. Moreover, this kind of long-chain, substituted phenol resin is comparatively hydrophobic, which results in a favorable shelf life of the coated proppants obtained process described herein. In addition, a phenol resin of this kind is also advantageous because cardol and cardanol are renewable raw materials.

In some embodiments, the isocyanate that is used to form the polyurethane has an equivalent weight of about 140. In some embodiments, the hydroxyl equivalent of the polyol that is used to form the polyurethane layer is about 85.

In some embodiments, one or more additives can be mixed with the proppant, the isocyanate reactive blend and the isocyanate component. These additives are not particularly restricted and can be selected from the additives known in the specific field of coated proppants. Provided that one of these additives has hydroxyl groups, it should be considered as a different hydroxyl-group-containing compound, as described above in connection with the isocyanate reactive blend. If one of the additives has isocyanate groups, it should be considered as a different isocyanate-group-containing compound. Additives with hydroxyl groups and isocyanate groups can be simultaneously considered as different hydroxyl-group-containing compounds and as different isocyanate-group-containing compounds.

In some embodiments, the coating comprises a reactive amine component, such as, but not limited to, an amine-terminated compound. This component can enhance crosslink density within the coating and, depending on component selection, can provide additional characteristics of benefit to the cured coating. In some embodiments, the amine components for include, but are not limited to, amine-terminated compounds such as diamines, triamines, amine-terminated glycols such as the amine-terminated polyalkylene glycols.

Non-limiting examples of diamines include primary, secondary and higher polyamines and amine-terminated compounds. Suitable compounds include, but are not limited to, ethylene diamine; propylenediamine; butanediamine; hexamethylenediamine; 1,2-diaminopropane; 1,4-diaminobutane; 1,3-diaminopentane; 1,6-diaminohexane; 2,5-diamino-2,5-dimethylhexane; 2,2,4- and/or 2,4,4-trimethyl-1,6-diaminohexane; 1,11-diaminoundecane; 1,12-diaminododecane; 1,3- and/or 1,4-cyclohexane diamine; 1-amino-3,3,5-trimethyl-5-aminomethyl-cyclohexane; 2,4- and/or 2,6-hexahydrotoluylene diamine; 2,4′ and/or 4,4′-diaminodicyclohexyl methane and 3,3′-dialkyl-4,4′-diamino-dicyclohexyl methanes such as 3,3′-dimethyl-4,4-diamino-dicyclohexyl methane and 3,3′-diethyl-4,4′-diaminodicyclohexyl methane; aromatic polyamines such as 2,4- and/or 2,6-diaminotoluene and 2,6-diaminotoluene and 2,4′ and/or 4,4′-diaminodiphenyl methane; and polyoxyalkylene polyamines (also referred to herein as amine terminated polyethers).

Mixtures of polyamines may also be employed in preparing aspartic esters, which is a secondary amine derived from a primary polyamine and a dialkyl maleic or fumaric acid ester. Representative examples of useful maleic acid esters include dimethyl maleate, diethyl maleate, dibutyl maleate, dioctyl maleate, mixtures thereof and homologs thereof.

Suitable triamines and higher multifunctional polyamines include, but are not limited to, diethylene triamine, triethylenetetramine, and higher homologs of this series.

JEFFAMINE diamines include the D, ED, and EDR series products. The D signifies a diamine, ED signifies a diamine with a predominately polyethylene glycol (PEG) backbone, and EDR designates a highly reactive, PEG based diamine. See also U.S. Pat. Nos. 6,093,496; 6,306,964; 5,721,315; 7,012,043; and Publication U.S. Patent Application No. 2007/0208156 the disclosure of which are hereby incorporated by reference.

### Optional Amine-Based Latent Curing Agents

Amine-based latent curing agents can also be added to the coating formulation in the isocyanate component, the isocyanate reactive blend, the amine-reactive isocyanate reactive blend or added simultaneously as any of these components or pre-coated on the proppant. Suitable amine-based latent curing agents include, but are not limited to, triethylenediamine; bis(2-dimethylaminoethyl)ether; tetramethylethylenediamine; pentamethyldiethylenetriamine; and other tertiary amine products of alkyleneamines. Additionally, other catalysts that promote the reaction of isocyanates with hydroxyls and amines that are known by the industry can be used.

### Additives

In some embodiments, the polymeric coating of coated particulates as provided and described herein may also comprise various additives. In some embodiments, the polymeric coating with additives is in the polyurethane coating. In some embodiments, the additive is introduced to the polyurethane polymeric coating via an isocyanate reactive blend or an isocyanate blend as provided and described herein. In some embodiments, the additive is introduced to the polyurethane polymeric coating via an isocyanate reactive blend as provided and described herein. In some embodiments, the additive is introduced to the polyurethane polymeric coating via an isocyanate blend as provided and described herein.

In some embodiments, the additives are in the same layer of coating of the coated particulate as provided and described herein. In some embodiments, the additives are in the different layer of coating of the coated particulate as provided and described herein.

In some embodiments, the additive is a UV stabilizer, a surfactant, an antimicrobial agent, an anti-block pigment, a tint, a dye, an IR reflective colorant, an impact modifier, an omniphobic low surface energy agent, a wetting agent, an antifoaming agent, a plasticizer, or a blowing agent, a silicone fluid, DI water, or a combination thereof.

In some embodiments, the UV stabilizers and pigments or dyes are incorporated in the same coating of the coated particulate for a turf infill as illustrated in FIG. 1.

In some embodiments, the pigments or dyes are incorporated only in the inner coating of the coated particulate for a turf infill as illustrated in FIG. 2.

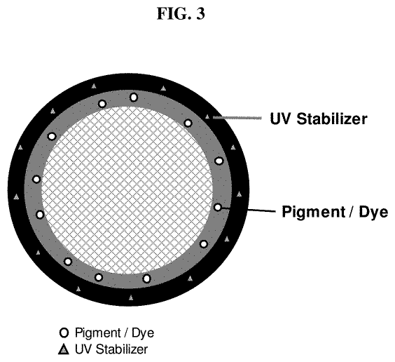

In some embodiments, the UV stabilizers and pigments or dyes are incorporated in the different coatings of the coated particulate for a turf infill, for example, pigments or dyes are incorporated inner layer, while UV stabilizers are incorporated in the outer layer of the coatings as illustrated in FIG. 3.

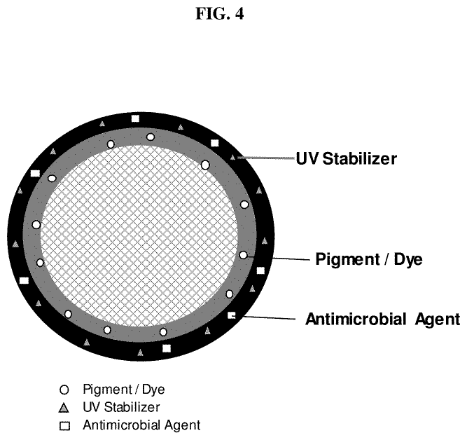

In some embodiments, the antimicrobial agents are incorporated into the outer layer of the coatings of the coated particulate for a turf infill along with UV stabilizers while pigments or dyes are incorporated in the inner layer as illustrated in FIG. 4.

In some embodiments, the additive is an impact strength enhancer, a reinforcing agent, a reaction rate enhancer or catalyst, a crosslinking agent, an optical brightener, a propylene carbonate, a coloring agent, a fluorescent agent, a whitening agent, a hindered amine a light stabilizer, a processing aid, a mica, a talc, a nano-filler, a silane coupling agent, an anti-slip agent, a water affinity or repulsion component, a water-activated agent, a viscosifier, a flow aid, an anticaking agent, a wetting agent, or a toughening agent such as one or more block copolymers, or a combination thereof.

In some embodiments, the additive is a surfactant. The surfactants may be anionic, cationic, amphoteric, nonionic, or mixtures thereof. In some embodiments, the surfactant is an anionic surfactant. In some embodiments, the anionic surfactant is sodium lauryl sulfate (SLS). In some embodiments, the surfactant is Cocamidopropyl Hydroxysultaine (Chembetaine™ Lubrizol)

In some embodiments, the additive is an antimicrobial agent as provided and described herein. In some embodiments, the antimicrobial agent is a boron-containing compound. In some embodiments, the boron-containing compound is borax pentahydrate, borax decahydrate, boric acid, polyborate, tetraboric acid, sodium metaborate, anhydrous, or boron components of polymers, or a combination thereof. In some embodiments, the antimicrobial agent is a silver based material, cupper based material such as cuprous oxide, or zinc based material such as zinc oxide copper, or a combination thereof such as a copper-silver-zinc alloy, copper-silver alloys, or silver-zinc alloy. In some embodiments, the zinc based material comprises Zinc pyrithione. In some embodiments, the zinc based material is Biomaster 627. In some embodiments, Biomaster 627 is an antimicrobial powder based on Zinc Pyrithione used to reduce the growth of bacteria, yeast and molds. In some embodiments, Biomaster 627 inhibits bacterial growth by slowly releasing zinc ions. In some embodiments, the zinc based material comprises Zinc 2-pyridinethiol-1-oxide. In some embodiments, the zinc based material is Zinc Omadine™. In some embodiments, Zinc Omadine™ Antimicrobial, Zinc 2-pyridinethiol-1-oxide, is a highly active, broad spectrum antimicrobial powder to prevent the growth of bacteria, fungi and algae. In some embodiments, the antimicrobial agent comprises N-butyl-1, 2-benzisothiazolin-3-one (BBIT). In some embodiments, the antimicrobial agent is Vanquish™ 100. In some embodiments, Vanquish™ 100 Antimicrobial is based on the active ingredient N-butyl-1, 2-benzisothiazolin-3-one (BBIT) effective for control of bacterial, fungal, and algal growth. In some embodiments, the antimicrobial agent is selected from quaternary ammonium surfactants, quaternary phosphonium compounds, alkylamines, isothiazolones, and organic thiocyanates.

In some embodiments, the additive is a surface chemistry modifier. A surface chemistry modifier may alter the chemistry of the outer surface of the coated turf infill, effectively tailor the surface chemistry and therefore the surface wettability. Surface wettability can be characterized by measuring the contact angle of water at the solid/liquid/gas interface. In some embodiments, the surface chemistry modifier is applied on the outer surface of the polymeric coating.

In some embodiments, the surface chemistry modifier is a surfactant. The surfactants may be anionic, cationic, amphoteric, nonionic, or mixtures thereof. In some embodiments, the surfactant is an anionic surfactant. In some embodiments, the anionic surfactant is sodium lauryl sulfate (SLS). In some embodiments, the surface chemistry modifier is Cocamidopropyl Hydroxysultaine (Chembetaine™, Lubrizol)

In some embodiments, the surface chemistry modifier is a silicone fluid, silicone glycols, polydimethylsiloxane fluids, silicone resins. In some embodiments, the surface chemistry modifier is polydimethyl siloxane having silanol groups in the terminal position (Wacker® F1006, Wacker Chemie AG), polyalkylene oxide-modified polydimethylsiloxane having organo-functional groups in the α,ω-position, or polysiloxane with polyether groups (Wacker® SG 3381, Wacker Chemie AG). In some embodiments, the surface chemistry modifier is polydimethyl siloxane having silanol groups in the terminal position having a formula of

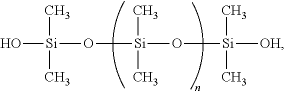

wherein n is 1-50000.

In some embodiments, the surface chemistry modifier increases water wettability by generating a high surface energy hydrophilic outer surface (water-wet surface) exhibiting low contact angles. In some embodiments, the contact angle is lower than 70°. In some embodiments, the contact angle is higher than 60°. In some embodiments, the contact angle is higher than 50°. In some embodiments, the contact angle is higher than 40°. In some embodiments, the contact angle is higher than 30°. In some embodiments, the contact angle is higher than 20°. In some embodiments, the contact angle is higher than 10°.

In some embodiments, the surface chemistry modifiers decrease water wettability generating hydrophobic lower surface energy coatings that exhibit large contact angles. In some embodiments, the contact angle is higher than 90°. In some embodiments, the contact angle is from about 90° to about 170°. In some embodiments, the contact angle is higher than 100°. In some embodiments, the contact angle is from about 100° to about 170°. In some embodiments, the contact angles are higher than 110°. In some embodiments, the contact angle is from about 110° to about 170°. In some embodiments, the contact angles are higher than 120°. In some embodiments, the contact angle is from about 120° to about 170°. In some embodiments, the contact angles are higher than 130°. In some embodiments, the contact angle is from about 130° to about 170°. In some embodiments, the contact angles are higher than 140°. In some embodiments, the contact angle is from about 140° to about 170°. In some embodiments, the contact angles are higher than 150°. In some embodiments, the contact angle is from about 150° to about 170°. In some embodiments, the contact angles are higher than 160°. In some embodiments, the contact angle is from about 160° to about 170°.

In some embodiments, the surface chemistry modifier is an omniphobic surface chemistry modifier. In some embodiments, the omniphobic surface chemistry modifier that generates an extremely low surface energy coating, reduces wettability of both water (hydrophobicity) and non-polar organic material (oleophobicity), and therefore may inhibit microbial growth. The surface chemistry modifier is selected from hydrophobic polyhedral oligomeric silsesquioxane (POSS), fluorodecyl POSS and fluorooctyl POSS, fluoropolymers, perfluoropolyether, perfluoroalkylphosphineoxides, perfluoroalkylamines, perfluoroalkylsulfides, perfluoroalkylethers, perfluoroalkylsulfoxides, perfluoropolyethers, perfluoroalkylphosphines and perfluorocycloethers organo silicons, silicons, silanes, siloxanes, siloxane, polydimethyl siloxane, polyalkyleneoxide copolymers, and any combination thereof. In some embodiments, the surface chemistry modifier is a silicone, a siloxane, or a fluoropolymer, or a combination thereof (e.g., SILRES® BS 26 A, Wacker Chemie AG). In some embodiments, the surface chemistry modifier is SILRES® BS 26 A, Wacker Chemie AG),

In some embodiments, the surface chemistry modifier decreases the roughness of the coated surface of a turf infill comprising the coated particulates as described herein. In some embodiments, the surface chemistry modifier tailors the rotational resistance of a turf infill comprising the coated particulates as described herein. In some embodiments, the surface chemistry modifier reduces friction between the coated particles of a turf infill comprising the coated particulates as described herein.

In some embodiments, the surface chemistry modifier is a dispersion of functionalized or non-functionalized fumed metal oxides. In some embodiments, the functionalized fumed metal oxide has a functionality selected from the group of amine, epoxy, isocyanate, polymeric, hydrophobic, and hydrophilic functionalities, and any combination thereof.

In some embodiments, the coated particles as described herein comprise fumed metal oxides in an amount from 0.01 wt. % to 1.9 wt. % of the coated particles. Fumed metal oxides dispersions include, for example, but are not limited to, fumed silica and fumed alumina. In some embodiments, the functionalized fumed metal oxide is fumed silica. In some embodiments, the coated particles as described herein comprise the fumed silica in an amount from 0.01 wt. % to 1.9 wt. %, 0.05 wt. % to 1.9 wt. %, 0.1 wt. % to 1.9 wt. %, 0.15 wt. % to 1.9 wt. %,0.2 wt. % to 1.9 wt. %, 0.25 wt. % to 1.9 wt. %, 0.3 wt. % to 1.9 wt. %, 0.35 wt. % to 1.9 wt. %, 0.4 wt. % to 1.9 wt. %, 0.45 wt. % to 1.9 wt. %, 0.5 wt. % to 1.9 wt. %, 0.55 wt. % to 1.9 wt. %, 0.6 wt. % to 1.9 wt. %, 0.65 wt. % to 1.9 wt. %, 0.7 wt. % to 1.9 wt. %, 0.75 wt. % to 1.9 wt. %, 0.80 wt. % to 1.9 wt. %, 0.85 wt. % to 1.9 wt. %, 0.9 wt. % to 1.9 wt. %, 0.95 wt. % to 1.9 wt. %,%, 1.0 wt. % to 1.9 wt. %, 1.05 wt. % to 1.9 wt. %, 1.1 wt. % to 1.9 wt. %, 1.15 wt. % to 1.9 wt. %, 1.2 wt. % to 1.9 wt. %, 1.25 wt. % to 1.9 wt. %, 1.3 wt. % to 1.9 wt. %, 1.35 wt. % to 1.9 wt. %, 1.4 wt. % to 1.9 wt. %, 1.45 wt. % to 1.9 wt. %, 1.5 wt. % to 1.9 wt. %, 1.55 wt. % to 1.9 wt. %, 1.6 wt. % to 1.9 wt. %, 1.65 wt. % to 1.9 wt. %, 1.7 wt. % to 1.9 wt. %, 1.75 wt. % to 1.9 wt. %, 1.8 wt. % to 1.9 wt. %, or 1.85 wt. % to 1.9 wt. %, of the coated particles. In some embodiments, the colloidal silica in the dispersion is in an amount from 5 wt. % to 40 wt. % of the dispersion. In some embodiments, the functionalized fumed metal oxide is fumed alumina. In some embodiments, the fumed silica or fumed alumina has an average particle size from 10 nm to 700 nm. In some embodiments, the fumed silica has an average particle size from 10 nm to 700 nm. In some embodiments, the fumed alumina has an average particle size from 10 nm to 700 nm. In some embodiments, the fumed silica or fumed alumina in the dispersion is in an amount from 5 wt. % to 40 wt. %, 10 wt. % to 40 wt. %, 15 wt. % to 40 wt. %, 20 wt. % to 40 wt. %, 25 wt. % to 40 wt. %, or 30 wt. % to 40 wt. %, or 5 wt. % to 40 wt. %, of the dispersion. In some embodiments, the fumed silica in the dispersion is in an amount from 5 wt. % to 40 wt. %, 10 wt. % to 40 wt. %, 15 wt. % to 40 wt. %, 20 wt. % to 40 wt. %, 25 wt. % to 40 wt. %, or 30 wt. % to 40 wt. %, or 5 wt. % to 40 wt. % of the dispersion. In some embodiments, the fumed silica or fumed alumina particles in the dispersion is in an amount from 5 wt. % to 40 wt. % of the dispersion. In some embodiments, the fumed metal oxide dispersion is CAB-O-SPERSE® available from Cabot Corp. In some embodiments, the fumed metal oxide dispersion is CAB-O-SIL® available from Cabot Corp

In some embodiments, the surface chemistry modifier is a colloidal silica dispersion. In some embodiments, a colloidal silica has a functionality selected from the group of amine, epoxy, isocyanate, polymeric, hydrophobic, and hydrophilic functionalities, and any combination thereof.

In some embodiments, the coated particles as described herein comprise the colloidal silica in an amount from 0.01 wt. % to 1.9 wt. %, 0.05 wt. % to 1.9 wt. %, 0.1 wt. % to 1.9 wt. %, 0.15 wt. % to 1.9 wt. %,0.2 wt. % to 1.9 wt. %, 0.25 wt. % to 1.9 wt. %, 0.3 wt. % to 1.9 wt. %, 0.35 wt. % to 1.9 wt. %, 0.4 wt. % to 1.9 wt. %, 0.45 wt. % to 1.9 wt. %, 0.5 wt. % to 1.9 wt. %, 0.55 wt. % to 1.9 wt. %, 0.6 wt. % to 1.9 wt. %, 0.65 wt. % to 1.9 wt. %, 0.7 wt. % to 1.9 wt. %, 0.75 wt. % to 1.9 wt. %, 0.80 wt. % to 1.9 wt. %, 0.85 wt. % to 1.9 wt. %, 0.9 wt. % to 1.9 wt. %, 0.95 wt. % to 1.9 wt. %,%, 1.0 wt. % to 1.9 wt. %, 1.05 wt. % to 1.9 wt. %, 1.1 wt. % to 1.9 wt. %, 1.15 wt. % to 1.9 wt. %, 1.2 wt. % to 1.9 wt. %, 1.25 wt. % to 1.9 wt. %, 1.3 wt. % to 1.9 wt. %, 1.35 wt. % to 1.9 wt. %, 1.4 wt. % to 1.9 wt. %, 1.45 wt. % to 1.9 wt. %, 1.5 wt. % to 1.9 wt. %, 1.55 wt. % to 1.9 wt. %, 1.6 wt. % to 1.9 wt. %, 1.65 wt. % to 1.9 wt. %, 1.7 wt. % to 1.9 wt. %, 1.75 wt. % to 1.9 wt. %, 1.8 wt. % to 1.9 wt. %, or 1.85 wt. % to 1.9 wt. %, of the coated particles. In some embodiments, the colloidal silica in the dispersion is in an amount from 5 wt. % to 40 wt. %, 10 wt. % to 40 wt. %, 15 wt. % to 40 wt. %, 20 wt. % to 40 wt. %, 25 wt. % to 40 wt. %, or 30 wt. % to 40 wt. %, or 5 wt. % to 40 wt. %, of the dispersion.

Functionalized inorganic particulates are prepared by reacting the inorganic particle with one or more organic agents that bond to the surface of the underlying particle and provide one or more reactive sites over the surface of the particle that can be used to bond or enhance the bond between a polymeric phase and the functionalized particulates dispersed therein. Silica is one such particle that has been functionalized in a variety of ways. See U.S. Pat. No. 5,168,082 (functionalizing group attached to the silica sol is a branched or straight chain silane including at one end a hydrophilic moiety and at another end a silicon anchor group); U.S. Pat. No. 5,330,836 (polyfunctional silica particulates); U.S. Pat. Nos. 6,486,287 and 7,129,308 (functionalized silicon for silica surfaces); U.S. Pat. No. 6,809,149 (silica with 3-methacryloxypropylsilyl and/or glycidyloxypropylsilyl groups on the surface); and published US Patent Application Publication Nos. 2004/0138343 (colloidal silica functionalized with at least one organoalkoxysilane functionalization agent and subsequently functionalized with at least one capping agent); 2007/0238088 (functionalized silica compositions by reacting acidic silica particulates with hydrophilic organosilanes); 2008/0063868 (silica nano-sized particulates having polyethylene glycol linkages); and 2013/0005856 (amine-functionalized silica particulates coupled to at least one group chosen from primary amines, secondary amines, tertiary amines, and quaternary ammonium groups). The contents of these, and all other patents and published applications mentioned herein are hereby incorporated by reference.

In some embodiments, the additive is an impact modifier filler. In some embodiments, the impact modifier filler reduces impact forces of a turf infill comprising the coated particulates as described herein. In some embodiments, the impact modifier filler modifies vertical deformation of a turf infill comprising the coated particulates as described herein. In some embodiments, the impact modifier filler reduces vertical deformation of a turf infill comprising the coated particulates as described herein.

In some embodiments, the additive is silicone fluid.

In some embodiments, the additive is DI water.

In some embodiments, the additive is functionalized, non-functionalized fumed silica, or a combination thereof.

In some embodiments, the additive is a pigment, tints, dye, and filler in an amount to provide visible coloration in the coatings. Other materials conventionally included in coating compositions may also be added to the coatings. These additional materials include, but are not limited to, reaction enhancers or catalysts, crosslinking agents, optical brighteners, propylene carbonates, coloring agents, fluorescent agents, whitening agents, UV absorbers, hindered amine light stabilizers, defoaming agents, processing aids, mica, talc, nano-fillers and other conventional additives. All of these materials are well known in the art and are added for their usual purpose in typical amounts. For example, the additives can be present in an amount of about 15 weight percent or less. In some embodiments, the additive is present in an amount of about 5 percent or less by weight of the coating composition.

Other additives can include, for example, solvents, softeners, surface-active agents, molecular sieves for removing the reaction water, thinners and/or adhesion agents can be used.

Silanes can be used by themselves as the first component of the coating or blended in the isocyanate reactive blend as additives, but can also be converted chemically with reactive constituents of the isocyanate reactive blend or of the isocyanate component. The silane can also form an inner layer. Examples of silanes that can be used include, but are not limited to, functional silanes such as amino-silanes, epoxy-, aryl- or vinyl silanes are commercially available and, as described above, can be used as additives or can be converted with the reactive constituents of the isocyanate reactive blend or of the isocyanate component. In particular, amino-silanes and epoxy-silanes can react with the isocyanate (NCO) groups and graft or couple the polymeric coating onto the inorganic core.

### Core Solids of the Coated Particulates

The coated particulates as provided and described herein can be virtually any small solid with an adequate crush strength and lack of chemical reactivity. Suitable examples include sand, synthetic organic particles, plastic particles, nylon beads, plastic beads, nylon pellets, natural materials, coconut shells, walnut shells, pecan shells, silicon carbide particles, ceramic particles (for instance, aluminum oxide, silicon dioxide, titanium dioxide, zinc oxide, zirconium dioxide, cerium dioxide, manganese dioxide, iron oxide, calcium oxide or bauxite), alumina, or also other granular materials. The coated particulates can have, for example, an average particle size from about 50 μm to about 8000 μm, and for example from about 75 μm to about 4000 μm.

### Compositions of One or More Types of Coated Particulates

The present disclosure provides compositions comprising two or more types of coated particulates as described and provided herein and provided herein. In some embodiments, the coated particulates are in different from each other. In some embodiments, the composition comprises two to twenty, two to ten, two to fifteen, or two to five types of coated particulates as described and provided herein. In some embodiments, the composition comprises two types of coated particulates as described and provided herein. In some embodiments, the composition comprises three types of coated particulates as described and provided herein. In some embodiments, the composition comprises four of coated particulates as described and provided herein. In some embodiments, the composition comprises five types of coated particulates as described and provided herein. In some embodiments, the composition comprises six types of coated particulates as described and provided herein. In some embodiments, the composition comprises seven types of coated particulates as described and provided herein. In some embodiments, the composition comprises eight types of coated particulates as described and provided herein. In some embodiments, the composition comprises nine types of coated particulates as described and provided herein. In some embodiments, the composition comprises ten types of coated particulates as described and provided herein.

In some embodiments, the composition as described and provided herein comprises two or more types of coated particulates, each of which comprises different additives.

In some embodiments, the composition as described and provided herein comprises two or more types of coated particulates, each of which has different surface chemistry functionalities.

In some embodiments, the composition as described and provided herein comprises two types of coated particulates, each of which has a different surface chemistry functionality. In some embodiments, the weight ratio of the two types of coated particulates are from 1:99 to 99:1, 5:95 to 95:5, 10:90 to 90:10, 15:85 to 85:15, 20:80 to 80:20, 30:70 to 70:30, or 40:60 to 60:40. In some embodiments, the weight ratio of the two types of coated particulates is 10:90. In some embodiments, the weight ratio of the two types of coated particulates is 15:85. In some embodiments, the weight ratio of the two types of coated particulates is 20:80. In some embodiments, the weight ratio of the two types of coated particulates is 25:75. In some embodiments, the weight ratio of the two types of coated particulates is 30:70. In some embodiments, the weight ratio of the two types of coated particulates is 35:75. In some embodiments, the weight ratio of the two types of coated particulates is 40:60. In some embodiments, the weight ratio of the two types of coated particulates is 45:55. In some embodiments, the weight ratio of the two types of coated particulates is 50:50. In some embodiments, one type of coated particulate is hydrophilic and the other type of coated particulate hydrophobic.

In some embodiments, the composition comprises two types of coated particulates as described and provided herein, wherein two types of coated particulates are in a weight ratio of

### Coating Methods

In some embodiments, methods of preparing a multi-layer coated particulate are provided. In some embodiments, the method comprises coating the particulate with a first layer. In some embodiments, the first layer is a polyurethane layer. In some embodiments, the outer layer is a polyurethane layer. In some embodiments, more than one layer of the coating are polyurethane layers. In some embodiments, the polyurethane layer is formed from the reaction of an isocyanate component and an isocyanate reactive blend. In some embodiments, the isocyanate component is as described herein. In some embodiments, the isocyanate reactive blend is as described herein.

In some embodiments, the layers are coated onto the particulate by mixing the components and the particulate in a mixer. For example, in some embodiments, the first layer is produced by mixing the particulate with an isocyanate reactive blend and an isocyanate component under conditions sufficient to form the polyurethane coating coated onto the particulate. Catalysts could be pre-blended with the isocyanate reactive blend prior to the coatings.

In some embodiments, the particulates are preheated sufficient enough to evaporate any water present in the coating components or dispersions. In some embodiments, the methods comprise drying the multi-layer coated particulate. In some embodiments, the methods comprise crosslinking the second layer to produce a cross-linked second layer. In some embodiments, the crosslinking comprises drying the second layer coated particulate to crosslink the polyurethane dispersion. In some embodiments, the crosslinking comprises contacting the second layer with a crosslinker, such as the chemicals described herein. In some embodiments, the cross-linking occurs by itself without the addition of an additional cross-linking chemical or component. This can be referred to as self-crosslinking.

In some embodiments, the methods for the production of coated particulates can be implemented without the use of solvents. Accordingly, the mixture one or more, or all of the steps are solvent-free (including but not limited to organic solvents) or is essentially solvent-free. The mixture is essentially solvent-free, if it contains less than 20 wt. %, less than 10 wt. %, less than 5 wt. %, less than 3 wt. %, or less than 1 wt. % of solvent, relative to the total mass of components of the mixture. In some embodiments, other than the water present in the polyurethane dispersion, no additional water is added to the mixer to coat the particulates.

In some embodiments, the method is implemented without the use of organic solvents. In some embodiments, one of the steps is performed without the use of organic solvents. In some embodiments, the inner polyurethane layer is formed free of organic solvents, or is essentially free of organic solvents. The mixture is essentially free of organic solvents, if it contains less than 20 wt. %, less than 10 wt. %, less than 5 wt. %, and less than 3 wt. %, or less than 1 wt. % of solvent, relative to the total mass of components of the mixture.

In some embodiments, the particulate is heated to an elevated temperature and then contacted (e.g., mixed) with the coating components. In some embodiments, the particulate is heated to a temperature from about 50° C. to about 150° C. In some embodiments, the particulate is heated to a temperature from about 50° C. to about 210° C. The increased temperature can, for example, accelerate crosslinking reactions in the applied coating.

The mixer used for the coating process is not particularly restricted and can be selected from among the mixers known in the specific field. For example, a pug mill mixer or an agitation mixer can be used. For example, a drum mixer, a plate-type mixer, a tubular mixer, a trough mixer or a conical mixer can be used. In some embodiments, the components and formulations are mixed in a rotating drum. In some embodiments, a continuous mixer, a worm gear can, for example, be used.

Mixing can be carried out on a continuous or batch mixer. The mixing is performed in mixers that apply forces by rotating paddles, rotating single screw, co-rotating or counter rotating screws, rotating wheels and plows, drums, pug mill, helical rotors. Exemplary mixers are Barber Greene, Simpson Technologies, Webac, and Eirich. It is also possible to arrange several mixers in series, or to coat the proppants in several runs in one mixer.

The temperature of the coating process is not particularly restricted outside of practical concerns for safety and component integrity. In some embodiments, the coating steps are performed at a temperature of from about 10° C. to about 210° C., or about 10° C. to about 200° C., or about 50° C. to about 210° C. In some embodiments, the coating steps are performed at a temperature of from about 10° C. to about 150° C., or about 10° C. to about 125° C., or about 50° C. to about 150° C.

The coating material may be applied in more than one layer. In some embodiments, each of the layers described herein are repeated as necessary (e.g. 1-5 times, 2-4 times or 2-3 times) to obtain the desired coating thickness. Thus, the thickness of the coating of the proppant can be adjusted and used as either a relatively narrow range of proppant size or blended with proppants of other sizes, such as those with more or less numbers of coating layers of polyurethane or polyurethane dispersions as described herein. This can also be used to form a particulate blend have more than one range of size distribution.

In some embodiments, the amount of the polyurethane coating that is applied or coated onto the particulate is about 0.1 wt. % to about 10 wt. %, about 0.2 wt. % to about 10 wt. %, about 0.3 wt. % to about 10 wt. %, about 0.4 wt. % to about 10 wt. %, about 0.5 wt. % to about 10 wt. %, about 0.65 wt. % to about 1.5 wt. %, about 0.75 wt. % to about 1.3 wt. %, 0.8 wt. % to about 1.25 wt. %, about 0.8 wt. %, about 0.9 wt. %, about 1.0 wt. %, about 1.1 wt. %, about 1.2 wt. %, about 1.25 wt. %, relative to the mass of the particulate as 100 wt. %.

In some embodiments, the amount of the polyurethane dispersion coating that is applied or coated onto the particulate is about 0.1 wt. % to about 10.0 wt. %, 0.1 wt. % to about 9.5 wt. %, 0.1 wt. % to about 9.0 wt. %, 0.1 wt. % to about 8.5 wt. %, 0.1 wt. % to about 8.0 wt. %, 0.1 wt. % to about 7.5 wt. %, 0.1 wt. % to about 7.0 wt. %, 0.1 wt. % to about 6.5 wt. %, 0.1 wt. % to about 6.0 wt. %, 0.1 wt. % to about 5.5 wt. %, 0.1 wt. % to about 5.0 wt. %, 0.1 wt. % to about 4.5 wt. %, 0.1 wt. % to about 4.0 wt. %, 0.1 wt. % to about 3.5 wt. %, 0.1 wt. % to about 3.0 wt. %, 0.1 wt. % to about 2.5 wt. %, 0.1 wt. % to about 2.0 wt. %, 0.1 wt. % to about 1.5 wt. %, 0.1 wt. % to about 1.0 wt. %, 0.1 wt. % to about 0.9 wt. %, 0.1 wt. % to about 0.8 wt. %, 0.1 wt. % to about 0.7 wt. %, 0.1 wt. % to about 0.6 wt. %, 0.1 wt. % to about 0.5 wt. %, 0.1 wt. % to about 0.4 wt. %, 0.1 wt. % to about 0.3 wt. %, or 0.1 wt. % to about 0.2 wt. %, relative to the mass of the particulate as 100 wt. %.

The coated particulates can additionally be treated with surface-active agents or auxiliaries, such as talcum powder or stearate, to improve pourability.

In some embodiments, the coated particulates can be baked or heated for a period of time sufficient to substantially react at least substantially all of the available isocyanate, hydroxyl that might remain in the coated particulate. Such a post-coating cure may occur even if additional contact time with a catalyst is used after a first coating layer or between layers. In some embodiments, the post-coating cure step is performed like a baking step at a temperature from about 100°−200° C. for a time of about 1-48 hours, or the temperature is from about 125° to about 175° C. for 19-36 hours.

In some embodiments, the present disclosure provides methods of producing the coated particulates as described herein comprising:
a) heating particulates in an oven;
b) transferring the heated particulates to a batch or continuous mixer;
c) adding the coupling agent into the mixer;
d) adding the isocyanate reactive blend into the mixer;
e) adding the isocyanate component into the mixer; and
f) optionally adding the additive into the mixer to produce the polyurethane coated particulates.

In some embodiments, methods of producing the coated particulates as described herein further comprise repeating steps d) to f) to add one or more additional polyurethane coatings.

In some embodiments, provided are methods of producing the coated particulates as described herein, wherein the particulates in step a) are heated in a heater to a temperature from about 100° C. to about 210° C. In some embodiments, the particulates in step a) are heated in a heater to a temperature from about 100° C. to about 210° C. In some embodiments, the particulates in step a) are heated in a heater to a temperature from about 120° C. to about 180° C. In some embodiments, the particulates in step a) are heated in a heater to a temperature from about 140° C. to about 160° C. In some embodiments, the particulates in step a) are heated in a heater to a temperature from about 145° C. to about 155° C. In some embodiments, provided are methods of producing the coated particulates as described herein, wherein the particulates in step a) are heated in a heater to a temperature from about 60° C. to about 210° C. In some embodiments, the particulates in step a) are heated in a heater to a temperature from about 60° C. to about 210° C. In some embodiments, the particulates in step a) are heated in a heater to a temperature from about 60° C. to about 180° C. In some embodiments, the particulates in step a) are heated in a heater to a temperature from about 60° C. to about 160° C. In some embodiments, the particulates in step a) are heated in a heater to a temperature from about 60° C. to about 155° C. In some embodiments, the particulates in step a) are heated in a heater to a temperature of about 80° C., about 88° C., about 93, about 104, about 107, about 110° C. or from about 150° C.

In some embodiments, provided are methods of producing the coated particulates as described herein, wherein the mixer in step b) is a Webac batch mixer or a continuous mixer.

In some embodiments, provided are methods of producing the coated particulates as described herein, wherein the coupling agent in step c) are added when the temperature of the particulates is from about 80° C. to about 210° C. In some embodiments, the coupling agent in step c) are added when the temperature of the particulates is from about 90° C. to about 140° C. In some embodiments, the coupling agent in step c) are added when the temperature of the particulates is from about 90° C. to about 130° C. In some embodiments, the coupling agent in step c) are added when the temperature of the particulates is from about 90° C. to about 120° C. In some embodiments, the coupling agent in step c) are added when the temperature of the particulates is from about 90° C. to about 115° C. In some embodiments, the coupling agent in step c) are added when the temperature of the particulates is about 93° C. In some embodiments, the coupling agent in step c) are added when the temperature of the particulates is about 110° C.

In some embodiments, provided are methods of producing the coated particulates as described herein, wherein the isocyanate reactive blend in step d) is added after 0 second to about 1 minute. In some embodiments, the isocyanate reactive blend is added after about 5, about 10, about 15, about 20, about 25, about 30, about 35, about 40, about 45, about 50, about 55, or about 60 seconds from the start of the addition of the coupling agent. In some embodiments, the isocyanate reactive blend is added over a period of 0 to about 20 seconds. In some embodiments, the isocyanate reactive blend is added over a period of about 5, about 10, about 15 or about 20 seconds. In some embodiments, the isocyanate reactive blend is added over a period of about 10 seconds.

In some embodiments, the isocyanate component in step e) is added after 0 second to about 60 seconds from the start of the addition of the coupling agent. In some embodiments, the isocyanate reactive blend is added after about 5, about 10, about 15, about 20, about 25, about 30, about 35, about 40, about 45, about 50, about 55, or about 60 seconds from the start of the addition of the coupling agent. In some embodiments, the isocyanate component is added over a period of 0 to about 10 seconds. In some embodiments, the isocyanate component is added over a period of about 5, about 10, about 15 or about 20 seconds. In some embodiments, the isocyanate component is added over a period of about 10 seconds.

In some embodiments, provided are methods of producing the coated particulates as described herein, wherein the additive in step f) is added after about 30 seconds to about 35 seconds from the start of the addition of the coupling agent.

In some embodiments, provided are methods of producing the coated particulates as described herein, wherein the isocyanate component is added over a period of about 5 seconds. In some embodiments, the coated particulates in step f) are discharged after mixing in the mixer for about 30 seconds to 5 minutes. In some embodiments, the coated particulates in step f) are discharged after mixing in the mixer for about 50 seconds to 3 minutes. In some embodiments, the coated particulates in step f) are discharged after mixing in the mixer for about 50 seconds. In some embodiments, the coated particulates in step f) are discharged after mixing in the mixer for about 1 minute. In some embodiments, the coated particulates in step f) are discharged after mixing in the mixer for about 2 minutes. In some embodiments, the coated particulates in step f) are discharged into a pan and allowed to cool. In some embodiments, the coated particulates are dry and free-flowing coated particulates.

In some embodiments, the present disclosure provides methods of producing coated particulates as described and provided herein comprising:
feeding heated particulates into an inlet of a first mixer, the first mixer comprising an outer wall and at least one auger comprising a rotating shaft and a plurality of paddles connected thereto, wherein the at least one auger of the first mixer is rotating at a rate to form an annulus of particulates positioned along the interior surface of the outer wall of the first mixer and moving the particulates towards an outlet of the first mixer;
mixing the annulus of particulates with coating compositions that are fed into the mixer through dosing ports operably connected to the second mixer; and
discharging the coated particulates through the outlet to the second mixer.

In some embodiments, provided are methods of producing coated particulates as described herein, wherein the at least one auger rotates at a rate of about 60 rotations per minute (RPM) to about 1200 RPM.

In some embodiments, provided are methods of producing coated particulates as described herein, wherein the particulates move from the inlet to the outlet in an average time from about 2 seconds to about 15 seconds.

In some embodiments, provided are methods of producing coated particulates as described herein, wherein the particulates are discharged from the outlet at an average rate of about 100 pounds per minute to about 6000 pounds of particulates per minute. In some embodiments, the particulates are discharged from the outlet at an average rate of about 3 tons per hour to about 180 tons per hour.

In some embodiments, provided are methods of producing coated particulates as described herein, wherein the first mixer further comprises at least a second dosing port operably connected to the mixer.

In some embodiments, provided are methods of producing coated particulates as described herein, wherein the method further comprises mixing the annulus of particulates with a second coating composition that is fed into the mixer through the second dosing port.

In some embodiments, provided are methods of producing coated particulates as described herein, further comprising injecting at least a first gas with the coating composition into one or more dosing ports of the first mixer, wherein the gas fills a space in the center of the particulate annulus in the first mixer.

In some embodiments, provided are methods of producing coated particulates as described herein, wherein each paddle of the first mixer has an orientation from about −45 degrees to about +45 degrees in relation to the horizontal axis of the rotating shaft to which said paddle is connected. In some embodiments, wherein each paddle has an orientation of −45 degrees, 0 degrees, or +45 degrees or wherein the plurality of the paddles are oriented at −45 degrees.

In some embodiments, provided are methods of producing coated particulates as described herein, wherein the paddles of the first mixer are grouped into an inlet zone, a middle zone, and an outlet zone.

In some embodiments, provided are methods of producing coated particulates as described herein, wherein the paddles in the inlet zone are oriented randomly at either −45 degrees, 0 degrees, or +45 degrees.

In some embodiments, provided are methods of producing coated particulates as described herein, wherein all of the paddles in the inlet zone are oriented at 0 degrees or at +45 degrees.

In some embodiments, provided are methods of producing coated particulates as described herein, further comprising at least a second mixer arranged in series with the first mixer, such that particulates are fed into the inlet of the first mixer at or approximately at the same time as particulates are fed into an inlet of the second mixer.

In some embodiments, provided are methods of producing coated particulates as described herein, further comprising the steps of:
heating the particulates to a first temperature in a container;
feeding the particulates from the container into the inlet of the first mixer and the inlet of the second mixer, such that particulates are fed into the inlet of the first mixer at or approximately at the same time as particulates are fed into the inlet of the second mixer.

In some embodiments, provided are methods of producing coated particulates as described herein, comprising:
optionally heating particulates to a first temperature;
feeding the optionally heated particulates into an inlet of the first mixer, wherein the first mixer comprises an outer wall and an auger comprising a rotating shaft and multiple paddles connected thereto, wherein the auger is rotating at a rate of about 60 rotations per minute to about 1200 rotations per minute,
wherein the auger moves a plurality of the particulates into an annulus positioned along the outer wall;
wherein the auger is capable of moving the particulates towards an outlet of the first mixer in an average time from about 2 seconds to about 20 seconds;
optionally heating a coating composition to a second temperature, wherein the second temperature is higher than the melting point of the coating composition;
feeding the coating composition into at least a first dosing port of the first mixer with or without a gas, wherein the coating composition mixes with the particulates in the rotating mixer, and wherein the coating composition coats the particulates as they move towards the outlet; and
collecting the coated particulates as the coated particulates are discharged from the outlet;

In some embodiments, provided are methods of producing coated particulates as described herein, wherein the method produces coated particulates at an average rate of about 3 tons per hour to about 180 tons per hour.

The method is not particularly restricted and can be implemented in the manner known in the specific field.

In some embodiments, a process of coating a particle with an epoxy-emulsion outer layer comprises heating a particle to about 380° F. to about 420° F. The particle can be heated prior to mixing. In some embodiments, the heated particle is mixed with a hydroxy-terminated amino-functional silane such as aqueous 3-aminopropylsilane hydrolysate. In some embodiments, the sand is then mixed with a phenol-aldehyde resin. In some embodiments, the sand is then coated with an epoxy emulsion such as, but not limited to, Dow Chemical DER 916™ and an amine epoxy hardener such as, but not limited to, DEH 24 and or DEH 58. The coated sand can be coated with the surface chemistry modifier as the last step before discharging. The times for adding the materials can be the same as described herein and above or as shown in the examples.

### Using the Coated Particulates for Preparing Artificial Turfs

Furthermore, the embodiments provided herein include the use of the coated particulates in conjunction with other suitable materials for the production of artificial turfs used in arenas for sports, landscaped public and private areas for various reasons including aesthetic appearance, low maintenance, evenness of the surfaces, etc.

In some embodiments, the artificial turfs as provided and described herein comprising a support, a base, a backing, and a filler, which can also be referred to as infill material, comprising at least one coated particulate as provided and described herein.

In some embodiments, the support is formed from the materials selected from sand, compacted soil, fiber reinforced soil, gravel, asphalt, concrete, and the like, or a combination thereof. In some embodiments, the base comprises one or more structures such as grids, which consists of more than one interconnected cell arranged over and supported by the support as described herein. In some embodiments, the cell forming the grid comprises at least one upstanding tubular member having an upper portion, which functions to support the backing, and a lower portion, which functions to engage with the support.

In some embodiments, the backing resides over the base. In some embodiments, the backing comprises piles secured into a backing fabric and extending upwardly therefrom. In some embodiments, the piles may also be secured with a foam backing which may be supported directly on the upper surface of the mat. In some embodiments, the filler comprising at least one coated particulate as provided and described herein is spread evenly over the pile fabric to cover the surface of the backing fabric and to surround and cover desired portions of the pile tufts. In some embodiments, the filler as provided and described herein may be combined with ground rubber or sand. In some embodiments, the filler consists of one or more coated particulate as provided and described herein.

In some embodiments, an artificial turf is provided, comprising a backing having pile fibers extending upwardly therefrom; and a filler (infill material) of coated particulates as provided for herein. In some embodiments, the pile fibers extend substantially above the infill material.

In some embodiments, methods of forming an artificial turf are provided. In some embodiments, the method comprises placing an aggregate infill material onto a backing, the backing having pile fibers secured thereto and extending upwardly above the infill material. In some embodiments, the aggregate infill material comprises coated particulates as provided for herein.

The present disclosure also provides the following non-limiting embodiments:

In order that the embodiments disclosed herein may be more efficiently understood, examples are provided below. It should be understood that these examples are for illustrative purposes only and are not to be construed as limiting the embodiments in any manner.

In some embodiments, the following embodiments are provided:
1. A coated particulate for a turf infill comprising a core, wherein the core is substantially covered with one or more layers of polymer coatings, wherein the polymer coating is selected from a polyurethane coating, an epoxy coating, a phenolic coating, a polyurethane-phenol coating, and any combination thereof.
2. The coated particulate of embodiment 1, wherein the polymer coating is a polyurethane coating.
3. The coated particulate of embodiment 1 or 2, wherein the polymer coating is coupled to the core through a coupling agent.
4. The coated particulate of embodiment 3, wherein the coupling agent is a silane coupling agent.
5. The coated particulate of embodiment 4, wherein the silane coupling agent is an organofunctional silane coupling agent.
6. The coated particulate of embodiment 5, wherein the organofunctional silane coupling agent is selected from the group of 3-glycidyloxypropyltrimethoxysilane, 3-glycidyloxypropyltriethoxysilane, 2-(3,4-epoxycyclohexy)ethyltrimethoxysilane, and 2-(3,4-epoxycyclohexyl)ethyltriethoxysilane, 3-[2-(2-aminoethylamino)ethylamino]propyl-trimethoxysilane (CAS No. 35141-30-1), 3-mercaptopropyl-trimethoxysilane (CAS No. 4420-74-0), n-propyltrimethoxysilane (CAS No. 1067-25-0), [3-(2-aminoethyl)aminopropyl]trimethoxysilane (CAS No. 1760-24-3), silane n-dodecyltrimethoxysilane (CAS No. 3069-21-4), bis(trimethoxysilylpropyl) amine (CAS No. 82985-35-1), 1,2-bis(trimethoxysilyl)ethane (CAS No. 18406-41-2), vinyltri(2-methoxyethoxy) silane (CAS No. 1067-53-4), n-octyltriethoxysilane (CAS No. 2943-75-1), bis[3-(triethoxysilyl) propyl]tetrasulfide (CAS No. 40372-72-3), vinyltriethoxysilane (CAS No. 78-08-0): 3-glycidoxypropyl-trimethoxysilane (CAS No. 2530-83-8), 3-(Triethoxysilyl)propyl isocyanate, 3-mercaptopropyl-triethoxysilane (CAS No. 14814-09-6), 3-glycidoxypropyl-triethoxysilane (CAS No. 2602-34-8), 2-(3,4-epoxycyclohexyl)ethyl]trimethoxysilane (CAS No. 3388-04-3), 3-aminopropyltrimethoxysilane (CAS No. 13822-56-5), 2-(3,4-epoxycyclohexyl)ethyl]triethoxysilane (CAS No. 10217-34-2), 3-aminopropyltriethoxysilane (CAS No. 919-30-2), 3-glycidoxypropyl-methyldimethoxysilane (CAS No. 65799-47-5), bis(triethoxysilylpropyl)amine (CAS No. 13497-18-2), 3-(2-aminoethylamino)propyldimethoxymethylsilane (CAS No. 3069-29-2), N-(n-Butyl)-3-aminopropyltri-methoxysilane (CAS NO. 31024-56-3), n-propyltriethoxysilane (CAS No. 2550-02-9), vinyltrimethoxysilane (CAS No. 2768-02-7), 3-ureidopropyltriethoxy-silane (CAS No. 23779-32-0), 3-methacryloxypropyl-trimethoxysilane (CAS No. 2530-85-0), aqueous 3-aminopropylsilane hydrolysate, and a combination thereof.
7. The coated particulate of embodiment 5, wherein the organofunctional silane coupling agent comprises 3-aminopropyltriethoxysilane.
8. The coated particulate of embodiment 7, wherein the organofunctional silane coupling agent is GENIOSIL® GF 93
9. The coated particulate of embodiment 5, wherein the organofunctional silane coupling agent comprises 3-aminopropylsilane hydrolysate silane.
10. The coated particulate of embodiment 9, wherein the organofunctional silane coupling agent is Dynasylan® HYDROSIL.
11. The coated particulate of any one of embodiments 4-10, wherein the silane coupling agent is from about 0.005% to about 4.000% of the particulate by weight.
12. The coated particulate of any one of embodiments 4-10, wherein the silane coupling agent is from about 0.06% to about 0.15% of the particulate by weight.
13. The coated particulate of any one of embodiments 2-12, wherein the polyurethane coating is homogenous.
14. The coated particulate of embodiment 13, wherein the polyurethane is formed from a reaction of an isocyanate component and an isocyanate reactive blend.
15. The coated particulate of embodiment 14, wherein the isocyanate component comprises a cycloaliphatic isocyanate, an aliphatic isocyanate, or an aromatic isocyanate, or a combination thereof.
16. The coated particulate of embodiment 14, wherein the isocyanate component comprises toluol-2,4-diisocyanate; toluol-2,6-diisocyanate (TDI); 1,5 naphthalindiisocyanate; cumol-2,4-diisocyanate; 4-methoxy-1,3-phenyldiisocyanate; 4-chloro-1,3-phenyldiisocyanate; diphenylmethane-4,4-diisocyanate; diphenylmethane-2,4-diisocyanate; diphenylmethane-2,2-diisocyanate; 4-bromo-1,3-phenyldiisocyanate; 4-ethoxy-1,3-phenyl-diisocyanate; 2,4′-diisocyanate diphenylether; 5,6-dimethyl-1,3-phenyl-diisocyanate; methylenediphenyl diisocyanate (including 2,2′-MDI, 2,4′-MDI and 4,4″-MDI); 4,4 diisocyanato-diphenylether; 4,6-dimethyl-1,3-phenyldiisocyanate; 9,10-anthracene-diisocyanate; 2,4,6-toluol triisocyanate; 2,4,4′-triisocyanatodiphenylether; 1,4-tetramethylene diisocyanate; 1,6-hexamethylene diisocyanate (HDI); 1,10-decamethylene-diisocyanate; 1,3-cyclohexylene diisocyanate; 4,4′ methylene-bis-(cyclohexylisocyanate); xylol diisocyanate; 1-isocyanato-3-methyl-isocyanate-3,5,5-trimethylcyclohexane (isophorone diisocyanate); 1-3-bis(isocyanato-1-methylethyl) benzol (m-TMXDI); 1,4 bis(isocyanato-1-methylethyl) benzol (p-TMXDI), isocyanurate-modified hexamethylene diisocyanate, 1,3,5-tris(6-isocyanatohexyl)biuret (hexamethylene diisocyanate biuret), hexamethylene diisocyanate trimer, or an oligomer or polymer thereof, or a combination thereof.
17. The coated particulate of embodiment 15, wherein the aliphatic isocyanate is an isocyanate terminated polypropylene glycol prepolymer based on hydrogenated 4,4′ methylenebis diisocyanate (HMDI).
18. The coated particulate of embodiment 17, wherein the aliphatic isocyanate is BASF Lupranate 5570.
19. The coated particulate of embodiment 15, wherein the aliphatic isocyanate comprises an isocyanurate-modified hexamethylene diisocyanate or an oligomer or polymer thereof.
20. The coated particulate of embodiment 19, wherein the aliphatic isocyanate is BASF Basonat® HI 2000 NG.
21. The coated particulate of embodiment 15, wherein the aliphatic isocyanate comprises 1,3,5-tris(6-isocyanatohexyl)biuret or an oligomer or polymer thereof.
22. The coated particulate of embodiment 21, wherein the aliphatic isocyanate is Tolonate™ HDB-LV.
23. The coated particulate of embodiment 15, wherein the aliphatic isocyanate comprises hexamethylene diisocyanate trimer or an oligomer or polymer thereof.
24. The coated particulate of embodiment 23, wherein the aliphatic isocyanate is Tolonate™ HDT-LV.
25. The coated particulate of embodiment 14, wherein the isocyanate component comprises a polymeric MDI isocyanate
26. The coated particulate of embodiment 25, wherein the polymeric MDI isocyanate is Dow HF-459.
27. The coated particulate of embodiment 25, wherein the polymeric MDI isocyanate is Dow PAPI™ 27.
28. The coated particulate of embodiment 25, wherein the polymeric MDI isocyanate is a low viscosity polymeric MDI isocyanate.
29. The coated particulate of embodiment 28, wherein the low viscosity polymeric MDI isocyanate is BASF Lupranate M20.
30. The coated particulate of any one of embodiments 14-29, wherein the isocyanate reactive blend comprises a polyether polyol.
31. The coated particulate of embodiment 30, wherein the polyether polyol is an aliphatic polyol.
32. The coated particulate of embodiment 31, wherein the aliphatic polyol is plant based.
33. The coated particulate of embodiment 32, wherein the plant-based aliphatic polyol is green.
34. The coated particulate of embodiment 33, wherein the green plant-based aliphatic polyol is Albodur 1055.
35. The coated particulate of embodiment 30, wherein the polyether polyol is Dow TERAFORCE 62575.
36. The coated particulate of any one of embodiments 14-29, wherein the isocyanate reactive blend comprises a low molecular weight polyol.
37. The coated particulate of embodiment 36, wherein the low molecular weight polyol is 1,4-butanediol or glycerin.
38. The coated particulate of any one of embodiments 14-29, wherein the isocyanate reactive blend comprises a polyol derived from cashew nutshell liquid.
39. The coated particulate of embodiment 38, wherein the polyol derived from cashew nut shell liquid is a polyether-polyester polyol or a branched polyether-polyester polyol.
40. The coated particulate of embodiment 38, wherein the polyol derived from cashew nut shell liquid is a Cardolite® NX-9014.
41. The coated particulate of any one of embodiments 30-40, wherein the isocyanate reactive blend further comprises a colorant.
42. The coated particulate of embodiment 41, wherein the colorant is to achieve a desired aesthetic effect.
43. The coated particulate of embodiment 42, wherein the colorant achieves a green color.
44. The coated particulate of embodiment 41 or 43, wherein the colorant is polyol-based colorant.
45. The coated particulate of embodiment 44, wherein the polyol-based colorant comprises phthalocyanine green G.
46. The coated particulate of embodiment 44, wherein the polyol-based colorant comprises Plasticolors® DL50056.
47. The coated particulate of embodiment 44, wherein the polyol-based colorant comprises Chromaflo CHROMA-CHEM® 50-990.
48. The coated particulate of embodiment 43, wherein the colorant comprises chrome (III) oxide (Cr₂O₃).
49. The coated particulate of embodiment 41, wherein the colorant achieves a black color.
50. The coated particulate of embodiment 49, wherein the colorant comprises iron oxide (FeO₂).
51. The coated particulate of embodiment 42, wherein the colorant comprises a green colorant, a yellow colorant, a back colorant, a red colorant, a blue colorant, magenta colorant, a white colorant or any combination thereof.
52. The coated particulate of embodiment 51, wherein the colorant is a blend of a green colorant and a yellow colorant.
53. The coated particulate of embodiment 52, wherein the green colorant is Plasticolors® DL-50056.
54. The coated particulate according to embodiments 52 or 53, wherein the yellow colorant is Plasticolors® DL 80943.
55. The coated particulate of any one of embodiments 52-54, wherein the ratio of the yellow colorant to the green colorant is about 1:10 to about 10:1.
56. The coated particulate of embodiment 55, wherein the ratio of the yellow colorant to the green colorant is about 4:1.
57. The coated particulate of any one of embodiments 14-56, wherein the isocyanate reactive blend further comprises a polyurethane catalyst.
58. The coated particulate of embodiment 57, wherein the polyurethane catalyst is dibutyltin dilaurate (Dabco T-12) or dimethyltin (TIB Kat®300).
59. The coated particulate of any one of embodiments 14-58, wherein the isocyanate reactive blend further comprises a UV stabilizer.
60. The coated particulate of embodiment 59, wherein the UV stabilizer is a hindered amine light stabilizer, benzophenone, benzotriazoie, hydroxyphenyl triazine, 2-(2′-hydroxyphenyl)benzotriazoles, Uvinol 3000, Tinuvin® P, Irganox 1098, Uvinol 3008, Lavinix, BHT, Tinuvin® 384-2, Tinuvin® 320, Tinuvin® 292 Irganox 1010, Irganox 1076, Irganox 1135, or Irgafos 168, or a combination thereof.
61. The coated particulate of embodiment 59, wherein the UV stabilizer is a solvent-free, liquid blend of a 2-(2-hydroxyphenyl)-benzotriazole UV absorber (UVA) and a basic hindered amine light stabilizer (HALS).
62. The coated particulate of embodiment 59, wherein the UV stabilizer is BASF Tinuvin® 5050.
63. The coated particulate of embodiment 59, wherein the UV stabilizer is BASF Tinuvin® 384-2.
64. The coated particulate of any one of embodiments 1-63, wherein the polymer coating further comprises an additive.
65. The coated particulate of embodiment 64, wherein the additive is a UV stabilizer, a surfactant, an antimicrobial agent, an anti-block pigment, a tint, a dye, an IR reflective colorant, an impact modifier, an omniphobic low surface energy agent, a wetting agent, an antifoaming agent, a plasticizer, or a blowing agent, a silicone fluid, DI water, a surface chemistry modifier, or a catalyst, or a combination thereof.
66. The coated particulate of embodiment 64, wherein the additive is an impact strength enhancer, a reinforcing agent, a reaction rate enhancer or catalyst, a crosslinking agent, an optical brightener, a propylene carbonate, a coloring agent, a fluorescent agent, a whitening agent, a hindered amine a light stabilizer, a processing aid, a mica, a talc, a nano-filler, a silane coupling agent, an anti-slip agent, a water affinity or repulsion component, a water-activated agent, a viscosifier, a flow aid, an anticaking agent, a wetting agent, a surface chemistry modifier, or a toughening agent such as one or more block copolymers, or a combination thereof.
67. The coated particulate of embodiment 64, wherein the additive is a surfactant.
68. The coated particulate of embodiment 67, wherein the surfactant is an anionic surfactant.
69. The coated particulate of embodiment 68, wherein the anionic surfactant is sodium lauryl sulfate (SLS).
70. The coated particulate of embodiment 66, wherein the additive is an antimicrobial agent.
71. The coated particulate of embodiment 70, wherein the antimicrobial agent is a boron-containing compound.
72. The coated particulate of embodiment 71, wherein the boron-containing compound is borax pentahydrate, borax decahydrate, boric acid, polyborate, tetraboric acid, sodium metaborate, anhydrous, or boron components of polymers, or a combination thereof.
73. The coated particulate of embodiment 70, wherein the antimicrobial agent is a silver based material, cupper based material such as cuprous oxide, or zinc based material such as zinc oxide copper, or a combination thereof such as a copper-silver-zinc alloy, copper-silver alloys, or silver-zinc alloy.
74. The coated particulate of embodiment 70, wherein the zinc based material comprises Zinc pyrithione.
75. The coated particulate of embodiment 74, wherein the zinc based material is Biomaster 627.
76. The coated particulate of embodiment 64 wherein the zinc based material comprises Zinc 2-pyridinethiol-1-oxide
77. The coated particulate of embodiment 76 wherein the zinc based material is Zinc Omadine™.
78. The coated particulate of embodiment 70, wherein the antimicrobial agent comprises N-butyl-1, 2-benzisothiazolin-3-one (BBIT).
79. The coated particulate of embodiment 78, wherein the antimicrobial agent is Vanquish™ 100.
80. The coated particulate of embodiment 64, wherein the additive is a silicone fluid.
81. The coated particulate of embodiment 64, wherein the additive is a surface chemistry modifier.
82. The coated particulate of embodiment 81, wherein the surface chemistry modifier is a dispersion of functionalized or non-functionalized fumed metal oxides.
83. The coated particulate of embodiment 82, wherein the functionalized fumed metal oxide has a functionality selected from the group of amine, epoxy, isocyanate, polymeric, hydrophobic, and hydrophilic functionalities, and any combination thereof.
84. The coated particulate of embodiment 82 or 83, wherein the fumed metal oxides in an amount from 0.01 wt. % to 1.9 wt. % of the coated particles.
85. The coated particulate of embodiment 84, wherein the fumed metal oxide is a fumed silica.
86. The coated particulate of embodiment 85, wherein the fumed silica is a non-functionalized fumed silica.
87. The coated particulate of embodiment 85, wherein the fumed silica is a functionalized fumed silica.
88. The coated particulate of any one of embodiments 85-87, wherein the fumed silica has an average particle size from 10 nm to 700 nm.
89. The coated particulate of any one of embodiments 85-87, wherein the fumed silica in the dispersion is in an amount from 5 wt. % to 40 wt. % of the dispersion.
90. The coated particulate of embodiment 81, wherein the surface chemistry modifier is a dispersion of functionalized or non-functionalized colloidal silica.
91. The coated particulate of embodiment 90, wherein the colloidal silica in an amount from 0.01 wt. % to 1.9 wt. % of the coated particles.
92. The coated particulate of embodiment 90 or 91, wherein the colloidal silica in the dispersion is in an amount from 5 wt. % to 40 wt. % of the dispersion.
93. The coated particulate of embodiment 81, wherein the surface chemistry modifier is Cocamidopropyl Hydroxysultaine (Chembetaine™, Lubrizol).
94. The coated particulate of embodiment 81, wherein the surface chemistry modifier is a polydimethyl siloxane having silanol groups in the terminal position (F1006, Wacker Chemie AG).
95. The coated particulate of embodiment 81, wherein the surface chemistry modifier is a polysiloxane with polyether groups (SG 3381, Wacker Chemie AG).
96. The coated particulate of embodiment 81, wherein the surface chemistry modifier is a silicone, a siloxane, or a fluoropolymer or a combination thereof.
97. The coated particulate of embodiment 81, wherein the surface chemistry modifier is SILRES® BS 26 A, Wacker Chemie AG.
98. The coated particulate of embodiment 65, wherein the impact modifier is DNC 701.01.
99. The coated particulate of embodiment 65, wherein the impact modifier is VORALUX™ HL 431.
100. The coated particulate of any one of embodiments 1-99, wherein the core is a sand particle, a bauxite particle, or a ceramic particle.
101. The coated particulate of any one of embodiments 1-100, wherein the core is a sand particle.
102. A composition comprising two or more types of coated particulates, wherein each coated particulate is, independently, a particulate of any one of embodiments 1-101.
103. The composition of embodiment 102, wherein the composition comprises two types of coated particulates, wherein each coated particulate is, independently, a particulate of any one of embodiments 1-101.
104. The composition of embodiment 102 or 103, wherein the composition comprises two types of coated particulates, wherein each type of the coated particulate has a different surface chemistry functionality.
105. The composition of embodiment 104, wherein one type of the coated particulate is hydrophilic and the other type of the coated particulate is hydrophobic.
106. The composition of any one of embodiments 103-105, wherein the weight ratio of the two types of coated particulates is from 1:99 to 99:1.
107. A method of producing the polyurethane coated particulates of any one of embodiments 1-101 or the composition of any one of embodiments 102-106 comprising:
a) heating particulates in an oven;
b) transferring the heated particulates to a mixer;
c) adding the coupling agent into the mixer;
d) adding the isocyanate reactive blend into the mixer;
e) adding the isocyanate component into the mixer; and
f) optionally adding the additive into the mixer to produce the polyurethane coated particulates.
108. The method of embodiment 107 further comprises repeating steps d) to f) to add one or more additional polyurethane coatings.
109. The method according to embodiments 107 or 108, wherein the particulates in step a) are heated in the oven to a temperature from about 100° C. to about 210° C. or from about 60° C. to about 210° C.
110. The method according to embodiments 107 or 108, wherein the particulates in step a) are heated in the oven to a temperature from about 120° C. to about 180° C. or from about 60° C. to about 180° C.
111. The method according to embodiments 107 or 108, wherein the particulates in step a) are heated in the oven to a temperature from about 140° C. to about 160° C. or from about 60° C. to about 160° C.
112. The method according to embodiments 107 or 108, wherein the particulates in step a) are heated in the oven to a temperature from about 145° C. to about 155° C. or from about 60° C. to about 155° C.
113. The method according to embodiments 107 or 108, wherein the particulates in step a) are heated in the oven to a temperature of about 80° C., about 88° C., about 93, about 104, about 107° C., about 110° C. or about 150° C.
114. The method of any one of embodiments 107-113, wherein the mixer in step b) is a Webac mixer.
115. The method of any one of embodiments 107-114, wherein the coupling agent in step c) are added when the temperature of the particulates is from about 80° C. to about 150° C.
116. The method of any one of embodiments 107-114, wherein the coupling agent in step c) are added when the temperature of the particulates is from about 90° C. to about 140° C.
117. The method of any one of embodiments 107-114, wherein the coupling agent in step c) are added when the temperature of the particulates is from about 90° C. to about 130° C.
118. The method of any one of embodiments 107-114, wherein the coupling agent in step c) are added when the temperature of the particulates is from about 90° C. to about 120° C.
119. The method of any one of embodiments 107-114, wherein the coupling agent in step c) are added when the temperature of the particulates is from about 90° C. to about 115° C.
120. The method of any one of embodiments 107-114, wherein the coupling agent in step c) are added when the temperature of the particulates is about 93° C.
121. The method of any one of embodiments 107-114, wherein the coupling agent in step c) are added when the temperature of the particulates is about 110° C.
122. The method of any one of embodiments 107-21, wherein the isocyanate reactive blend in step d) is added after a second to about 15 seconds from the start of the addition of the coupling agent.
123. The method of embodiment 122, wherein the isocyanate reactive blend is added over a period of about 10 seconds.
124. The method of any one of embodiments 107-123, wherein the isocyanate component in step e) is added after about 20 seconds from the start of the addition of the coupling agent.
125. The method of embodiment 124, wherein the isocyanate component is added over a period of about 10 seconds.
126. The method of any one of embodiments 107-125, wherein the additive in step f) is added after 0 second to about 35 seconds from the start of the addition of the coupling agent.
127. The method of embodiment 107, wherein the isocyanate component is added over a period of about 5 seconds.
128. The method of any one of embodiments 107-127, wherein the coated particulates in step f) are discharged after mixing in the mixer for about 30 seconds to 5 minutes.
129. The method of any one of embodiments 107-127, wherein the coated particulates in step f) are discharged after mixing in the mixer for about 50 seconds to 3 minutes.
130. The method of any one of embodiments 107-127, wherein the coated particulates in step f) are discharged after mixing in the mixer for about 50 seconds.
131. The method of any one of embodiments 107-127, wherein the coated particulates in step f) are discharged after mixing in the mixer for about 1 minute.
132. The method of any one of embodiments 107-127, wherein the coated particulates in step f) are discharged after mixing in the mixer for about 2 minutes.
133. The method of any one of embodiments 107-132, wherein the coated particulates in step f) are discharged into a pan and allowed to cool.
134. The method of any one of embodiments 107-133, wherein the coated particulates are dry and free flowing coated particulates.
135. A method of producing coated particulates of any one of embodiments 1-101 or the composition of any one of embodiments 102-106 comprising:
feeding heated particulates into an inlet of a first mixer, the first mixer comprising an outer wall and at least one auger comprising a rotating shaft and a plurality of paddles connected thereto, wherein the at least one auger of the first mixer is rotating at a rate to form an annulus of particulates positioned along the interior surface of the outer wall of the first mixer and moving the particulates towards an outlet of the first mixer;
mixing the annulus of particulates with coating compositions that are fed into the mixer through dosing ports operably connected to the first mixer;
discharging the coated particulates through the outlet to the second mixer;
mixing the annulus of particulates with coating compositions that are fed into the mixer through dosing ports operably connected to the first mixer; and
discharging the coated particulates through the outlet.
136. The method of embodiment 135, wherein the at least one auger rotates at a rate of about 60 rotations per minute (RPM) to about 1200 RPM.
137. The method of embodiment 135 or 136, wherein the particulates move from the inlet to the outlet in an average time from about 2 seconds to about 15 seconds.
138. The method of any one of embodiments 135-137, wherein the particulates are discharged from the outlet at an average rate of about 100 pounds per minute to about 6000 pounds of particulates per minute.
139. The method of any one of embodiments 135-138, wherein the particulates are discharged from the outlet at an average rate of about 3 tons per hour to about 180 tons per hour.
140. The method of any one of embodiments 135-139, wherein the first mixer further comprises at least a second dosing port operably connected to the mixer.
141. The method of any one of embodiments 135-140, wherein the method further comprises mixing the annulus of particulates with a second coating composition that is fed into the mixer through the second dosing port.
142. The method of any one of embodiments 135-141, further comprising injecting at least a first gas with the coating composition into one or more dosing ports of the first mixer, wherein the gas fills a space in the center of the particulate annulus in the first mixer.
143. The method of any one of embodiments 135-142, wherein each paddle of the first mixer has an orientation from about −45 degrees to about +45 degrees in relation to the horizontal axis of the rotating shaft to which said paddle is connected.
144. The method of embodiment 143, wherein each paddle has an orientation of −45 degrees, 0 degrees, or +45 degrees or wherein the plurality of the paddles are oriented at −45 degrees.
145. The method according to embodiments 143 or 144, wherein the paddles of the first mixer are grouped into an inlet zone, a middle zone, and an outlet zone.
146. The method of embodiment 145, wherein the paddles in the inlet zone are oriented randomly at either −45 degrees, 0 degrees, or +45 degrees.
147. The method of embodiment 146, wherein all of the paddles in the inlet zone are oriented at 0 degrees or at +45 degrees.
148. The method of any one of embodiments 135-147, further comprising at least a second mixer arranged in series with the first mixer, such that particulates are fed into the inlet of the first mixer at or approximately at the same time as particulates are fed into an inlet of the second mixer.
149. The method of embodiment 148, further comprising the steps of:
heating the particulates to a first temperature in a container; and
feeding the particulates from the container into the inlet of the first mixer and the inlet of the second mixer, such that particulates are fed into the inlet of the first mixer at or approximately at the same time as particulates are fed into the inlet of the second mixer.
150. A method of producing coated particulates of any one of embodiments 1-101 or the composition of any one of embodiments 102-106 comprising:
optionally heating particulates to a first temperature;
feeding the optionally heated particulates into an inlet of the first mixer, wherein the first mixer comprises an outer wall and an auger comprising a rotating shaft and multiple paddles connected thereto, wherein the auger is rotating at a rate of about 60 rotations per minute to about 1200 rotations per minute,
wherein the auger moves a plurality of the particulates into an annulus positioned along the outer wall;
wherein the auger is capable of moving the particulates towards an outlet of the first mixer in an average time from about 2 seconds to about 20 seconds;
optionally heating a coating composition to a second temperature, wherein the second temperature is higher than the melting point of the coating composition;
feeding the coating composition into at least a first dosing port of the first mixer with or without a gas, wherein the coating composition mixes with the particulates in the rotating mixer, and wherein the coating composition coats the particulates as they move towards the outlet; and
collecting the coated particulates as the coated particulates are discharged from the outlet;
151. The method of embodiment 150, wherein the method produces coated particulates at an average rate of about 3 tons per hour to about 180 tons per hour.
152. An artificial turf comprising the coated particulate of any one of embodiments 1-101 or the composition of any one of embodiments 102-106 or the coated particulate prepared according to the method of any one of embodiments 107-151.
153. The artificial turf of embodiment 152, wherein the artificial turf effectively drains water on the surface of the artificial turf.
154. The artificial turf of embodiment 152, wherein the artificial turf is effectively resistant to microbial growth.
155. An artificial turf, comprising:
a backing having pile fibers extending upwardly therefrom; and
a filler of coated particulate of any one of embodiment 1-101 or the composition of any one of embodiments 102-106 or the coated particulate prepared according to the method of any one of embodiments 107-151, and wherein the pile fibers extend substantially above the infill material.
156. A method of forming an artificial turf comprising:
placing an aggregate infill material onto a backing,
wherein the backing has pile fibers secured thereto and extending upwardly above the infill material and wherein the aggregate infill material comprises the coated particulates of any one of embodiments 1-101 or the composition of any one of embodiments 102-106 or the coated particulate prepared according to the method of any one of embodiments 107-151.

Although the present embodiments have been described in connection with certain specific embodiments for instructional purposes, the present embodiments are not limited thereto. Accordingly, various modifications, adaptations, and combinations of various features of the described embodiments can be practiced without departing from the scope of the invention as set forth in the claims. Furthermore, the following examples are illustrative, but not limiting, of the compounds, compositions and methods described herein. Other suitable modifications and adaptations known to those skilled in the art are within the scope of the following embodiments. Any and all journal articles, patent applications, issued patents, or other cited references are incorporated by reference in their entirety.

### EXAMPLES

### Example 1

Example 1 provides coated particulates for a turf infill comprising a single layer polyurethane based coating with an isocyanate index of about 1.0, and a cycle time of 3 minutes. The particulates were prepared as described and provided for herein using 9060 grams of 16/30 mesh size sand, which was introduced into a batch mixer.

ADDITION CYCLE

| Time | |
|---|---|
| (m:s) | Step |
| 0:00 | 9060 g of preheated sand (110° C.) is added to a mixer |
| 0:00 | 7.25 g of the coupling agent aminopropyltriethoxysilane |
| | (GENIOSIL ® GF 93) is added with mixing over a 5 second |
| | period |
| 0:15 | 26.41 g of the isocyanate reactive blend (13.73 g of a hydroxyl |
| | functional polyol based on UV-resistant castor oil (Albodur ® |
| | 1055), 12.53 g of a green color polychlorinated copper |
| | phthalocyanine (25%) pigment (Plasticolors ® DL 50056), 0.15 g |
| | of a dibutyltin dilaurate (Dabco ® T-12) is added over a 10 |
| | second period |
| 0:20 | 26.70 g of an isocyanate terminated polypropylene glycol |
| | prepolymer based on hydrogenated 4,4′ methylenebis diisocyanate |
| | (HMDI) f(Lupranate ® 5570) is added over a 10 second period |
| 3:00 | Coated sand is discharged |

### Example 2

Example 2 provided coated particulates for a turf infill comprising a single layer polyurethane based coating with an isocyanate index of about 1.1, and a cycle time of 50 seconds. The particulates were prepared as described and provided for herein using 9060 grams of 16/30 mesh size sand, which was introduced into a batch mixer.

ADDITION CYCLE

| Time | |
|---|---|
| (m:s) | Step |
| 0:00 | 9060 g of preheated sand (220° F.) is added to a mixer |
| 0:00 | 7.25 g of the coupling agent aminopropyltriethoxysilane |
| | (GENIOSIL ® GF 93) is added with mixing over a 5 second |
| | period |
| 0:15 | 21.95 g of the isocyanate reactive blend (9.34 g of 1,4-butanediol, |
| | 12.45 g of a green color polychlorinated copper phthalocyanine |
| | (25%) pigment (Plasticolors ® DL 50056, 0.16 g of a dibutyltin |
| | dilaurate (Dabco ® T-12) is added over a 10 second period |
| 0:20 | 31.15 g of a polymeric MDI isocyanate with a functionality of |
| | approximately 2.7 (Lupranate ® M20) is added over a 10 second |
| | period |
| 0:35 | 2.27 g of a surfactantsodium lauryl sulfate (CHEMTERGE SLS- |
| | 30, BYK) is added over a 5 second period |
| 1:00 | Coated sand is discharged |

### Example 3

Example 3 provided coated particulates for a turf infill comprising a single layer polyurethane based coating with an isocyanate index of about 1.8, and a cycle time of 1 minute. The particulates were prepared as described and provided for herein using 9060 grams of 16/30 mesh size sand, which was introduced into a batch mixer.

ADDITION CYCLE

| Time | |
|---|---|
| (m:s) | Step |
| 0:00 | 9060 g of preheated sand (220° F.) is added to a mixer |
| 0:00 | 7.25 g of the coupling agent aminopropyltriethoxysilane |
| | (GENIOSIL ® GF 93) is added with mixing over a 5 second |
| | period |
| 0:15 | 20.39 g of the isocyanate reactive blend (8.89 g of a polyether |
| | polyol (TERAFORCE ™ 62575), 11.33 g of a green color |
| | polychlorinated copper phthalocyanine (25%) pigment |
| | (Plasticolors ® DL 50056), 0.17 g of a dibutyltin dilaurate |
| | (Dabco ® T-12) is added over a 10 second period |
| 0:20 | 27.91 g of a polymeric MDI isocyanate (HF-459) is added over a |
| | 10 second period |
| 1:00 | Coated sand is discharged |

### Example 4

Example 4 provided coated particulates for a turf infill comprising a single layer polyurethane based coating with an isocyanate index of about 1.5, and a cycle time of 1 minute. The particulates were prepared as described and provided for herein using 9060 grams of 16/30 mesh size sand, which was introduced into a batch mixer.

ADDITION CYCLE

| Time | |
|---|---|
| (m:s) | Step |
| 0:00 | 9060 g of preheated sand (220° F.) is added to a mixer |
| 0:00 | 7.25 g of the coupling agent aminopropyltriethoxysilane |
| | (GENIOSIL ® GF 93) is added with mixing over a 5 second |
| | period |
| 0:15 | 26.47 g of the isocyanate reactive blend (10.45 g of a polyether |
| | polyol (TERAFORCE ™ 62575), 11.33 g of a green color |
| | polychlorinated copper phthalocyanine (25%) pigment |
| | (Plasticolors ® DL 50056, 0.17 g of a dibutyltin dilaurate |
| | (Dabco ® T-12), 4.53 g of a solvent-free, liquid blend of a |
| | 2-(2-hydroxyphenyl)-benzotriazole UV absorber (UVA) and a |
| | basic hindered amine light stabilizer (HALS) (Tinuvin ® 5050) |
| | is added over a 10 second period |
| 0:20 | 26.36 g of a polymeric MDI isocyanate (HF-459) is added over a |
| | 10 second period |
| 1:00 | Coated sand is discharged. |

### Example 5

Example 5 provided coated particulates for a turf infill comprising a dual-layer coating in which Layer 1 is a polyurethane based coating with an isocyanate index of about 1.5 and in which Layer 2 with isocyanate index of about 1.3, and an overall cycle time of 1 minute. The particulates were prepared as described and provided for herein using 9060 grams of 16/30 mesh size sand, which was introduced into a batch mixer.

ADDITION CYCLE

| Time | |
|---|---|
| (m:s) | Step |
| 0:00 | 9060 g of preheated sand (220° F.) is added to a mixer |
| 0:00 | 7.25 g of the coupling agent aminopropyltriethoxysilane |
| | (GENIOSIL ® GF 93) is added with mixing over a 5 second |
| | period |
| 0:15 | 15.27 g of the first layer isocyanate reactive blend (3.86 g of a |
| | polyether polyol (TERAFORCE ™ 62575), 11.33 g of a green |
| | color polychlorinated copper phthalocyanine (25%) pigment |
| | (Plasticolors ® DL 50056, 0.08 g of a dibutyltin dilaurate |
| | (Dabco ® T-12) is added over a 10 second period |
| 0:20 | 10.29 g of the first layer of a polymeric MDI isocyanate (HF-459) |
| | is added over a 10 second period |
| 0:35 | 9.56 g of the second layer isocyanate reactive blend (7.21 g of a |
| | polyether polyol (TERAFORCE ™ 62575), 0.08 g of a dibutyltin |
| | dilaurate (Dabco ® T-12), 2.27 g of a solvent-free, liquid blend |
| | of a 2-(2-hydroxyphenyl)-benzotriazole UV absorber (UVA) and a |
| | basic hindered amine light stabilizer (HALS) (Tinuvin ® 5050)) is |
| | added over a 10 second period |
| 0:40 | 15.44 g of the second layer of a polymeric MDI isocyanate (HF- |
| | 459) is added over a 10 second period |
| 1:00 | Coated sand is discharged |

### Example 6

Example 6 provided coated particulates for a turf infill comprising a dual-layer coating in which Layer 1 is a polyurethane based coating with an isocyanate index of about 1.5 and in which Layer 2 is a PUD (polyurethane dispersion) based coating, and an overall cycle time of 1 minute. The particulates were prepared as described and provided for herein using 9060 grams of 16/30 mesh size sand, which was introduced into a batch mixer.

ADDITION CYCLE

| Time | |
|---|---|
| (m:s) | Step |
| 0:00 | 9060 g of preheated sand (220° F.) is added to a mixer |
| 0:00 | 7.25 g of the coupling agent aminopropyltriethoxysilane |
| | (GENIOSIL ® GF 93) is added with mixing over a 5 second |
| | period |
| 0:15 | 15.27 g of the first layer isocyanate reactive blend (3.86 g of a |
| | polyether polyol (TERAFORCE ™ 62575), 11.33 g of a green |
| | color polychlorinated copper phthalocyanine (25%) pigment |
| | (Plasticolors ® DL 50056, 0.08 g of a dibutyltin dilaurate |
| | (Dabco ® T-12) is added over a 10 second period |
| 0:20 | 10.29 g of first layer of a polymeric MDI isocyanate (HF-459) is |
| | added over a 10 second period |
| 0:35 | 24.92 g of second layer PUD blend (22.65 g of an aqueous, |
| | colloidal, anionic, low viscous dispersion of an aliphatic polyester- |
| | polyurethane without free isocyanate groups (Alberdingk ® U |
| | 6100), 2.27 g of a solvent-free, liquid blend of a 2-(2- |
| | hydroxyphenyl)-benzotriazole UV absorber (UVA) and a basic |
| | hindered amine light stabilizer (HALS) (Tinuvin ® 5050)) is added |
| | over a 10 second period |
| 1:00 | Coated sand is discharged. |

### Example 7

Example 7 provided coated particulates for a turf infill comprising a single layer polyurethane based coating with an isocyanate index of about 1.0, and a cycle time of 2 minutes. The particulates were prepared as described and provided for herein using 9060 grams of 16/30 mesh size sand, which was introduced into a batch mixer.

ADDITION CYCLE

| Time | |
|---|---|
| (m:s) | Step |
| 0:00 | 9060 g of preheated sand (220° F.) is added to a mixer |
| 0:00 | 7.25 g of the coupling agent aminopropyltriethoxysilane |
| | (GENIOSIL ® GF 93) is added with mixing over a 5 sec period |
| 0:15 | 20.39 g of the isocyanate reactive blend (8.89 g of a polyether |
| | polyol (TERAFORCE ™ 62575), 11.33 g of a green color |
| | polychlorinated copper phthalocyanine (25%) pigment |
| | (Plasticolors ® DL 50056), 0.17 g of a dibutyltin dilaurate |
| | (Dabco ® T-12) is added over a 10 second period |
| 0:20 | 27.91 g of a polymeric MDI isocyanate (HF-459) is added over a |
| | 10 second period |
| 0:35 | 6.80 g of a fumed silica dispersion of a dispersant-free and |
| | electrostatically stabilized fumed silica for water-based systems |
| | (CAB-O-SPERSE 1020K, Cabot) is added over a 5 second period |
| 1:00 | Coated sand is discharged |

### Example 8

Example 8 provided coated particulates for a turf infill comprising a single layer phenolic based coating with a cycle time of 1 minute 20 seconds. The particulates were prepared as described and provided for herein using 9060 grams of 16/30 mesh size sand, which was introduced into a batch mixer.

ADDITION CYCLE

| Time | |
|---|---|
| (min:sec) | Step |
| 0:00 | 9060 g of preheated sand (205° C.) was added to a mixer |
| 0:00 | 27.18 g of the coupling agent 3-aminopropylsilane |
| | hydrolysate silane (Dynasylan ® HYDROSIL 1151) was |
| | added with mixing over a 5 second period |
| 0:15 | 20.39 g of the novolac phenolic resin (PSM 4327, GUN EI |
| | Chemical Industry Co.) was added over a 5 second period |
| 0:45 | 5.62 g of the hexamethylenetetramine (38 wt. % in DI water) |
| | was added over a 5 second period |
| 1:00 | 1.13 g of a clear, colorless polydimethyl siloxane fluid having |
| | silanol group in the terminal position (F1006), Wacker |
| | Chemie AG) was added over a 5 second period |
| 1:05 | 1.13 g of a surface chemistry modifier (BYK-LP X 6297) was |
| | added over a 5 second period |
| 1:20 | Coated sand was discharged |

### Example 9

Example 9 provided coated particulates for a turf infill comprising a dual-layer coating in which Layer 1 is a phenolic coating and Layer 2 is a polyurethane based coating with an isocyanate index of about 1.5, and a cycle time of 2 minutes. The particulates were prepared as described and provided for herein using 9060 grams of 16/30 mesh size sand, which was introduced into a batch mixer.

ADDITION CYCLE

| Time | |
|---|---|
| (m:s) | Step |
| 0:00 | 9060 g of preheated sand (205° C.) is added to a mixer |
| 0:00 | 27.18 g of the coupling agent 3-aminopropylsilane hydrolysate |
| | silane (Dynasylan ® HYDROSIL 1151) is added with mixing over |
| | a 5 second period |
| 0:15 | 20.39 g of the novolac phenolic resin (PSM 6385, GUN EI |
| | Chemical Industry Co.) is added over a 5 second period |
| 0:45 | 5.62 g of the hexamethylenetetramine (38 wt. % in DI water) |
| | solution is added over a 5 second period |
| 1:00 | 90.6 g of DI water is added over a 5 second period |
| 1:20 | 16.68 g of the isocyanate reactive blend (3.00 g of a polyether |
| | polyol (TERAFORCE ™ 62575), 11.33 g of a green color |
| | polychlorinated copper phthalocyanine (25%) pigment |
| | (Plasticolors ® DL 50056, 0.08 g of a dibutyltin dilaurate |
| | (Dabco ® T-12, 2.27 g of a solvent-free, liquid blend of a |
| | 2-(2-hydroxyphenyl)-benzotriazole UV absorber (UVA) and a |
| | basic hindered amine light stabilizer (HALS) (Tinuvin ® 5050) |
| | is added over a 10 second period |
| 1:25 | 10.42 g of a polymeric MDI isocyanate (HF-459) is added over a |
| | 10 second period |
| 1:45 | 1.13 g of a clear, colorless polydimethyl siloxane fluid having |
| | silanol group in the terminal position (F1006, Wacker Chemie AG) |
| | is added over a 5 second period |
| 1:55 | 1.13 g of a coconut oil-derived, high-foaming, mild surfactant |
| | (Chembetaine, Lubrizol) is added over a 5 second period |
| 2:00 | Coated sand is discharged |

### Example 10

Example 10 provided coated particulates for a turf infill comprising a single layer epoxy based coating with a cycle time of 50 seconds. The particulates were prepared as described and provided for herein using 9060 grams of 16/30 mesh size sand, which was introduced into a batch mixer.

ADDITION CYCLE

| Time | |
|---|---|
| (m:s) | Step |
| 0:00 | 9060 g of preheated sand (205° C.) is added to a mixer |
| 0:00 | 27.18 g of the coupling agent 3-aminopropylsilane hydrolysate |
| | silane (Dynasylan ® HYDROSIL 1151) is added with mixing over |
| | a 5 second period |
| 0:15 | 40.02 g of the epoxy dispersion, curative and hardener blend |
| | (37.75 g of a modified, semi-solid, epoxy novolac resin emulsified |
| | in water (DOW DER 916 ™) and 2.27 g triethylenetetramine, a |
| | liquid aliphatic polyamine curing agent (DEH ™ 24) is added over |
| | a 10 second period |
| 0:35 | 1.13 g of a clear, colorless polydimethyl siloxane fluid having |
| | silanol group in the terminal position (F1006, Wacker Chemie AG) |
| | is added over a 5 second period |
| 0:50 | Coated sand is discharged |

### Example 11

Example 11 provided coated particulates for a turf infill comprising a dual-layer coating in which Layer 1 is an epoxy based coating and Layer 2 is a polyurethane based coating with an isocyanate index of about 1.5, and cycle time of 1 minute 20 seconds. The particulates were prepared as described and provided for herein using 9060 grams of 16/30 mesh size sand, which was introduced into a batch mixer.

ADDITION CYCLE

| Time | |
|---|---|
| (m:s) | Step |
| 0:00 | 9060 g of preheated sand (205° C.) is added to a mixer |
| 0:00 | 27.18 g of the coupling agent 3-aminopropylsilane hydrolysate |
| | silane (Dynasylan ® HYDROSIL 1151) is added with mixing over |
| | a 5 second period |
| 0:15 | 38.43 g of the epoxy dispersion, curative and hardener blend |
| | (37.75 g of a modified, semi-solid, epoxy novolac resin emulsified |
| | in water (DOW DER 916 ™) and 0.68 g of a low viscosity |
| | accelerated aliphatic polyamine curing agent (DEH ™ 58), which |
| | is a mixture of diethylenetriamine and 35% bisphenol A) is added |
| | over a 10 second period |
| 0:30 | 16.68 g of the isocyanate reactive blend (3.00 g of a polyether |
| | polyol (TERAFORCE ™ 62575), 11.33 g of a green color |
| | polychlorinated copper phthalocyanine (25%) pigment |
| | (Plasticolors ® DL 50056), 0.08 g of a dibutyltin dilaurate |
| | (Dabco ® T-12), 2.27 g of a solvent-free, liquid blend of a |
| | 2-(2-hydroxyphenyl)-benzotriazole UV absorber (UVA) and a |
| | basic hindered amine light stabilizer (HALS) (Tinuvin ® 5050)) |
| | is added over a 10 second period |
| 0:35 | 10.42 g of a polymeric MDI isocyanate (HF-459) is added over a |
| | 10 second period |
| 1:00 | 1.13 g of a stable, emulsion of silane, siloxane and organic |
| | polymer, (SILRES ® BS 26A), Wacker Chemie AG) as a surface |
| | chemistry modifier is added over a 5 second period |
| 1:20 | Coated sand is discharged |

### Example 12

Example 12 provided coated particulates for a turf infill comprising a dual-layer coating in which Layer 1 is a polyurethane based coating with an isocyanate index of about 1.5 and in which Layer 2 is a polyurethane based coating with an isocyanate index of about 1.3, and an overall cycle time of 1 minute. The particulates were prepared as described and provided for herein using 9060 grams of 12/20 mesh size sand which was introduced into a batch mixer

ADDITION CYCLE

| Time | |
|---|---|
| (m:s) | Step |
| 0:00 | 9060 g of preheated sand (230° F.) is added to a mixer |
| 0:00 | 7.25 g of the coupling agent aminopropyltriethoxysilane |
| | (GENIOSIL ® GF 93) is added with mixing over a 5 second |
| | period |
| 0:15 | 15.27 g of the first layer isocyanate reactive blend (3.86 g of |
| | a polyether polyol (TERAFORCE ™ 62575), 11.33 g of a green |
| | color polychlorinated copper phthalocyanine (25%) pigment |
| | (Plasticolors ® DL 50056), 0.08 g of a dibutyltin dilaurate |
| | (Dabco ® T-12) is added over a 10 second period |
| 0:20 | 10.29 g of the first layer of a polymeric MDI isocyanate (HF- |
| | 459) is added over a 10 second period |
| 0:35 | 9.56 g of the second layer isocyanate reactive blend (7.21 g of a |
| | polyether polyol (TERAFORCE ™ 62575), 0.08 g of a dibutyltin |
| | dilaurate (Dabco ® T-12), 2.27 g of a solvent-free, liquid blend of |
| | a 2-(2-hydroxyphenyl)-benzotriazole UV absorber (UVA) and a |
| | basic hindered amine light stabilizer (HALS) (Tinuvin ® 5050)) is |
| | added over a 10 second period |
| 0:40 | 15.44 g of the second layer of a polymeric MDI isocyanate (HF- |
| | 459) is added over a 10 second period |
| 0:50 | 1.13 g of a polyalkylene oxide-modified polydimethylsiloxane |
| | having organo-funtional groups in the α,ω-position (WACKER ® |
| | SG 3381) as a surface chemistry modifier is added over a 5 second |
| | period |
| 1:00 | Coated sand is discharged |

### Example 13

Example 13 provided coated particulates for a turf infill comprising a dual-layer coating in which Layer 1 is a polyurethane based coating with an isocyanate index of about 0.85 and in which Layer 2 is a polyurethane based coating with an isocyanate index of about 0.85, and an overall cycle time of 1 minute. The particulates were prepared as described and provided for herein using 9060 grams of 16/30 mesh size sand, which was introduced into a batch mixer.

ADDITION CYCLE

| Time | |
|---|---|
| (m:s) | Step |
| 0:00 | 9060 g of preheated sand (220° F.) is added to a mixer |
| 0:00 | 7.25 g of the coupling agent aminopropyltriethoxysilane |
| | (GENIOSIL ® GF 93) is added with mixing over a 5 second |
| | period |
| 0:15 | 15.54 g of the first layer isocyanate reactive blend (6.39 g of a |
| | polyether polyol (TERAFORCE ™ 62575), 9.06 g of a green color |
| | polychlorinated copper phthalocyanine (25%) pigment |
| | (Plasticolors ® DL 50056), 0.08 g of a dibutyltin dilaurate |
| | (Dabco ® T-12) is added over a 10 second period |
| 0:20 | 9.46 g of the first layer of a polymeric MDI isocyanate (HF-459) is |
| | added over a 10 second period |
| 0:35 | 11.79 g of the second layer isocyanate reactive blend (9.44 g of a |
| | polyether polyol (TERAFORCE ™ 62575), 0.08 g of a dibutyltin |
| | dilaurate (Dabco ® T-12, 2.27 g of a solvent-free, liquid blend of a |
| | 2-(2-hydroxyphenyl)-benzotriazole UV absorber (UVA) and a |
| | basic hindered amine light stabilizer (HALS) (Tinuvin ® 5050)) is |
| | added over a 10 second period |
| 0:40 | 13.21 g of the second layer of a polymeric MDI isocyanate (HF- |
| | 459) is added over a 10 second period |
| 1:00 | Coated sand is discharged |

### Example 14

Example 14 provided coated particulates for a turf infill comprising a single layer polyurethane based coating with an isocyanate index of about 1.5, and an overall cycle time of 1 minute. The particulates were prepared as described and provided for herein using 9060 grams of 16/30 mesh size sand, which was introduced into a batch mixer.

ADDITION CYCLE

| Time | |
|---|---|
| (m:s) | Step |
| 0:00 | 9060 g of preheated sand (220° F.) is added to a mixer |
| 0:00 | 7.25 g of the coupling agent aminopropyltriethoxysilane |
| | (GENIOSIL ® GF 93) is added with mixing over a 5 second |
| | period |
| 0:15 | 19.77 g of the isocyanate reactive blend (8.26 g PLURACOL ® |
| | 858, 11.33 g of a green color polychlorinated copper |
| | phthalocyanine (25%) pigment (Plasticolors ® DL 50056), 0.17 g |
| | of a dibutyltin dilaurate (Dabco ® T-12) is added over a 10 |
| | second period |
| 0:20 | 28.54 g of a polymeric MDI isocyanate with a functionality of |
| | approximately 2.7 (Lupranate ® M20) is added over a 10 second |
| | period |
| 1:00 | Coated sand is discharged |

### Example 15

Example 15 provided coated particulates for a turf infill comprising a single layer polyurethane based coating with an isocyanate index of about 1.5, and an overall cycle time of 1 minute. The particulates were prepared as described and provided for herein using 9060 grams of 16/30 mesh size sand, which was introduced into a batch mixer.

ADDITION CYCLE

| Time | |
|---|---|
| (m:s) | Step |
| 0:00 | 9060 g of preheated sand (220° F.) is added to a mixer |
| 0:00 | 7.25 g of the coupling agent aminopropyltriethoxysilane |
| | (GENIOSIL ® GF 93) is added with mixing over a 5 second |
| | period |
| 0:15 | 19.87 g of the isocyanate reactive blend (8.37 g PLURACOL ® |
| | 1158, 11.33 g of a green color polychlorinated copper |
| | phthalocyanine (25%) pigment (Plasticolors ® DL 50056), 0.17 g |
| | of a dibutyltin dilaurate (Dabco ® T-12) is added over a 10 |
| | second period |
| 0:20 | 28.43 g of a polymeric MDI isocyanate with a functionality of |
| | approximately 2.7 Lupranate ® M20 is added over a 10 second |
| | period |
| 1:00 | Coated sand is discharged |

### Example 16

Example 16 provided coated particulates for a turf infill comprising a dual-layer coating in which Layer 1 is a polyurethane based coating with an isocyanate index of about 0.50 and in which Layer 2 is a polyurethane based coating with an isocyanate index of about 0.75, and an overall cycle time of 1 minute. The particulates were prepared as described and provided for herein using 9060 grams of 16/30 mesh size sand, which was introduced into a batch mixer.

ADDITION CYCLE

| Time | |
|---|---|
| (m:s) | Step |
| 0:00 | 9060 g of preheated sand (230° F.) is added to a mixer |
| 0:00 | 7.25 g of the coupling agent aminopropyltriethoxysilane |
| | (GENIOSIL ® GF 93) is added with mixing over a 5 second |
| | period |
| 0:15 | 21.21 g of the first layer isocyanate reactive blend (10.23 g of a |
| | polyether polyol (TERAFORCE ™ 62575), 10.87 g of a green |
| | color polychlorinated copper phthalocyanine (25%) pigment |
| | (Plasticolors ® DL 50056), 0.10 g a dibutyltin dilaurate |
| | (Dabco ® T-12) is added over a 10 second period |
| 0:20 | 8.79 g of the first layer of a polymeric MDI isocyanate (HF-459) |
| | is added over a 10 second period |
| 0:35 | 25.44 g of the second layer isocyanate reactive blend (12.16 g of a |
| | polyether polyol (TERAFORCE ™ 62575), 0.10 g a dibutyltin |
| | dilaurate (Dabco ® T-12), 2.31 g of a solvent-free, liquid blend |
| | of a 2-(2-hydroxyphenyl)-benzotriazole UV absorber (UVA) and a |
| | basic hindered amine light stabilizer (HALS) (Tinuvin ® 5050), |
| | 10.87 g of a 100% active, liquid sterically hindered phenolic |
| | antioxidant for polyols, polyurethanes, and other polymers |
| | (Irganox ® 1135) is added over a 10 second period |
| | 15.02 g of the second layer of a polymeric MDI isocyanate (HF- |
| 0:40 | 459) is added over a 10 second period |
| 0:50 | 1.00 g of a clear, colorless polydimethyl siloxane fluid having |
| | silanol group in the terminal position (F1006, Wacker Chemie |
| | AG) is added over a 5 second period |
| 1:00 | Coated sand is discharged |

### Example 17

Example 17 provided coated particulates for a turf infill comprising a dual-layer coating in which Layer 1 is a polyurethane based coating with an isocyanate index of about 0.50 and in which Layer 2 is a polyurethane based coating with an isocyanate index of about 0.75, and an overall cycle time of 1 minute. The particulates were prepared as described and provided for herein using 9060 grams of 16/30 mesh size sand, which was introduced into a batch mixer.

ADDITION CYCLE

| Time | |
|---|---|
| (m:s) | Step |
| 0:00 | 9060 g of preheated sand (220° F.) is added to a mixer |
| 0:00 | 7.25 g of the coupling agent aminopropyltriethoxysilane |
| | (GENIOSIL ® GF 93) is added with mixing over a 5 second |
| | period |
| 0:15 | 24.33 g of the first layer isocyanate reactive blend (10.23 g of |
| | a polyether polyol (TERAFORCE ™ 62575), 10.87 g of a green |
| | color polychlorinated copper phthalocyanine (25%) pigment |
| | (Plasticolors ® DL 50056), 0.10 g a dibutyltin dilaurate |
| | (Dabco ® T-12, 0.41 Tinuvin ® 292, 2.72 of a 100% active, |
| | liquid sterically hindered phenolic antioxidant for polyols, |
| | polyurethanes, and other polymers (Irganox ® 1135)) is |
| | added over a 10 second period |
| 0:20 | 8.79 g of the first layer of a polymeric MDI isocyanate (HF-459) is |
| | added over a 10 second period |
| 0:35 | 23.13 g of the second layer isocyanate reactive blend (12.16 g of a |
| | polyether polyol (TERAFORCE ™ 62575), 0.10 g a dibutyltin |
| | dilaurate (Dabco ® T-12), 10.87 g of a liquid hindered amine light |
| | stabilizer (Tinuvin ® 384-2) is added over a 10 second period |
| 0:40 | 15.02 g of the second layer of a polymeric MDI isocyanate (HF- |
| | 459) is added over a 10 second period |
| 1:00 | 15.10 g of a stable, emulsion of silane, siloxane and organic |
| | polymer. (SILRES ® BS 26 A) is added for 10 seconds |
| 1:10 | Coated sand is discharged |

### Example 18

Example 18 provided coated particulates for a turf infill comprising a dual-layer coating in which Layer 1 is a polyurethane based coating with an isocyanate index of about 1.3 and in which Layer 2 is a polyurethane based coating with an isocyanate index of about 1.3. The particulates were prepared as described and provided for herein. The of 16/30 mesh size sand was preheated at 225° F. and charged into the first of the 2 (in series) continuous mixers at flow rates of about 5000 lb/min.

MIXER PROCESSING PARAMETERS

| | |
|---|---|
| Flow Rate of Particles | 5000 lb/min |
| Temperature of Particles | 225° F. |

| DOSING | FORMULATION | | |
|---|---|---|---|
| PARAMETERS | | Flow | |
| Dosing Ports | | Rate | Mixer |
| Position | Chemicals | lbs/min | No. |
| A | Aminopropyltriethoxysilane (GENIOSIL ® | 4.00 | 1 |
| | GF 93) | | |
| B | Isocyanate reactive blend | 8.60 | 1 |
| | a polyether polyol (XUS 62575, Dow | | |
| | Chemical) (24.70 wt. %) | | |
| | a dibutyltin dilaurate (Dabco T12), Air | | |
| | Products (0.64 wt. %) | | |
| | Phthalocyanine green pigment dispersion | | |
| | based on polyol (ChromaFlo DL50056) | | |
| | (74.66 wt. %) | | |
| C | a polymeric MDI isocyanate (HF-459), Dow | 5.75 | 1 |
| | Chemical | | |
| D | Isocyanate reactive blend | 16.60 | 1 |
| | a polyether polyol (XUS 62575, Dow | | |
| | Chemical) (62.95 wt. %) | | |
| | a dibutyltin dilaurate (Dabco T12), Air | | |
| | Products (0.60 wt. %) | | |
| | a solvent-free, liquid blend of a 2-(2- | | |
| | hydroxyphenyl)-benzotriazole UV absorber | | |
| | (UVA) and a basic hindered amine light | | |
| | stabilizer (HAUS) (Tinuvin ® 5050) (30.12 | | |
| | wt. %) | | |
| | a 100% active, liquid sterically hindered | | |
| | phenolic antioxidant for polyols, | | |
| | polyurethanes, and other polymers | | |
| | (Irganox ® 1135) (6.33 wt. %) | | |
| E | of a polymeric MDI isocyanate (HF-459), | 14.55 | 1 |
| | Dow Chemical | | |
| F | a clear, colorless polydimethyl siloxane fluid | 0.55 | 2 |
| | having silanol group in the terminal position | | |
| | (F1006), | | |

### Example 19

Example 19 provided coated particulates for a turf infill comprising a dual layer coating in which Layer 1 is a polyurethane based coating with an isocyanate index of about 0.75 and in which Layer 2 is a polyurethane based coating with an isocyanate index of about 0.75. The particulates were prepared as described and provided for herein. The sand was preheated at 225° F. and charged into the first of the 2 (in series) continuous mixers at flow rates of about 1000 lb/min.

MIXER PROCESSING PARAMETERS

| | |
|---|---|
| Flow Rate of Particles | 1000 lb/min |
| Temperature of Particles | 225° F. |

| DOSING | FORMULATION - | | |
|---|---|---|---|
| PARAMETERS | | Flow | |
| Dosing Ports | | Rate | Mixer |
| Position | Chemicals | lbs/min | No. |
| A | Aminopropyltriethoxysilane (GENIOSIL ® GF | 0.80 | 1 |
| | 93) | | |
| B | Isocyanate reactive blend | 1.81 | 1 |
| | a polyether polyol (XUS 62575, Dow | | |
| | Chemical) (55.81 wt. %) | | |
| | a dibutyltin dilaurate (Dabco T12), Air | | |
| | Products (0.55 wt. %) | | |
| | a green color polychlorinated copper | | |
| | phthalocyanine (25%) pigment (Plasticolors ® | | |
| | DL 50056) (27.62 wt. %) | | |
| | a 100% active, liquid sterically hindered | | |
| | phenolic antioxidant for polyols, | | |
| | polyurethanes, and other polymers (BASF | | |
| | Irganox ® 1135) (13.81 wt. %) | | |
| | a liquid hindered amine light stabilizer | | |
| | especially developed for coatings (BASF | | |
| | Tinuvin ® 292) (2.21 wt. %) | | |
| C | of a polymeric MDI isocyanate (HF-459), | 1.11 | 1 |
| | Dow Chemical | | |
| D | Isocyanate reactive blend | 3.04 | 1 |
| | a polyether polyol (XUS 62575, Dow | | |
| | Chemical) (66.45 wt. %) | | |
| | a dibutyltin dilaurate (Dabco T12), Air | | |
| | Products (0.66 wt. %) | | |
| | a liquid hindered amine light stabilizer (BASF | | |
| | Tinuvin ® 384-2) (32.89 wt. %) | | |
| E | a polymeric MDI isocyanate (HF-459), Dow | 2.23 | |
| | Chemical | | |
| F | a stable, emulsion of silane, siloxane and | 0.30 | 2 |
| | organic polymer, (SILRES ® BS 26A), | | |
| | Wacker Chemie AG) as a surface chemistry | | |
| | modifier | | |

### Example 20

Example 20 provided coated particulates for a turf infill comprising a dual-layer coating in which Layer 1 is a polyurethane based coating with an isocyanate index of about 0.85 and in which Layer 2 is a polyurethane based coating with an isocyanate index of about 0.85, and an overall cycle time of 1 minute. The particulates were prepared as described and provided for herein using 9060 grams of 16/30 mesh size sand, which was introduced into a batch mixer.

ADDITION CYCLE

| Time | |
|---|---|
| (m:s) | Step |
| 0:00 | 9060 g of preheated sand (220° F.) is added to a mixer |
| 0:00 | 7.25 g of the coupling agent aminopropyltriethoxysilane |
| | (GENIOSIL ® GF 93) is added with mixing over a 5 second period |
| 0:15 | 15.54 g of the first layer isocyanate reactive blend (3.20 g of a |
| | polyether polyol (TERAFORCE ™ 62575), 3.20 g VORALUX ™ |
| | HL 431 polyol, 9.06 g of a green color polychlorinated copper |
| | phthalocyanine (25%) pigment (Plasticolors ® DL 50056), 0.08 g of |
| | a dibutyltin dilaurate (Dabco ® T-12) is added over a 10 second period |
| 0:20 | 9.46 g of the first layer of a polymeric MDI isocyanate (HF-459) is |
| | added over a 10 second period |
| 0:35 | 11.79 g of the second layer isocyanate reactive blend (4.72 g of a |
| | polyether polyol (TERAFORCE ™ 62575), 4.72 g VORALUX ™ |
| | HL 431polyol, 0.08 g of a dibutyltin dilaurate (Dabco ® T-12), 2.27 |
| | g of a solvent-free, liquid blend of a 2-(2-hydroxyphenyl)- |
| | benzotriazole UV absorber (UVA) and a basic hindered amine |
| | light stabilizer (HALS) (Tinuvin ® 5050)) is added over a 10 second period |
| 0:40 | 13.21 g of the second layer of a polymeric MDI isocyanate (HF- |
| | 459) is added over a 10 second period |
| 1:00 | Coated sand is discharged |

### Example 21

Example 21 provided coated particulates for a turf infill comprising a dual-layer polyurethane based coating with an isocyanate index of about 1.3, and an overall cycle time of 1 minute and 7 seconds. The particulates were prepared as described and provided for herein using 1000 pounds of 16/30 mesh size sand, which was introduced into a batch mixer.

ADDITION CYCLE

| Time | |
|---|---|
| (m:s) | Step |
| 0:00 | 1000 lb of preheated sand (190° F.) is added to a mixer |
| 0:04 | 0.40 lb of the coupling agent aminopropyltriethoxysilane |
| | (GENIOSIL ® GF 93) is added with mixing over a 5 second period |
| 0:15 | 1.93 lb of the first isocyanate reactive blend (0.89 lb of a low |
| | viscosity polyol with improved color stability (Cardolite ® NX- |
| | 9014), 0.20 lb of a green color polychlorinated copper |
| | phthalocyanine (25%) pigment (Plasticolors ® DL 50056), 0.80 lb |
| | of a red color iron oxide (50%) pigment (Plasticolors ® DL 80943), |
| | 0.01 lb of a dibutyltin dilaurate (Dabco ® T-12), 0.015 lb of Zinc |
| | pyrithione (Biomaster 627), 0.016 lb of an antimicrobial based on |
| | the active agent N-butyl-l,2-benzisothiazolin-3-one (BBIT) |
| | (Vanquish ™ 100 Antimicrobial) is added over a 10 second period |
| 0:17 | 2.47 lb of the second isocyanate reactive blend (2.39 lb of a low |
| | viscosity polyol with improved color stability (Cardolite ® NX- |
| | 9014), 0.02 lb a dibutyltin dilaurate (Dabco ® T-12), 0.030 lb of |
| | of Zinc pyrithione (Biomaster 627), 0.032 lb of of an antimicrobial |
| | based on the active agent N-butyl-1,2-benzisothiazolin-3-one |
| | (BBIT) (Vanquish ™ 100 Antimicrobial)) is added over a 10 second period |
| 0:20 | 3.67 lb of a solvent-free, low viscosity aliphatic polyisocyanate for |
| | lightfast and weather-resistant two-pack polyurethane coatings |
| | (Basonat ® HI 2000 NG) is added over a 10 second period |
| 0:60 | 0.25 lb of a clear, colorless polydimethyl siloxane fluid having |
| | silanol group in the terminal position (F1006), Wacker Chemie |
| | AG) is added over a 3 second period |
| 1:07 | Coated sand is discharged |

### Example 22

Example 22 provided coated particulates for a turf infill comprising a dual-layer polyurethane based coating with an isocyanate index of about 1.3, and an overall cycle time of 1 minute and 7 seconds. The particulates were prepared as described and provided for herein using 1000 pounds of 16/30 mesh size sand, which was introduced into a batch mixer.

ADDITION CYCLE

| Time | |
|---|---|
| (m:s) | Step |
| 0:00 | 1000 lb of preheated sand (190° F.) is added to a mixer |
| 0:04 | 0.40 lb of the coupling agent aminopropyltriethoxysilane |
| | (GENIOSIL ® GF 93) is added with mixing over a 5 second period |
| 0:15 | 1.93 lb of the first isocyanate reactive blend (0.89 lb of a low |
| | viscosity polyol with improved color stability (Cardolite ® NX- |
| | 9014), 0.20 lb of a green color polychlorinated copper |
| | phthalocyanine (25%) pigment (Plasticolors ® DL 50056), 0.80 lb |
| | of a red color iron oxide (50%) pigment (Plasticolors ® DL 80943), |
| | 0.01 lb a dibutyltin dilaurate (Dabco ® T-12), 0.015 lb of Zinc |
| | 2-pyridinethiol-1-oxide (Zinc Omadine ™ Antimicrobial), 0.016 lb |
| | of an antimicrobial based on the active agent N-butyl-1,2- |
| | benzisothiazolin-3-one (BBIT) (Vanquish ™ 100 Antimicrobial), is |
| | added over a 10 second period |
| 0:17 | 2.47 lb of the second isocyanate reactive blend (2.39 lb of a low |
| | viscosity polyol with improved color stability (Cardolite ® NX- |
| | 9014), 0.02 lb of a dibutyltin dilaurate (Dabco ® T-12), 0.030 lb of |
| | of Zinc 2-pyridinethiol-1-oxide (Zinc Omadine ™ Antimicrobial), |
| | 0.032 lb of of an antimicrobial based on the active agent N-butyl- |
| | 1,2-benzisothiazolin-3-one (BBIT) (Vanquish ™ 100 |
| | Antimicrobial)) is added over a 10 second period |
| 0:20 | 3.67 lb of isocyanate a solvent-free, low viscosity aliphatic |
| | polyisocyanate for lightfast and weather-resistant two-pack |
| | polyurethane coatings (Basonat ® HI 2000 NG) is added over a 10 second period |
| 0:60 | 0.25 lb of a clear, colorless polydimethyl siloxane fluid having |
| | silanol group in the terminal position (F1006), Wacker Chemie |
| | AG) is added over a 3 second period |
| 1:07 | Coated sand is discharged |

### Example 23

Example 23 provided coated particulates for a turf infill comprising a dual-layer polyurethane based coating with an isocyanate index of about 1.3, and an overall cycle time of 1 minute and 7 seconds. The particulates were prepared as described and provided for herein using 1000 pounds of 16/30 mesh size sand, which was introduced into a batch mixer.

ADDITION CYCLE

| Time | |
|---|---|
| (m:s) | Step |
| 0:00 | 1000 lb of preheated sand (190° F.) is added to a mixer |
| 0:04 | 0.40 lb of the coupling agent aminopropyltriethoxysilane |
| | (GENIOSIL ® GF 93) is added with mixing over a 5 second period |
| 0:15 | 1.93 lb of the first isocyanate reactive blend (0.89 lb of a low |
| | viscosity polyol with improved color stability (Cardolite ® NX- |
| | 9014), 0.20 lb of a green color polychlorinated copper |
| | phthalocyanine (25%) pigment (Plasticolors ® DL 50056), 0.80 lb |
| | of a red color iron oxide (50%) pigment (Plasticolors ® DL 80943), |
| | 0.01 lb of a dibutyltin dilaurate (Dabco ® T-12), 0.015 lb of Zinc |
| | pyrithione (Biomaster 627), 0.016 lb of an antimicrobial based on |
| | the active agent N-butyl-1,2-benzisothiazolin-3-one (BBIT) |
| | (Vanquish ™ 100 Antimicrobial)) is added over a 10 second period |
| 0:17 | 2.47 lb of the second isocyanate reactive blend (2.39 lb of a low |
| | viscosity polyol with improved color stability (Cardolite ® NX- |
| | 9014), 0.02 lb of a dibutyltin dilaurate (Dabco ® T-12), 0.030 lb of |
| | of Zinc pyrithione (Biomaster 627), 0.032 lb of of an antimicrobial |
| | based on the active agent N-butyl-1,2-benzisothiazolin-3-one |
| | (BBIT) (Vanquish ™ 100 Antimicrobial)) is added over a 10 second period |
| 0:20 | 3.67 lb of a low viscosity, solvent-free aliphatic polyisocyanate |
| | based on Hexamethylene Diisocyanate trimer (HDI homopolymer |
| | (Tolonate ™ HDT-LV) is added over a 10 second period |
| 0:60 | 0.25 lb of a clear, colorless polydimethyl siloxane fluid having |
| | silanol group in the terminal position (F1006), Wacker Chemie |
| | AG) is added over a 3 second period |
| 1:07 | Coated sand is discharged |

### Example 24

Example 24 provided coated particulates for a turf infill comprising a dual-layer polyurethane based coating with an isocyanate index of about 1.3, and an overall cycle time of 1 minute and 7 seconds. The particulates were prepared as described and provided for herein using 1000 pounds of 16/30 mesh size sand, which was introduced into a batch mixer.

ADDITION CYCLE

| Time | |
|---|---|
| (m:s) | Step |
| 0:00 | 1000 lb of preheated sand (190° F.) is added to a mixer |
| 0:04 | 0.40 lb of the coupling agent aminopropyltriethoxysilane |
| | (GENIOSIL ® GF 93) is added with mixing over a 5 second period |
| 0:15 | 1.93 lb of the first isocyanate reactive blend (0.89 lb of a low |
| | viscosity polyol with improved color stability (Cardolite ® NX- |
| | 9014), 0.20 lb of a green color polychlorinated copper |
| | phthalocyanine (25%) pigment (Plasticolors ® DL 50056), 0.80 lb |
| | of a red color iron oxide (50%) pigment (Plasticolors ® DL 80943), |
| | 0.01 lb of a dibutyltin dilaurate (Dabco ® T-12), 0.015 lb of Zinc |
| | 2-pyridinethiol-1-oxide (Zinc Omadine ™ Antimicrobial), |
| | 0.016 lb of an antimicrobial based on the active agent N-butyl-1,2- |
| | benzisothiazolin-3-one (BBIT) (Vanquish ™ 100 Antimicrobial)) is |
| | added over a 10 second period |
| 0:17 | 2.47 lb of the second isocyanate reactive blend (2.39 lb of a low |
| | viscosity polyol with improved color stability (Cardolite ® NX- |
| | 9014), 0.02 lb of a dibutyltin dilaurate (Dabco ® T-12), 0.030 lb of |
| | of Zinc 2-pyridinethiol-1-oxide (Zinc Omadine ™ Antimicrobial), |
| | 0.032 lb of of an antimicrobial based on the active agent N-butyl- |
| | 1,2-benzisothiazolin-3-one (BBIT) (Vanquish ™ 100 |
| | Antimicrobial)) is added over a 10 second period |
| 0:20 | 3.67 lb of a low viscosity, solvent-free aliphatic polyisocyanate |
| | based on Hexamethylene Diisocyanate trimer (HDI homopolymer |
| | (Tolonate ™ HDT-LV) is added over a 10 second period |
| 0:60 | 0.25 lb of a clear, colorless polydimethyl siloxane fluid having |
| | silanol group in the terminal position (F1006), Wacker Chemie |
| | AG) is added over a 3 second period |
| 1:07 | Coated sand is discharged |

### Example 25

Example 25 provided coated particulates for a turf infill comprising a dual-layer polyurethane based coating with an isocyanate index of about 1.3, and an overall cycle time of 1 minute and 7 seconds. The particulates were prepared as described and provided for herein using 1000 pounds of 16/30 mesh size sand, which was introduced into a batch mixer.

ADDITION CYCLE

| Time | |
|---|---|
| (m:s) | Step |
| 0:00 | 1000 lb of preheated sand (between 175 and 185° F.) is added to a mixer |
| 0:04 | 0.40 lb of the coupling agent aminopropyltriethoxysilane |
| | (GENIOSIL ® GF 93) is added with mixing over a 5 second period |
| 0:15 | 1.94 lb of the first isocyanate reactive blend (0.90 lb of a low |
| | viscosity polyol with improved color stability (Cardolite ® NX- |
| | 9014), 0.20 lb of a green color polychlorinated copper |
| | phthalocyanine (25%) pigment (Plasticolors ® DL 50056), 0.80 lb |
| | of a red color iron oxide (50%) pigment (Plasticolors ® DL 80943), |
| | 0.01 lb of a dibutyltin dilaurate (Dabco ® T-12), 0.015 lb of Zinc |
| | pyrithione (Biomaster 627), 0.016 lb of an antimicrobial based on |
| | the active agent N-butyl-1,2-benzisothiazolin-3-one (BBIT) |
| | (Vanquish ™ 100 Antimicrobial)) is added over a 10 second period |
| 0:17 | 2.49 lb of the second isocyanate reactive blend (2.41 lb of a low |
| | viscosity polyol with improved color stability (Cardolite ® NX- |
| | 9014), 0.02 lb of a dibutyltin dilaurate (Dabco ® T-12), 0.030 lb of |
| | of Zinc pyrithione (Biomaster 627), 0.032 lb of of an antimicrobial |
| | based on the active agent N-butyl-1,2-benzisothiazolin-3-one |
| | (BBIT) (Vanquish ™ 100 Antimicrobial)) is added over a 10 second period |
| 0:20 | 3.64 lb of a low viscosity solvent-free aliphatic polyisocyanate |
| | based on Hexamethylene Diisocyanate biuret (HDI homopolymer |
| | (Tolonate ™ HDB-LV) is added over a 10 second period |
| 0:60 | 0.25 lb of a clear, colorless polydimethyl siloxane fluid having |
| | silanol group in the terminal position (F1006), Wacker Chemie |
| | AG) is added over a 3 second period |
| 1:07 | Coated sand is discharged |

### Example 26

Example 26 provided coated particulates for a turf infill comprising a dual-layer polyurethane based coating with an isocyanate index of about 1.3, and an overall cycle time of 1 minute and 7 seconds. The particulates were prepared as described and provided for herein using 1000 pounds of 16/30 mesh size sand, which was introduced into a batch mixer.

ADDITION CYCLE

| Time | |
|---|---|
| (m:s) | Step |
| 0:00 | 1000 lb of preheated sand (between 175 and 185° F.) is added to a mixer |
| 0:04 | 0.40 lb of the coupling agent aminopropyltriethoxysilane |
| | (GENIOSIL ® GF 93) is added with mixing over a 5 second period |
| 0:15 | 1.94 lb of the first isocyanate reactive blend (0.90 lb of a low |
| | viscosity polyol with improved color stability (Cardolite ® NX- |
| | 9014), 0.20 lb of a green color polychlorinated copper |
| | phthalocyanine (25%) pigment (Plasticolors ® DL 50056), 0.80 lb |
| | of a red color iron oxide (50%) pigment (Plasticolors ® DL 80943), |
| | 0.01 lb of a dibutyltin dilaurate (Dabco ® T-12), 0.015 lb of Zinc |
| | 2-pyridinethiol-1-oxide (Zinc Omadine ™ Antimicrobial), 0.016 lb of |
| | an antimicrobial based on the active agent N-butyl-1,2- |
| | benzisothiazolin-3-one (BBIT) (Vanquish ™ 100 Antimicrobial)) is |
| | added over a 10 second period |
| 0:17 | 2.49 lb of the second isocyanate reactive blend (2.41 lb of a low |
| | viscosity polyol with improved color stability (Cardolite ® NX- |
| | 9014), 0.02 lb of a dibutyltin dilaurate (Dabco ® T-12), 0.030 lb of |
| | of Zinc 2-pyridinethiol-1-oxide (Zinc Omadine ™ Antimicrobial), |
| | 0.032 lb of of an antimicrobial based on the active agent N-butyl- |
| | 1,2-benzisothiazolin-3-one (BBIT) (Vanquish ™ 100 |
| | Antimicrobial)) is added over a 10 second period |
| 0:20 | 3.64 lb of isocyanate a low viscosity solvent-free aliphatic |
| | polyisocyanate based on Hexamethylene Diisocyanate biuret (HDI |
| | homopolymer (Tolonate ™ HDB-LV) is added over a 10 second period |
| 0:60 | 0.25 lb of a clear, colorless polydimethyl siloxane fluid having |
| | silanol group in the terminal position (F1006), Wacker Chemie |
| | AG) is added over a 3 second period |
| 1:07 | Coated sand is discharged |

### Example 27

Example 27 provided coated particulates for a turf infill comprising a single layer polyurethane based coating with an isocyanate index of about 1.0, and an overall cycle time of 1 minute. The particulates were prepared as described and provided for herein using 1000 pounds of 16/30 mesh size sand, which was introduced into a batch mixer.

ADDITION CYCLE

| Time | | |
|---|---|---|
| (m:s) | Description | Step |
| 0:00 | | 1000 lb of preheated sand (between 190 and 190° F.) is added to a mixer |
| 0:04 | Silane | 0.40 lb of the coupling agent aminopropyltriethoxysilane |
| | | (GENIOSIL ® GF 93) is added with mixing over a 5 second period |
| 0:15 | Polyol Blend 1 | 3.41 lb of the first isocyanate reactive blend (2.63 lb of a |
| | (polyether-polyester | low viscosity polyol with improved color stability |
| | polyol, colorants, | (Cardolite ® NX-9014), 0.10 lb of a green color |
| | catalyst, surfactant, | polychlorinated copper phthalocyanine (25%) pigment |
| | antimicrobials) | (Plasticolors ® DL 50056), 0.41 lb of a red color iron oxide |
| | | (50%) pigment (Plasticolors ® DL 80943), 0.05 lb a colorant |
| | | (Plasticolors ® DL-20711), 0.02 lb of a dibutyltin dilaurate |
| | | (Dabco ® T-12), 0.08 lb of a polyether-modified |
| | | polydimethylsiloxane (BYK ® 333), 0.06 lb of Zinc 2- |
| | | pyridinethiol-1-oxide (Zinc Omadine ™ Antimicrobial), |
| | | 0.06 lb of an antimicrobial based on the active agent N- |
| | | butyl-1,2-benzisothiazolin-3-one (BBIT) (Vanquish ™ 100 |
| | | Antimicrobial)) is added over a 10 second period |
| 0:20 | Isocyanate Blend | 2.07 lb of isocyanate blend (1.97 lb of a low viscosity, |
| | | solvent-free aliphatic polyisocyanate based on |
| | | Hexamethylene Diisocyanate trimer (HDI homopolymer |
| | | (Tolonate ™ HDT-LV), 0.66 lb of a polymethylene |
| | | polyphenylisocyanate that contains MDI (PAPI ™ 27 |
| | | Polymeric MDI) is added over a 10 second period |
| 1:00 | | Coated sand is discharged |

### Example 28

Example 28 provided coated particulates for a turf infill comprising a single layer polyurethane based coating with an isocyanate index of about 1.0, and an overall cycle time of 1 minute. The particulates were prepared using 1000 pounds of 16/30 mesh size sand, which was introduced into a batch mixer.

ADDITION CYCLE

| Time | | |
|---|---|---|
| (m:s) | Description | Step |
| 0:00 | | 1000 lb of preheated sand (between 190 and 190° F.) is added to a mixer |
| 0:04 | Silane | 0.40 lb of the coupling agent aminopropyltriethoxysilane |
| | | (GENIOSIL ® GF 93) is added with mixing over a 5 second period |
| 0:15 | Polyol Blend 1 | 3.53 lb of the first isocyanate reactive blend (2.75 lb of a |
| | (polyether-polyester | low viscosity polyol with improved color stability |
| | polyol, colorants, | (Cardolite ® NX-9014), 0.10 lb of a green color |
| | catalyst, surfactant, | polychlorinated copper phthalocyanine (25%) pigment |
| | antimicrobials) | (Plasticolors ® DL 50056), 0.41 lb of a red color iron oxide |
| | | (50%) pigment (Plasticolors ® DL 80943), 0.05 lb a colorant |
| | | (Plasticolors ® DL-20711), 0.02 lb of a catalysit for the |
| | | reaction between isocyanates and alcohols (TIB ® Kat 300), |
| | | 0.08 lb of a polyether-modified polydimethylsiloxane |
| | | (BYK ®333), 0.06 lb of Zinc 2-pyridinethiol-1-oxide (Zinc |
| | | Omadine ™ Antimicrobial), 0.06 lb of an antimicrobial |
| | | based on the active agent N-butyl-1,2-benzisothiazolin-3- |
| | | one (BBIT) (Vanquish ™ 100 Antimicrobial)) is added over |
| | | a 10 second period |
| 0:20 | Isocyanate Blend | 1.94 lb of isocyanate blend (1.46 lb of an isocyanate |
| | | terminated polypropylene glycol prepolymer based on |
| | | hydrogenated 4,4′ methylenebis diisocyanate (HMDI) |
| | | (Lupranate ® 5570, 0.49 lb of a polymethylene |
| | | polyphenylisocyanate that contains MDI (PAPI ™ 27 |
| | | Polymeric MDI) is added over a 10 second period |
| 1:00 | | Coated sand is discharged |

### Example 29

Example 29 provided coated particulates for a turf infill comprising a single layer polyurethane based coating with an isocyanate index of about 1.0, and an overall cycle time of 1 minute. The particulates were prepared using 1000 pounds of 16/30 mesh size sand, which was introduced into a batch mixer.

ADDITION CYCLE

| Time | | |
|---|---|---|
| (m:s) | Description | Step |
| 0:00 | | 1000 lb of preheated sand (between 190 and 190° F.) is added to a mixer |
| 0:04 | Silane | 0.40 lb of the coupling agent aminopropyltriethoxysilane |
| | | (GENIOSIL ® GF 93) is added with mixing over a 5 second period |
| 0:15 | Polyol Blend 1 | 2.22 lb of the first isocyanate reactive blend (1.90 lb of a |
| | (polyether- | polyether polyol (TERAFORCE ™ 62575), 0.04 lb of a |
| | polyester polyol, | green color polychlorinated copper phthalocyanine (25%) |
| | colorants, catalyst, | pigment (Plasticolors ® DL 50056), 0.16 lb of a red color |
| | surfactant) | iron oxide (50%) pigment (Plasticolors ® DL 80943), 0.02 lb |
| | | of a colorant (Plasticolors ® DL-20711), 0.02 lb of a |
| | | dibutyltin dilaurate (Dabco ® T-12), 0.08 lb of a polyether- |
| | | modified polydimethylsiloxane (BYK ® 333)) is added over |
| | | a 10 second period |
| 0:20 | Isocyanate | 2.98 lb of a polymethylene polyphenylisocyanate that |
| | | contains MDI (PAPI ™ 27 Polymeric MDI) is added over a |
| | | 10 second period |
| 1:00 | | Coated sand is discharged |

### Example 30

Example 30 demonstrated that the coated the coated sand particulates of one of the Examples 1-29 was applied to a synthetic turf as turf infill and was found to perform at satisfactory levels as discussed herein. The infill was spread with standard machinery to apply to such materials. An artificial turf was produced from the coated particulates for a turf infill as described and provided for herein such as the coated sand particulates for a turf infill prepared according to Examples 1-29. The coated particles as described and provided for herein were tested as turf infill and were found to be acceptable as turf infill. The artificial turf described herein includes a pile fabric having a backing and pile elements extending upwardly from the backing and an infill layer filed on the backing such that the pile elements are at least partially embedded in the infill layer and the infill layer includes the coated particulates for a turf infill as described herein, optionally in combination with inorganic fillers and elastic infills. The artificial turf was produced as follows. First, a pile fabric was provided with a backing and the pile elements extending upwardly from an upper surface of the backing. Then, the coated particulates as described herein such as the coated particulates for a turf infill prepared according to Examples 1-29 were provided. Subsequently, the coated particulates as described herein were optionally mixed with the inorganic infills and elastic infills to form an infill mixture. Next, the infill mixture was used to form the infill layer filled on the backing such that the pile elements were at least partially embedded in the infill layer. The backing served to fix the pile elements and had a loose texture or a perforated structure to drain well. The backing could be in contact with the ground. The pile elements were attached to the backing to serve as the surface of the artificial turf. Each of the pile elements was made of plastic filament such as polyethylene, polypropylene, polyvinylidene chloride, nylon, or the like and contained a green pigment to give the feel similar to the natural turf. The infill layer was formed by filling an empty space between the pile elements with the infill in order to give the artificial turf with elasticity and low sliding resistance. Because the infill layer had a great influence on performance of the artificial turf, the infill layer is required to have proper and consistent elasticity, hardness, and drain performance. The coated particulates for a turf infill as described and provided for herein alone or in combination with elastic infill were tested to achieve and enhance all the characteristics required for the artificial turf infill.

It must also be noted that as used herein and in the appended claims, the singular forms “a”, “an”, and “the” include plural reference unless the context clearly dictates otherwise.

As used in this document, terms “comprise,” “have,” and “include” and their conjugates, as used herein, mean “including but not limited to.” While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

Various references and patents are disclosed herein, each of which are hereby incorporated by reference for the purpose that they are cited.

This description is not limited to the particular processes, compositions, or methodologies described, as these may vary. The terminology used in the description is for the purpose of describing the particular versions or embodiments only, and it is not intended to limit the scope of the embodiments described herein. Unless defined otherwise, all technical and scientific terms used herein have the same meanings as commonly understood by one of ordinary skill in the art. In some cases, terms with commonly understood meanings are defined herein for clarity and/or for ready reference, and the inclusion of such definitions herein should not necessarily be construed to represent a substantial difference over what is generally understood in the art. However, in case of conflict, the patent specification, including definitions, will prevail.

From the foregoing, it will be appreciated that various embodiments of the present disclosure have been described herein for purposes of illustration and that various modifications can be made without departing from the scope and spirit of the present disclosure. Accordingly, the various embodiments disclosed herein are not intended to be limiting.

1. A coated particulate for a turf infill comprising a core, wherein the core is substantially covered with one or more layers of polymer coatings, wherein the polymer coating is selected from a polyurethane coating, an epoxy coating, a phenolic coating, a polyurethane-phenol coating, and any combination thereof.

2. The coated particulate of claim 1, wherein the polymer coating is a polyurethane coating, optionally wherein the polyurethane coating is homogenous.

3. The coated particulate of claim 1, wherein the polymer coating is coupled to the core through a coupling agent.

4-156. (canceled)

157. The coated particulate of claim 3, wherein the coupling agent comprises a silane coupling agent, optionally wherein the silane coupling agent comprises an organofunctional silane coupling agent selected from 3-glycidyloxypropyltrimethoxysilane, 3-glycidyloxypropyltriethoxysilane, 2-(3,4-epoxycyclohexy)ethyltrimethoxysilane, and 2-(3,4-epoxycyclohexyl)ethyltriethoxysilane, 3-[2-(2-aminoethylamino)ethylamino]propyl-trimethoxysilane (CAS No. 35141-30-1), 3-mercaptopropyl-trimethoxysilane (CAS No. 4420-74-0), n-propyltrimethoxysilane (CAS No. 1067-25-0), [3-(2-aminoethyl)aminopropyl]trimethoxysilane (CAS No. 1760-24-3), silane n-dodecyltrimethoxysilane (CAS No. 3069-21-4), bis(trimethoxysilylpropyl) amine (CAS No. 82985-35-1), 1,2-bis(trimethoxysilyl)ethane (CAS No. 18406-41-2), vinyltri(2-methoxyethoxy) silane (CAS No. 1067-53-4), n-octyltriethoxysilane (CAS No. 2943-75-1), bis[3-(triethoxysilyl) propyl]tetrasulfide (CAS No. 40372-72-3), vinyltriethoxysilane (CAS No. 78-08-0): 3-glycidoxypropyl-trimethoxysilane (CAS No. 2530-83-8), 3-(Triethoxysilyl)propyl isocyanate, 3-mercaptopropyl-triethoxysilane (CAS No. 14814-09-6), 3-glycidoxypropyl-triethoxysilane (CAS No. 2602-34-8), 2-(3,4-epoxycyclohexyl)ethyl[trimethoxysilane (CAS No. 3388-04-3), 3-aminopropyltrimethoxysilane (CAS No. 13822-56-5), 2-(3,4-epoxycyclohexyl)ethyl]triethoxysilane (CAS No. 10217-34-2), 3-aminopropyltriethoxysilane (CAS No. 919-30-2), 3-glycidoxypropyl-methyldimethoxysilane (CAS No. 65799-47-5), bis(triethoxysilylpropyl)amine (CAS No. 13497-18-2), 3-(2-aminoethylamino)propyldimethoxymethylsilane (CAS No. 3069-29-2), N-(n-Butyl)-3-aminopropyltri-methoxysilane (CAS NO. 31024-56-3), n-propyltriethoxysilane (CAS No. 2550-02-9), vinyltrimethoxysilane (CAS No. 2768-02-7), 3-ureidopropyltriethoxy-silane (CAS No. 23779-32-0), 3-methacryloxypropyl-trimethoxysilane (CAS No. 2530-85-0), aqueous 3-aminopropylsilane hydrolysate, and a combination thereof.

158. The coated particulate of claim 2, wherein the polyurethane coating is formed from a reaction of an isocyanate component and an isocyanate reactive blend.

159. The coated particulate of claim 158, wherein the isocyanate component comprises a cycloaliphatic isocyanate, an aliphatic isocyanate, or an aromatic isocyanate, or a combination thereof.

160. The coated particulate of claim 158, wherein the isocyanate component comprises toluol-2,4-diisocyanate; toluol-2,6-diisocyanate (TDI); 1,5 naphthalindiisocyanate; cumol-2,4-diisocyanate; 4-methoxy-1,3-phenyldiisocyanate; 4-chloro-1,3-phenyldiisocyanate; diphenylmethane-4,4-diisocyanate; diphenylmethane-2,4-diisocyanate; diphenylmethane-2,2-diisocyanate; 4-bromo-1,3-phenyldiisocyanate; 4-ethoxy-1,3-phenyl-diisocyanate; 2,4′-diisocyanate diphenylether; 5,6-dimethyl-1,3-phenyl-diisocyanate; methylenediphenyl diisocyanate (including 2,2′-MDI, 2,4′-MDI and 4,4″-MDI); 4,4 diisocyanato-diphenylether; 4,6-dimethyl-1,3-phenyldiisocyanate; 9,10-anthracene-diisocyanate; 2,4,6-toluol triisocyanate; 2,4,4′-triisocyanatodiphenylether; 1,4-tetramethylene diisocyanate; 1,6-hexamethylene diisocyanate (HDI); 1,10-decamethylene-diisocyanate; 1,3-cyclohexylene diisocyanate; 4,4′ methylene-bis-(cyclohexylisocyanate); xylol diisocyanate; 1-isocyanato-3-methyl-isocyanate-3,5,5-trimethylcyclohexane (isophorone diisocyanate); 1-3-bis(isocyanato-1-methylethyl) benzol (m-TMXDI); 1,4 bis(isocyanato-1-methylethyl) benzol (p-TMXDI), isocyanurate-modified hexamethylene diisocyanate, 1,3,5-tris(6-isocyanatohexyl)biuret (hexamethylene diisocyanate biuret), hexamethylene diisocyanate trimer, or an oligomer or polymer thereof, or a combination thereof.

161. The coated particulate of claim 159, wherein the aliphatic isocyanate comprises:
i. an isocyanate terminated polypropylene glycol prepolymer based on hydrogenated 4,4′ methylenebis diisocyanate (HMDI), optionally wherein the isocyanate terminated polypropylene glycol prepolymer based on hydrogenated 4,4′ methylenebis diisocyanate (HMDI) is BASF Lupranate 5570;
ii. an isocyanurate-modified hexamethylene diisocyanate or an oligomer or polymer thereof, optionally wherein the isocyanurate-modified hexamethylene diisocyanate or an oligomer or polymer thereof is BASF Basonat® HI 2000 NG;
iii. 1,3,5-tris(6-isocyanatohexyl)biuret or an oligomer or polymer thereof, optionally wherein the 1,3,5-tris(6-isocyanatohexyl)biuret or an oligomer or polymer thereof is Tolonate™ HDB-LV; or
iv. hexamethylene diisocyanate trimer or an oligomer or polymer thereof, optionally wherein the hexamethylene diisocyanate trimer or an oligomer or polymer thereof is Tolonate™ HDT-LV.

162. The coated particulate of claim 158, wherein the isocyanate component comprises:
i. a polymeric MDI isocyanate, optionally wherein the polymeric MDI isocyanate is Dow HF-459, Dow PAPI™ 27; or
ii. a low viscosity polymeric MDI isocyanate, optionally wherein the low viscosity polymeric MDI isocyanate is BASF Lupranate M20.

163. The coated particulate of claim 158, wherein the isocyanate reactive blend comprises
i. a polyether polyol, optionally wherein the polyether polyol is Albodur 1055 or Dow TERAFORCE 62575;
ii. a low molecular weight polyol, optionally wherein the low molecular weight polyol is 1,4-butanediol or glycerin; or
iii. a polyol derived from cashew nutshell liquid, optionally wherein the polyol derived from cashew nut shell liquid is a polyether-polyester polyol or a branched polyether-polyester polyol and optionally the polyol derived from cashew nut shell liquid is a Cardolite® NX-9014.

164. The coated particulate of claim 158, wherein the isocyanate reactive blend further comprises a colorant selected from a green colorant, a yellow colorant, a back colorant, a red colorant, a blue colorant, magenta colorant, a white colorant and a combination thereof.

165. The coated particulate of claim 158, wherein the isocyanate reactive blend further comprises a polyurethane catalyst, optionally wherein the polyurethane catalyst is dibutyltin dilaurate (Dabco T-12) or dimethyltin (TIB Kat®300); or a UV stabilizer, optionally wherein the UV stabilizer is a hindered amine light stabilizer, benzophenone, benzotriazoie, hydroxyphenyl triazine, 2-(2′-hydroxyphenyl)benzotriazoles, Uvinol 3000, Tinuvin® P, Irganox 1098, Uvinol 3008, Lavinix, BHT, Tinuvin® 384-2, Tinuvin® 320, Tinuvin® 292 Irganox 1010, Irganox 1076, Irganox 1135, or Irgafos 168, or a combination thereof and optionally wherein the UV stabilizer is a solvent-free, liquid blend of a 2-(2-hydroxyphenyl)-benzotriazole UV absorber (UVA) and a basic hindered amine light stabilizer (HALS) and optionally wherein the UV stabilizer is BASF Tinuvin® 5050 or BASF Tinuvin® 384-2.

166. The coated particulate of claim 1, wherein the core is a sand particle, a quartz sand, a bauxite particle, a ceramic particle, a rubber particle, an elastomeric particle, or a polymeric particle.

167. A composition comprising two or more types of coated particulates, wherein each coated particulate is, independently, a particulate of claim 1.

168. A method of producing the polyurethane coated particulates of claim 1 comprising:
a. heating particulates in an oven, optionally wherein the particulates are heated in the oven to a temperature from about 60° C. to about 210° C. and optionally wherein the particulates are heated to a temperature of about 80° C., about 88° C., about 93, about 104, about 107° C., about 110° C. or about 150° C.;
b. transferring the heated particulates to a mixer, optionally wherein the mixer is a Webac mixer;
c. adding the coupling agent into the mixer, optionally wherein the coupling agent in are added when the temperature of the particulates is from about 80° C. to about 150° C. and optionally wherein the coupling agent is added when the temperature of the particulates is about 93° C. or 110° C.;
d. adding the isocyanate reactive blend into the mixer, optionally wherein the isocyanate reactive blend is added after a second to about 15 seconds from the start of the addition of the coupling agent, and optionally wherein the isocyanate reactive blend is added over a period of about 10 seconds;
e. adding the isocyanate component into the mixer, optionally wherein the isocyanate component is added after about 20 seconds from the start of the addition of the coupling agent and optionally wherein the isocyanate component is added over a period of about 10 seconds; and
f. optionally adding the additive into the mixer to produce the polyurethane coated particulates, optionally wherein the additive is added after 0 second to about 35 seconds from the start of the addition of the coupling agent, optionally wherein the isocyanate component is added over a period of about 5 seconds, optionally the coated particulates are discharged after mixing in the mixer for about 30 seconds to 5 minutes, optionally wherein the coated particulates are discharged into a pan and allowed to cool, and optionally wherein the coated particulates are dry and free flowing coated particulates;
wherein the method optionally further comprises repeating steps d) to f) to add one or more additional polyurethane coatings

169. A method of producing coated particulates of claim 1 comprising:
a. feeding heated particulates into an inlet of a first mixer, the first mixer comprising an outer wall and at least one auger comprising a rotating shaft and a plurality of paddles connected thereto, wherein the at least one auger of the first mixer is rotating at a rate to form an annulus of particulates positioned along the interior surface of the outer wall of the first mixer and moving the particulates towards an outlet of the first mixer, optionally wherein the at least one auger rotates at a rate of about 60 rotations per minute (RPM) to about 1200 RPM, and optionally wherein the particulates move from the inlet to the outlet in an average time from about 2 seconds to about 15 seconds;
b. mixing the annulus of particulates with coating compositions that are fed into the mixer through dosing ports operably connected to the first mixer;
c. discharging the coated particulates through the outlet to the second mixer;
d. mixing the annulus of particulates with coating compositions that are fed into the mixer through dosing ports operably connected to the first mixer; and
e. discharging the coated particulates through the outlet, optionally wherein the particulates are discharged from the outlet at an average rate of about 100 pounds per minute to about 6000 pounds of particulates per minute; and
optionally wherein the first mixer further comprises at least a second dosing port operably connected to the mixer.

170. A method of producing coated particulates of claim 1 comprising:
a. optionally heating particulates to a first temperature;
b. feeding the optionally heated particulates into an inlet of the first mixer, wherein the first mixer comprises an outer wall and an auger comprising a rotating shaft and multiple paddles connected thereto, wherein the auger is rotating at a rate of about 60 rotations per minute to about 1200 rotations per minute,
wherein the auger moves a plurality of the particulates into an annulus positioned along the outer wall;
wherein the auger is capable of moving the particulates towards an outlet of the first mixer in an average time from about 2 seconds to about 20 seconds;
c. optionally heating a coating composition to a second temperature, wherein the second temperature is higher than the melting point of the coating composition;
d. feeding the coating composition into at least a first dosing port of the first mixer with or without a gas, wherein the coating composition mixes with the particulates in the rotating mixer, and wherein the coating composition coats the particulates as they move towards the outlet; and
e. collecting the coated particulates as the coated particulates are discharged from the outlet;

171. An artificial turf comprising the coated particulate of claim 1.

172. An artificial turf, comprising:
a backing having pile fibers extending upwardly therefrom; and
a filler of coated particulate of claim 1, and wherein the pile fibers extend substantially above the infill material.

173. A method of forming an artificial turf comprising:
placing an aggregate infill material onto a backing,
wherein the backing has pile fibers secured thereto and extending upwardly above the infill material and wherein the aggregate infill material comprises the coated particulates claim 1.
